(19) United States
(12) Patent Application Publication
(10) Pub. No.: US 2018/0325050 A1
(43) Pub. Date: Nov. 15, 2018

(54) System And Method For Monitoring And Actuating Components In An Agricultural Environment Using A Configurable Software Platform

(71) Applicant: n.io Innovation, LLC, Broomfield, CO (US)

(72) Inventors: Randall E. BYE, Louisville, CO (US); Douglas A. STANDLEY, Boulder, CO (US); Stephen B. WILCHEK, Lakewood, CO (US); James A. HOLMES, Broomfield, CO (US); Philip L. ASMUNDSON, Marana, AZ (US); Michael L. KILLIAN, Denver, CO (US); Christopher H. BRACKERT, Torrance, CA (US); Blake A. DUHAME, Denver, CO (US); Thomas E. YOUNG, Longmont, CO (US); Kimberly B. ASMUNDSON, Marana, AZ (US); Matthew R. DODGE, Dana Point, CA (US)

(21) Appl. No.: 15/777,618

(22) PCT Filed: Nov. 21, 2016
(86) PCT No.: PCT/IB2016/001792

§ 371 Date: May 18, 2018

Related U.S. Application Data
(60) Provisional application No. 62/397,775, filed on Sep. 21, 2016.
(60) Provisional application No. 62/257,971, filed on Nov. 20, 2015.
(60) Provisional application No. 62/257,976, filed on Nov. 20, 2015.
(60) Provisional application No. 62/258,062, filed on Nov. 20, 2015.

(51) Int. Cl. A01G 25/16; G05D 7/06

(52) U.S. Cl. CPC A01G 25/167; G05D 7/0676; A01G 25/162

(57) ABSTRACT

A system and method are provided for managing some or all of an agricultural ecosystem. In one example, the method includes obtaining a current soil moisture level for multiple zones at a geographic location, where each of the zones has been assigned a desired minimum soil moisture level. The zones are ranked in a watering schedule based on a delta between the current soil moisture level and the desired minimum soil moisture level of each zone. For each zone, in the order based on the zone's ranking, at least one valve is opened to deliver water to the zone and closed after watering of the zone is completed. The water may be delivered based on time or volume. If by volume, the volume needed by the zone is calculated.

### CROSS-REFERENCE AND CLAIM OF PRIORITY

This application claims the benefit of U.S. Provisional Application Ser. No. 62/257,971, filed on Nov. 20, 2015, and entitled SYSTEM AND METHOD FOR PROVIDING CONFIGURABLE COMMUNICATIONS FOR A SOFTWARE PLATFORM ON A PER SERVICE BASIS, U.S. Provisional Application Ser. No. 62/257,976, filed on Nov. 20, 2015, and entitled SYSTEM AND METHOD FOR MONITORING AND ACTUATING ELECTRICAL COMPONENTS USING A CONFIGURABLE SOFTWARE PLATFORM INSTANCE, U.S. Provisional Application Ser. No. 62/258,062, filed on Nov. 20, 2015, and entitled SYSTEM AND METHOD FOR MONITORING AND ACTUATING COMPONENTS IN AN AGRICULTURAL ENVIRONMENT USING A CONFIGURABLE SOFTWARE PLATFORM, and U.S. Provisional Application Ser. No. 62/397,775, filed on Sep. 21, 2016, and entitled SYSTEM AND METHOD FOR MONITORING AND CONTROLLING AN AGRICULTURAL ENVIRONMENT USING A CONFIGURABLE SOFTWARE PLATFORM, all of which are incorporated by reference herein in their entirety. This application is related to PCT application PCT/IB2016/01184.

### BACKGROUND

The proliferation of devices has resulted in the production of a tremendous amount of data that is continuously increasing. Current processing methods are unsuitable for processing this data. Accordingly, what is needed are systems and methods that address this issue.

### BRIEF DESCRIPTION OF THE DRAWINGS

For a more complete understanding, reference is now made to the following description taken in conjunction with the accompanying Drawings in which:

FIG. 1A illustrates one embodiment of a neutral input/output (NIO) platform with customizable and configurable processing functionality and configurable support functionality;

FIG. 1B illustrates one embodiment of a data path that may exist within a NIO platform instance based on the NIO platform of FIG. 1A;

FIGS. 1C and 1D illustrate embodiments of the NIO platform of FIG. 1A as part of a stack;

FIG. 1E illustrates one embodiment of a system on which the NIO platform of FIG. 1A may be run;

FIG. 2 illustrates a more detailed embodiment of the NIO platform of FIG. 1A;

FIG. 3A illustrates another embodiment of the NIO platform of FIG. 2;

FIG. 3B illustrates one embodiment of a NIO platform instance based on the NIO platform of FIG. 3A;

FIG. 4A illustrates one embodiment of a workflow that may be used to create and configure a NIO platform;

FIG. 4B illustrates one embodiment of a user's perspective of a NIO platform;

FIGS. 5-7 illustrate embodiments of systems formed by interconnected NIO platforms;

FIGS. 8A-8C illustrate embodiments of how a service or set of services may be distributed across multiple NIO platforms;

FIG. 9 illustrates one embodiment of NIO platforms from the system of FIG. 7 arranged in a hierarchy of a mother node, a supervisor node, and an edge node;

FIG. 10 illustrates one embodiment of a method that may be used to define and create a system of NIO platforms;

FIG. 11 illustrates another embodiment of a system formed by interconnected NIO platforms;

FIG. 12 illustrates one embodiment of a different perspective of the NIO platform instance of FIG. 3B;

FIG. 13 illustrates one embodiment of a hierarchical flow that begins with task specific functionality and ends with NIO platform instances;

FIG. 14 illustrates another embodiment of a system formed by interconnected NIO platforms;

FIG. 15 illustrates one embodiment of the system of FIG. 11 with some of the NIO platforms grouped into communication clusters;

FIG. 16 illustrates one embodiment of a service that may be configured with various input and output blocks;

FIGS. 17-19 illustrate different embodiments of systems of NIO platforms configured with input and output blocks for communication;

FIG. 20A illustrates one embodiment of a method that may be executed to configure a service for communication;

FIG. 20B illustrates one embodiment of a method that may be executed by a NIO platform;

FIG. 20C illustrates one embodiment of a method that may be executed by a service;

FIG. 21 illustrates one embodiment of an environment showing how functionality embodied in services and blocks can be distributed to different hardware environments;

FIGS. 22A-22D illustrate embodiments of methods that can be applied within the environment of FIG. 21;

FIG. 23 illustrates one embodiment of an environment in which a NIO platform may monitor one or more electrical components;

FIG. 24 illustrates one embodiment of a method that may be executed by the NIO platform of FIG. 23;

FIG. 25 illustrates one embodiment of an electrical component monitoring and actuation system that uses a single NIO platform;

FIGS. 26-28 illustrate embodiments of services that may be used by the NIO platform of FIG. 25;

FIGS. 29A and 29B illustrate an alternate embodiment of the service of FIG. 28;

FIG. 30 illustrates one embodiment of an electrical component monitoring and actuation system that uses multiple NIO platforms;

FIG. 31 illustrates one embodiment of an electrical component monitoring system that uses at least one NIO platform to monitor a power panel;

FIG. 32 illustrates one embodiment of a service that may be used by the NIO platform of FIG. 31 to monitor device metrics of a device on which the NIO platform is running;

FIGS. 33A and 33B illustrate embodiments of a GUI that may be produced using real time data obtained by the NIO platform of FIG. 31;

FIGS. 34 and 35 illustrate embodiments of an agricultural environment within which one or more NIO platforms may be used;

FIG. 36 illustrates an embodiment of various components of the agricultural environment of FIGS. 34 and 35 coupled to NIO platforms configured with possible services;

FIG. 37 illustrates one embodiment of an architecture that may be used within an agricultural environment to deploy multiple NIO platforms;

FIG. 38 illustrates one embodiment of a method that may be executed within the agricultural environment of FIG. 34;

FIGS. 39 and 40 illustrate embodiments of a system that may be used to manage the agricultural environment of FIGS. 34 and 35;

FIGS. 41 and 42 illustrate embodiments of methods that may be executed within the systems of FIGS. 39 and 40;

FIG. 43 illustrates one embodiment of inputs and outputs for a sensor hub node that may be used in the systems of FIGS. 39 and 40;

FIGS. 44A-44F illustrate one embodiment of inputs and outputs for a manager node that may be used in the systems of FIGS. 39 and 40;

FIG. 45 illustrates one example of a service structure that may be executed within the systems of FIGS. 39 and 40;

FIG. 46 illustrates one embodiment of an environment containing a portion of the system of FIG. 39;

FIGS. 47 and 48A illustrate embodiments of methods that may be executed within the systems of FIGS. 39 and 40;

FIG. 48B illustrates an environment describing aspects of the method of FIG. 48A;

FIGS. 48C and 48D illustrate embodiments of charts describing aspects of the method of FIG. 48A;

FIG. 49A illustrates one embodiment of a method that may be executed within the systems of FIGS. 39 and 40;

FIG. 49B illustrates one embodiment of a chart describing aspects of the method of FIG. 49A;

FIG. 50 illustrates one embodiment of a method that may be executed within the systems of FIGS. 39 and 40;

FIGS. 51-66 illustrate embodiments of screens that may be provided by a graphical user interface to interact with the systems of FIGS. 39 and 40;

FIG. 67 illustrates one embodiment of an environment in which annotation may be integrated with the systems of FIGS. 39 and 40; and

FIG. 68 illustrates one embodiment of an ecosystem that may be managed by one or more NIO platforms.

### DETAILED DESCRIPTION

The present disclosure is directed to a system and method for monitoring and controlling an agricultural environment using a configurable software platform. It is understood that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

This application refers to U.S. patent application Ser. No. 14/885,629, filed on Oct. 16, 2015, and entitled SYSTEM AND METHOD FOR FULLY CONFIGURABLE REAL TIME PROCESSING, now issued as U.S. Pat. No. 9,454,385, which is a continuation of PCT/IB2015/001288, filed on May 21, 2015, both of which are incorporated by reference in their entirety.

The present disclosure describes various embodiments of a neutral input/output (NIO) platform that includes a core that supports one or more services. While the platform itself may technically be viewed as an executable application in some embodiments, the core may be thought of as an application engine that runs task specific applications called services. The services are constructed using defined templates that are recognized by the core, although the templates can be customized to a certain extent. The core is designed to manage and support the services, and the services in turn manage blocks that provide processing functionality to their respective service. Due to the structure and flexibility of the runtime environment provided by the NIO platform's core, services, and blocks, the platform is able to asynchronously process any input signal from one or more sources in real time.

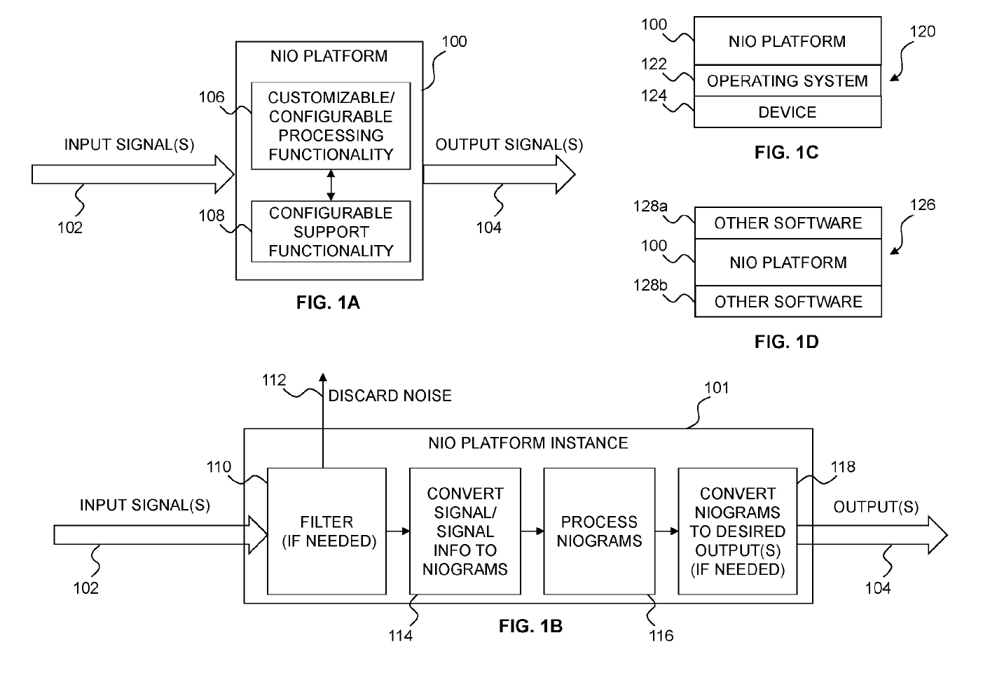

Referring to FIG. 1A, one embodiment of a NIO platform 100 is illustrated. The NIO platform 100 is configurable to receive any type of signal (including data) as input, process those signals, and produce any type of output. The NIO platform 100 is able to support this process of receiving, processing, and producing in real time or near real time. The input signals can be streaming or any other type of continuous or non-continuous input.

When referring to the NIO platform 100 as performing processing in real time and near real time, it means that there is no storage other than possible queuing between the NIO platform instance's input and output. In other words, only processing time exists between the NIO platform instance's input and output as there is no storage read and write time, even for streaming data entering the NIO platform 100.

It is noted that this means there is no way to recover an original signal that has entered the NIO platform 100 and been processed unless the original signal is part of the output or the NIO platform 100 has been configured to save the original signal. The original signal is received by the NIO platform 100, processed (which may involve changing and/or destroying the original signal), and output is generated. The receipt, processing, and generation of output occurs without any storage other than possible queuing. The original signal is not stored and deleted, it is simply never stored. The original signal generally becomes irrelevant as it is the output based on the original signal that is important, although the output may contain some or all of the original signal. The original signal may be available elsewhere (e.g., at the original signal's source), but it may not be recoverable from the NIO platform 100.

It is understood that the NIO platform 100 can be configured to store the original signal at receipt or during processing, but that is separate from the NIO platform's ability to perform real time and near real time processing. For example, although no long term (e.g., longer than any necessary buffering) memory storage is needed by the NIO platform 100 during real time and near real time processing, storage to and retrieval from memory (e.g., a hard drive, a removable memory, and/or a remote memory) is supported if required for particular applications.

The internal operation of the NIO platform 100 uses a NIO data object (referred to herein as a niogram). Incoming signals 102 are converted into niograms at the edge of the NIO platform 100 and used in intra-platform communications and processing. This allows the NIO platform 100 to handle any type of input signal without needing changes to the platform's core functionality. In embodiments where multiple NIO platforms are deployed, niograms may be used in inter-platform communications.

The use of niograms allows the core functionality of the NIO platform 100 to operate in a standardized manner regardless of the specific type of information contained in the niograms. From a general system perspective, the same core operations are executed in the same way regardless of the input data type. This means that the NIO platform 100 can be optimized for the niogram, which may itself be optimized for a particular type of input for a specific application.

The NIO platform 100 is designed to process niograms in a customizable and configurable manner using processing functionality 106 and support functionality 108. The processing functionality 106 is generally both customizable and configurable by a user. Customizable means that at least a portion of the source code providing the processing functionality 106 can be modified by a user. In other words, the task specific software instructions that determine how an input signal that has been converted into one or more niograms will be processed can be directly accessed at the code level and modified. Configurable means that the processing functionality 106 can be modified by such actions as selecting or deselecting functionality and/or defining values for configuration parameters. These modifications do not require direct access or changes to the underlying source code and may be performed at different times (e.g., before runtime or at runtime) using configuration files, commands issued through an interface, and/or in other defined ways.

The support functionality 108 is generally only configurable by a user, with modifications limited to such actions as selecting or deselecting functionality and/or defining values for configuration parameters. In other embodiments, the support functionality 108 may also be customizable. It is understood that the ability to modify the processing functionality 106 and/or the support functionality 108 may be limited or non-existent in some embodiments.

The support functionality 108 supports the processing functionality 106 by handling general configuration of the NIO platform 100 at runtime and providing management functions for starting and stopping the processing functionality. The resulting niograms can be converted into any signal type(s) for output(s) 104.

Referring to FIG. 1B, one embodiment of a NIO platform instance 101 illustrates a data path that starts when the input signal(s) 102 are received and continues through the generation of the output(s) 104. The NIO platform instance 101 is created when the NIO platform 100 of FIG. 1A is launched. A NIO platform may be referred to herein as a “NIO platform” before being launched and as a “NIO platform instance” after being launched, although the terms may be used interchangeably for the NIO platform after launch. As described above, niograms are used internally by the NIO platform instance 101 along the data path.

In the present example, the input signal(s) 102 may be filtered in block 110 to remove noise, which can include irrelevant data, undesirable characteristics in a signal (e.g., ambient noise or interference), and/or any other unwanted part of an input signal. Filtered noise may be discarded at the edge of the NIO platform instance 101 (as indicated by arrow 112) and not introduced into the more complex processing functionality of the NIO platform instance 101. The filtering may also be used to discard some of the signal's information while keeping other information from the signal. The filtering saves processing time because core functionality of the NIO platform instance 101 can be focused on relevant data having a known structure for post-filtering processing. In embodiments where the entire input signal is processed, such filtering may not occur. In addition to or as alternative to filtering occurring at the edge, filtering may occur inside the NIO platform instance 101 after the signal is converted to a niogram.

Non-discarded signals and/or the remaining signal information are converted into niograms for internal use in block 114 and the niograms are processed in block 116. The niograms may be converted into one or more other formats for the output(s) 104 in block 118, including actions (e.g., actuation signals). In embodiments where niograms are the output, the conversion step of block 118 would not occur.

Referring to FIG. 1C, one embodiment of a stack 120 is illustrated. In the present example, the NIO platform 100 interacts with an operating system (OS) 122 that in turn interacts with a device 124. The interaction may be direct or may be through one or more other layers, such as an interpreter or a virtual machine. The device 124 can be a virtual device or a physical device, and may be standalone or coupled to a network.

Referring to FIG. 1D, another embodiment of a stack 126 is illustrated. In the present example, the NIO platform 100 interacts with a higher layer of software 128a and/or a lower layer of software 128b. In other words, the NIO platform 100 may provide part of the functionality of the stack 126, while the software layers 128a and/or 128b provide other parts of the stack's functionality. Although not shown, it is understood that the OS 122 and device 124 of FIG. 1C may be positioned under the software layer 128b if the software 128b is present or directly under the NIO platform 100 (as in FIG. 1C) if the software layer 128b is not present.

Referring to FIG. 1E, one embodiment of a system 130 is illustrated. The system 130 is one possible example of a portion or all of the device 124 of FIG. 1C. The system 130 may include a controller (e.g., a processor/central processing unit (“CPU”)) 132, a memory unit 134, an input/output (“I/O”) device 136, and a network interface 138. The components 132, 134, 136, and 138 are interconnected by a data transport system (e.g., a bus) 140. A power supply (PS) 142 may provide power to components of the system 130 via a power transport system 144 (shown with data transport system 140, although the power and data transport systems may be separate).

It is understood that the system 130 may be differently configured and that each of the listed components may actually represent several different components. For example, the CPU 132 may actually represent a multi-processor or a distributed processing system; the memory unit 134 may include different levels of cache memory, main memory, hard disks, and remote storage locations; the I/O device 136 may include monitors, keyboards, and the like; and the network interface 138 may include one or more network cards providing one or more wired and/or wireless connections to a network 146. Therefore, a wide range of flexibility is anticipated in the configuration of the system 130, which may range from a single physical platform configured primarily for a single user or autonomous operation to a distributed multi-user platform such as a cloud computing system.

The system 130 may use any operating system (or multiple operating systems), including various versions of operating systems provided by Microsoft (such as WINDOWS), Apple (such as Mac OS X), UNIX, and LINUX, and may include operating systems specifically developed for handheld devices (e.g., iOS, Android, Blackberry, and/or Windows Phone), personal computers, servers, and other computing platforms depending on the use of the system 130. The operating system, as well as other instructions (e.g., for telecommunications and/or other functions provided by the device 124), may be stored in the memory unit 134 and executed by the processor 132. For example, if the system 130 is the device 124, the memory unit 134 may include instructions for providing the NIO platform 100 and for performing some or all of the methods described herein.

The network 146 may be a single network or may represent multiple networks, including networks of different types, whether wireless or wireline. For example, the device 124 may be coupled to external devices via a network that includes a cellular link coupled to a data packet network, or may be coupled via a data packet link such as a wide local area network (WLAN) coupled to a data packet network or a Public Switched Telephone Network (PSTN). Accordingly, many different network types and configurations may be used to couple the device 124 with external devices.

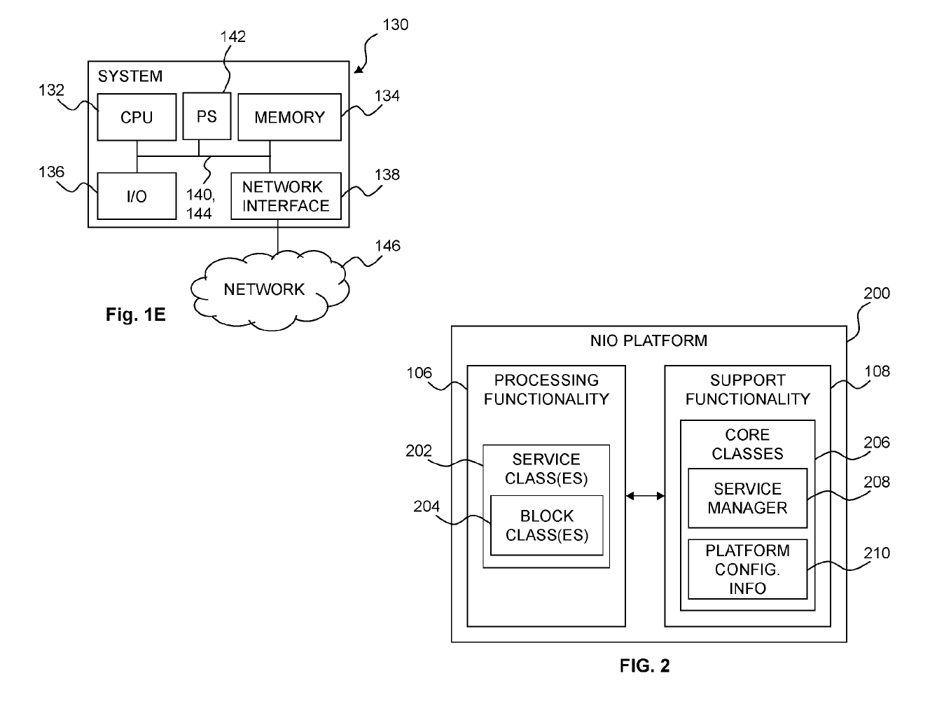

Referring to FIG. 2, a NIO platform 200 illustrates a more detailed embodiment of the NIO platform 100 of FIG. 1A. In the present example, the NIO platform 200 includes two main components: service classes 202 for one or more services that are to provide the configurable processing functionality 106 and core classes 206 for a core that is to provide the support functionality 108 for the services. Each service corresponds to block classes 204 for one or more blocks that contain defined task specific functionality for processing niograms. The core includes a service manager 208 that will manage the services (e.g., starting and stopping a service) and platform configuration information 210 that defines how the NIO platform 200 is to be configured, such as what services are available when the instance is launched.

When the NIO platform 200 is launched, a core and the corresponding services form a single instance of the NIO platform 200. It is understood that multiple concurrent instances of the NIO platform 200 can run on a single device (e.g., the device 124 of FIG. 1C). Each NIO platform instance has its own core and services. The most basic NIO platform instance is a core with no services. The functionality provided by the core would exist, but there would be no services on which the functionality could operate. Because the processing functionality of a NIO platform instance is defined by the executable code present in the blocks and the services are configured as collections of one or more blocks, a single service containing a single block is the minimum configuration required for any processing of a niogram to occur.

It is understood that FIG. 2 illustrates the relationship between the various classes and other components. For example, the block classes are not actually part of the service classes, but the blocks are related to the services. Furthermore, while the service manager is considered to be part of the core for purposes of this example (and so created using the core classes), the core configuration information is not part of the core classes but is used to configure the core and other parts of the NIO platform 200.

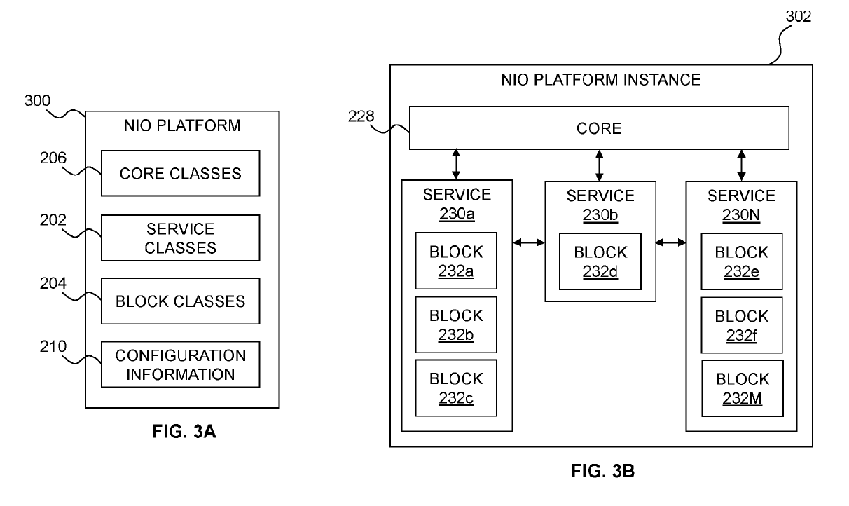

With additional reference to FIGS. 3A and 3B, another embodiment of the NIO platform 200 of FIG. 2 is illustrated as a NIO platform 300 prior to being launched (FIG. 3A) and as a NIO platform instance 302 after being launched (FIG. 3B). FIG. 3A illustrates the NIO platform 300 with core classes 206, service classes 202, block classes 204, and configuration information 210 that are used to create and configure a core 228, services 230a-230N, and blocks 232a-232M of the NIO platform instance 302. It is understood that, although not shown in FIG. 3B, the core classes 206, service classes 202, block classes 204, and configuration information 210 generally continue to exist as part of the NIO platform instance 402.

Referring specifically to FIG. 3B, the NIO platform instance 302 may be viewed as a runtime environment within which the core 228 creates and runs the services 230a, 230b, . . . , and 230N. Each service 230a-230N may have a different number of blocks. For example, service 230a includes blocks 232a, 232b, and 232c. Service 230b includes a single block 232d. Service 230N includes blocks 232e, 232f, . . . , and 232M.

One or more of the services 230a-230N may be stopped or started by the core 228. When stopped, the functionality provided by that service will not be available until the service is started by the core 228. Communication may occur between the core 228 and the services 230a-230N, as well as between the services 230a-230N themselves.

In the present example, the core 228 and each service 230a-230N is a separate process from an operating system/hardware perspective. Accordingly, the NIO platform instance 302 of FIG. 3B would have N+1 processes running, and the operating system may distribute those across multi-core devices as with any other processes. It is understood that the configuration of particular services may depend in part on a design decision that takes into account the number of processes that will be created. For example, it may be desirable from a process standpoint to have numerous but smaller services in some embodiments, while it may be desirable to have fewer but larger services in other embodiments. The configurability of the NIO platform 300 enables such decisions to be implemented relatively easily by modifying the functionality of each service 230a-230N.

In other embodiments, the NIO platform instance 302 may be structured to run the core 228 and/or services 230a-230N as threads rather than processes. For example, the core 228 may be a process and the services 230a-230N may run as threads of the core process.

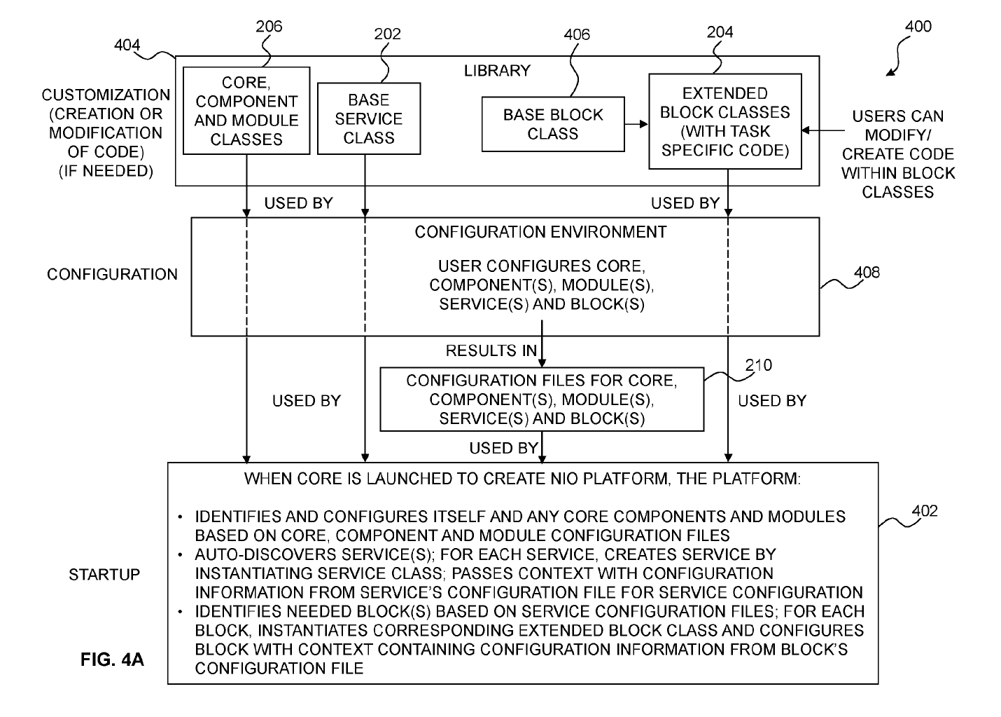

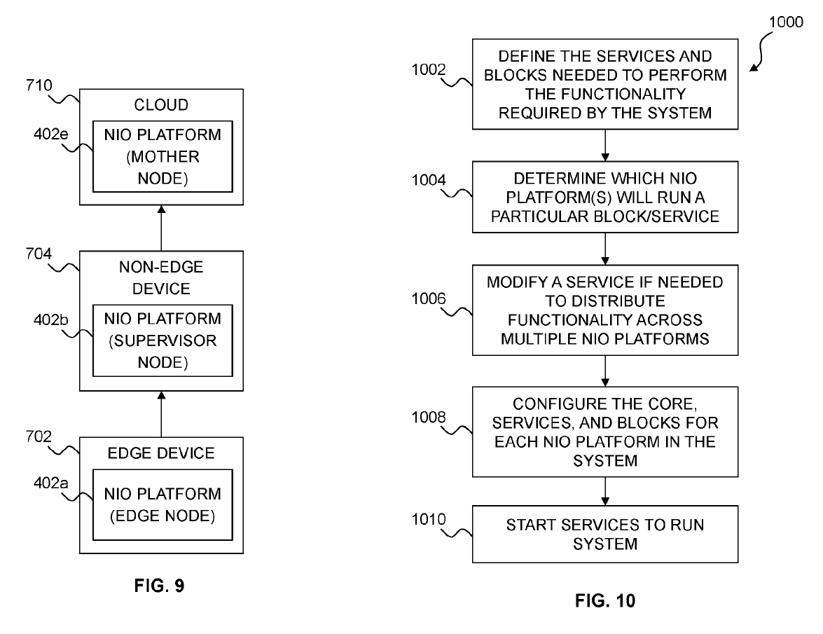

Referring to FIG. 4A, a diagram 400 illustrates one embodiment of a workflow that runs from creation to launch of a NIO platform 402 (which may be similar or identical to the NIO platform 100 of FIG. 1A, 200 of FIG. 2, and/or 300/302 of FIGS. 3A and 3B, as well as 900 of FIGS. 9A and 9B of previously referenced U.S. patent application Ser. No. 14/885,629). The workflow begins with a library 404. The library 404 includes core classes 206 (that include the classes for any core components and modules in the present example), a base service class 202, a base block class 406, and block classes 204 that are extended from the base block class 406. Each extended block class 204 includes task specific code. A user can modify and/or create code for existing blocks classes 204 in the library 404 and/or create new block classes 204 with desired task specific functionality. Although not shown, the base service class 202 can also be customized and various extended service classes may exist in the library 404.

The configuration environment 408 enables a user to define configurations for the core classes 206, the service class 202, and the block classes 204 that have been selected from the library 404 in order to define the platform specific behavior of the objects that will be instantiated from the classes within the NIO platform 402. The NIO platform 402 will run the objects as defined by the architecture of the platform itself, but the configuration process enables the user to define various task specific operational aspects of the NIO platform 402. The operational aspects include which core components, modules, services and blocks will be run, what properties the core components, modules, services and blocks will have (as permitted by the architecture), and when the services will be run. This configuration process results in configuration files 210 that are used to configure the objects that will be instantiated from the core classes 206, the service class 202, and the block classes 204 by the NIO platform 402.

In some embodiments, the configuration environment 408 may be a graphical user interface environment that produces configuration files that are loaded into the NIO platform 402. In other embodiments, the configuration environment 408 may use a REST interface (such as the REST interface 908, 964 disclosed in FIGS. 9A and 9B of previously referenced U.S. patent application Ser. No. 14/885,629) of the NIO platform 402 to issue configuration commands to the NIO platform 402. Accordingly, it is understood that there are various ways in which configuration information may be created and produced for use by the NIO platform 402.

When the NIO platform 402 is launched, each of the core classes 206 are identified and corresponding objects are instantiated and configured using the appropriate configuration files 210 for the core, core components, and modules. For each service that is to be run when the NIO platform 402 is started, the service class 202 and corresponding block classes 204 are identified and the services and blocks are instantiated and configured using the appropriate configuration files 210. The NIO platform 402 is then configured and begins running to perform the task specific functions provided by the services.

Referring to FIG. 4B, one embodiment of an environment 420 illustrates a user's perspective of the NIO platform 402 of FIG. 4A with external devices, systems, and applications 432. From the user's perspective, much of the functionality of the core 228, which may include core components 422 and/or modules 424, is hidden. Various core components 422 and modules 424 are discussed in greater detail in previously referenced U.S. patent application Ser. No. 14/885,629 and are not described further in the present example. The user has access to some components of the NIO platform 402 from external devices, systems, and applications 432 via a REST API 426. The external devices, systems, and applications 432 may include mobile devices 434, enterprise applications 436, an administration console 438 for the NIO platform 402, and/or any other external devices, systems, and applications 440 that may access the NIO platform 402 via the REST API.

Using the external devices, systems, and applications 432, the user can issue commands 430 (e.g., start and stop commands) to services 230, which in turn either process or stop processing niograms 428. As described above, the services 230 use blocks 232, which may receive information from and send information to various external devices, systems, and applications 432. The external devices, systems, and applications 432 may serve as signal sources that produce signals using sensors 442 (e.g., motion sensors, vibration sensors, thermal sensors, electromagnetic sensors, and/or any other type of sensor), the web 444, RFID 446, voice 448, GPS 450, SMS 452, RTLS 454, PLC 456, and/or any other analog and/or digital signal source 458 as input for the blocks 232. The external devices, systems, and applications 432 may serve as signal destinations for any type of signal produced by the blocks 232, including actuation signals. It is understood that the term “signals” as used herein includes data.

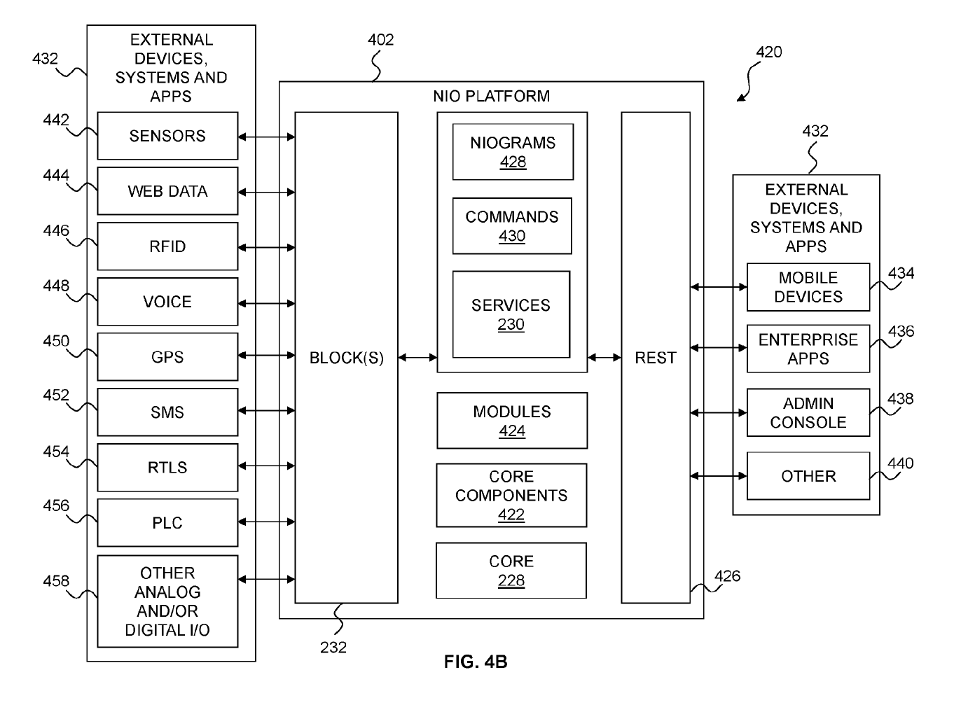

Referring to FIG. 5, one embodiment of a system 500 illustrates two NIO platforms 402a and 402b organized in a tiered or hierarchical arrangement within which real time processing can be performed. Within the system 500, the NIO platform 402a feeds into the NIO platform 402b. Although not shown, it is understood that the communications may be two way, with each of the NIO platforms 402a and 402b sending information (e.g., data and/or commands) to and receiving information from the other of the NIO platforms. For purposes of example, the NIO platform 402a is on an edge device for the system 500 and the NIO platform 402b is not on an edge device.

As described in previous embodiments, each NIO platform 402a and 402b uses the same basic core 228, but can be configured with different core components 912, modules 904, and/or services 230 with corresponding blocks 232. This configurability enables the NIO platform to serve as a single platform solution for the system 500 while supporting highly flexible distribution of the system's processing capabilities. For example, depending on which of the NIO platforms 402a and 402b is selected to run a particular service, particular processing functionality in the system 500 can be moved out to the edge or moved away from the edge as desired. Accordingly, the NIO platform can be used in multiple locations of the system 500 and the functionality of a particular one of the NIO platforms within the system 500 can be configured as desired.

By deploying the NIO platform 402a on an edge device, the fully configurable processing provided by the NIO platform 402a can be used to reduce and/or eliminate the need to transfer data for decision making to another device (e.g., a device on which the NIO platform 402b is running). This not only reduces network traffic, but also means that decisions can be made more quickly as the NIO platform 402a operating at the edge can be configured to make decisions and act on those decisions without the additional temporal overhead that would be required for the round trip transmission time that would be imposed by communications with the NIO platform 402b located on another device. If needed or desired, data can be transferred away from the edge and deeper into the system 500.

The configurability of the NIO platforms 402a and 402b in the system 500 may reduce and/or eliminate the need for customized hardware and/or software needed for particular tasks. The development of such hardware/software is often an expensive and time consuming task, and the development cycle may have to be repeated for each particular device that is to be integrated into or coupled to the system 500. For example, a particular server application may need to interact with different interfaces and/or different operating system running on different devices, and so multiple versions of the same software may be created.

In contrast, because the NIO platform can be configured as desired, adapting a particular service to another interface may be as simple as exchanging one block for another block and setting some configuration values. Furthermore, even though the services can be completely different on different NIO platforms, the use of a standard interface across the NIO platforms provides a consistent environment to users regardless of the services to be run. This enables a user familiar with the interface to configure a NIO platform for its particular task or tasks relatively easily.

Furthermore, because blocks can be reused and existing blocks can be modified, creating a service for a particular task may leverage existing assets. If new blocks are created, they can be used in other instances of the NIO platform. Therefore, each deployment of a particular configuration of the NIO platform 402 may result in a larger library of blocks, which in turn may lessen the amount of effort required for the next deployment. This is particularly true in cases where the next deployment has substantial similarities to the current deployment, such as deployments in different locations that perform similar or identical operations (e.g., manufacturing or agriculture operations).

Accordingly, the NIO platform 402a receives external input that may be any type(s) of input for which the NIO platform 402a is configured. The external input comes from one or more external devices, systems, and/or applications (not shown). As the NIO platform 402a is an edge device in the present example, the input will not be exclusively from another NIO platform, although some of the input may be from another NIO platform. The NIO platform 402a processes the input and then passes data based on the processed input to the NIO platform 402b. Depending on the configuration of the NIO platform 402a, the processing can range from simple (e.g., simply inserting the input into a niogram for forwarding) to complex (e.g., executing multiple related services with complex instructions). The NIO platform 402b can then perform further processing if needed.

This tiered system enables the NIO platform 402a to perform its functions at the point of input into the system 500, rather than having to pass the input to the NIO platform 402b for processing. When the NIO platform 402a is located on an edge device, this means that the input can be processed at the edge based on the particular configuration of the NIO platform 402a.

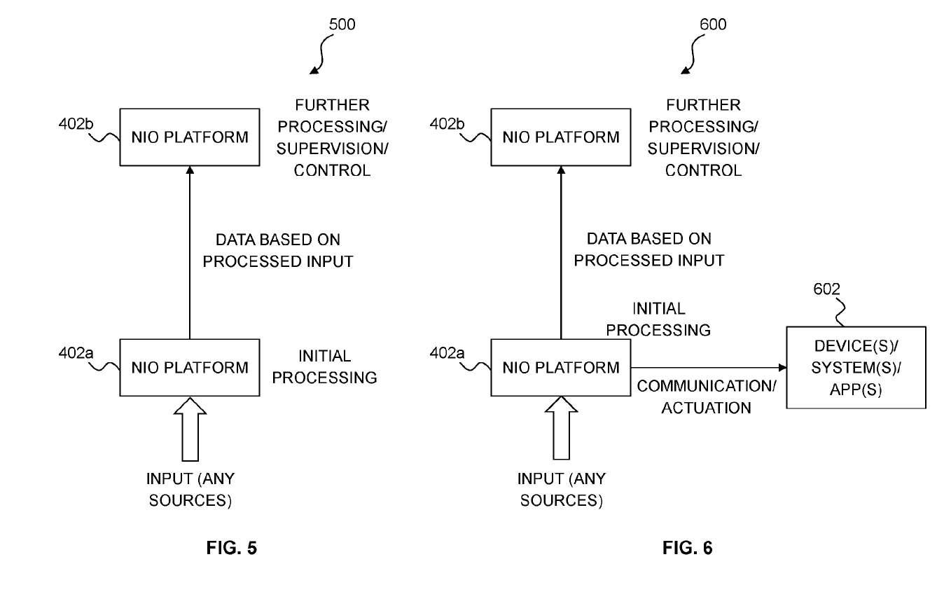

Referring to FIG. 6, one embodiment of a system 600 illustrates the two NIO platforms 402a and 402b of FIG. 5 and one or more devices, systems, and/or applications 602. As described with respect to FIG. 5, the NIO platforms 402a and 402b are organized in a tiered arrangement. As shown, the NIO platform 402a is an edge device and can directly actuate the device 602. This means that the processing performed on the input at the edge, which may include input from the device 602, can be used to actuate the device 602 or another device, system, or application. By configuring the services 230 on the NIO platform 402a to handle whatever logic may be desired with respect to the device 602, the actuation of the device 602 directly from the NIO platform 402a can occur in real time without introducing additional transmission time.

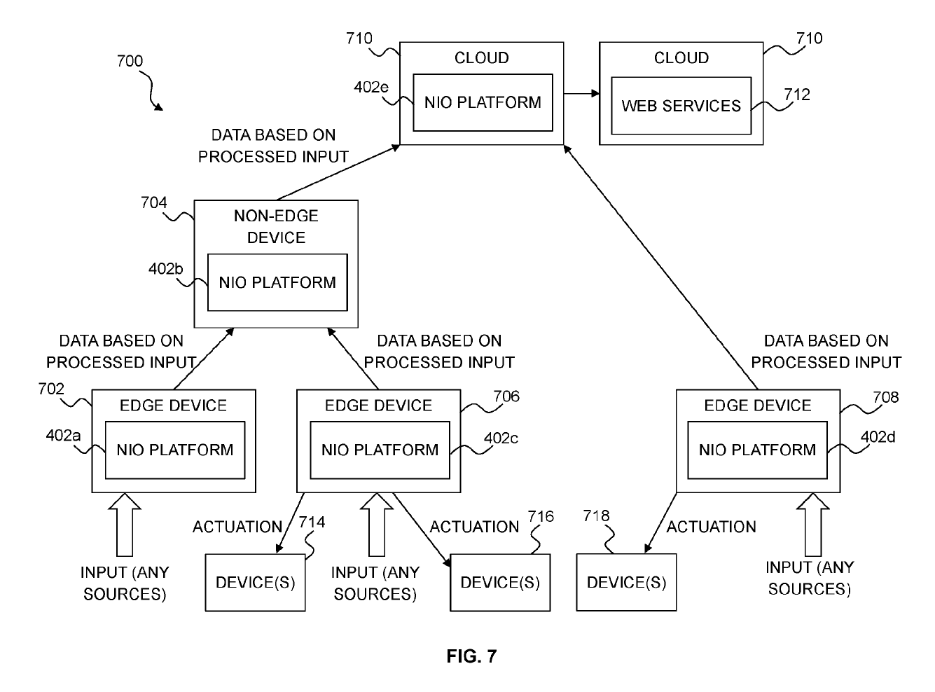

Referring to FIG. 7, one embodiment of a system 700 illustrates the two NIO platforms 402a and 402b of FIG. 5. The system 700 also includes additional NIO platforms 402c, 402d, and 402e. The NIO platforms 402a, 402c, and 402d are running on edge devices 702, 706, and 708, respectively. The NIO platform 402b is running on a non-edge device 704. The NIO platform 402e is running on a server/distributed server system (e.g., a cloud) 710.

The system 700 further includes devices 714, 716, and 718 (which may represent one or more devices, systems, and/or applications as shown in FIG. 6), as well as web services 712 running in the cloud, although these components may not be included in the system itself in embodiments where the NIO platforms are viewed as the system. In some embodiments, some or all of the web services 712 may be provided by the NIO platform 402e, while in other embodiments the web services 712 may be separate from the NIO platform 402e.

For purposes of example, the NIO platforms 402a, 402c, and 402d are referred to as being located on edge devices. More specifically, any NIO platform in the present example that is positioned to directly interface with a device other than a NIO platform is referred to as an edge platform or running on an edge device, while any NIO platform that only interfaces with other NIO platforms or the web services 712 for output is not an edge platform. Although not shown, it is understood that multiple instances of the NIO platform may be run on a single device. For example, the NIO platforms 402a and 402c may be run on one device, rather than on the two devices 702 and 706.

The NIO platforms 402a and 402c are configured to receive input from any source(s), process the input, and pass data based on the input to the NIO platform 402b. The NIO platform 402b is configured to process the received input and pass data based on the input to the NIO platform 402e. The NIO platform 402d is configured to receive input from any source(s), process the input, and pass data based on the input to the NIO platform 402e. The NIO platform 402e is configured to process the input and pass data based on the input to the web services 712 for output as a message (e.g., an email, SMS, or voice message), to a display (e.g., as a webpage), a database, and/or any other destination. It is understood that additional NIO platforms may be present in the system 700.

The arrows representing communication illustrate the general flow of data “up” through the tiers of the system 500 and “down” to the devices 714, 716, and 718 for actuation purposes. However, although the communications are illustrated as one way, it is understood that two way communications are likely to occur. For example, the NIO platforms will likely communicate with the NIO platforms at lower levels (e.g., the NIO platform 402e with the NIO platform 402b), and such communications may include configuration changes to the core 228, services 230, or blocks 232 of a particular NIO platform, commands to perform certain actions, actuation commands to be passed through to one of the devices 714, 716, or 718, and/or requests for data. Accordingly, depending on how the NIO platforms 402a-402e are configured and the capabilities of the devices on which the NIO platforms 402a-402e are running, the communications used with the system 700 may range from the simple to the complex.

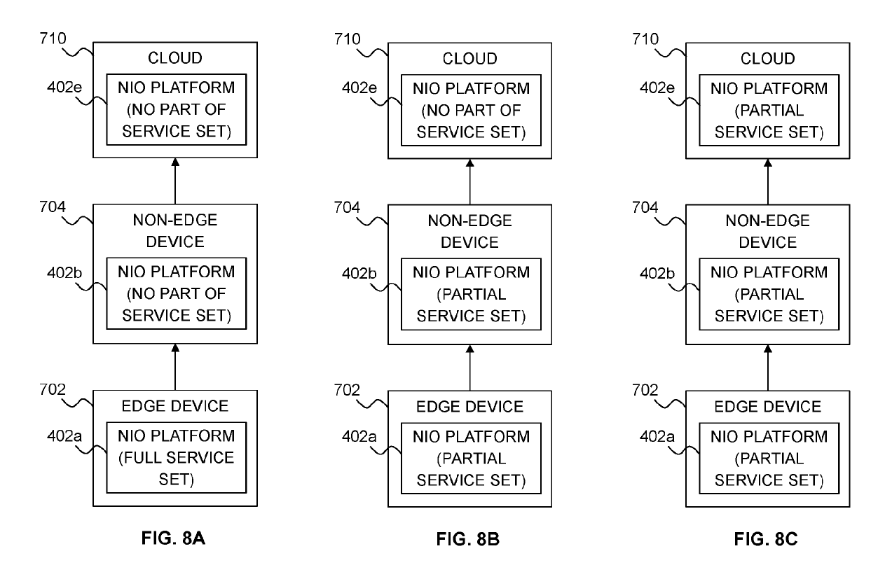

FIGS. 8A-8C illustrate embodiments of how a set of services 230 may be assigned to a single NIO platform or distributed among multiple NIO platforms. One advantage provided by using multiple instances of a single configurable platform to form a system such as the system 700 of FIG. 7 is that the system's functionality may be distributed relatively easily in many different ways simply by configuring the various NIO platforms as desired. It is understood that the service set may actually be a single service, but will often include multiple services that work together to accomplish a particular task. Accordingly, the following examples apply equally to a single service that can be divided into multiple services. The NIO platforms 402a, 402b, and 402e of FIG. 7 are used for purposes of example, with the set of services being responsible for receiving the input, performing defined processing tasks, and then producing a final output.

Referring specifically to FIG. 8A, the entire set of services is located on the NIO platform 402a. In this embodiment, the NIO platform 402a performs all the functions of receiving the input, performing the defined processing tasks, and producing the final output. The final output may include sending an actuation signal to a device, sending data to the NIO platform 402b, or waiting for additional input (e.g., not sending anything out). It is understood that the set of services may also be horizontally distributed (e.g., between two or more edge instances).

Referring specifically to FIG. 8B, the set of services is divided between the NIO platform 402a and the NIO platform 402b. In this embodiment, the NIO platform 402a would be responsible for receiving input. The functions of performing the defined processing tasks and producing the final output may be split between the NIO platforms 402a and 402b in many different ways. For example, the NIO platform 402a may perform part of the processing and send data to the NIO platform 402b. The NIO platform 402b may then perform additional processing and produce the final output.

In another example, the NIO platform 402a would be responsible for receiving input and would simply forward the input data to the NIO platform 402b. The NIO platform 402b would then perform the defined processing tasks and produce the final output. In yet another example, the NIO platform 402a would be responsible for receiving input and would forward the input data to the NIO platform 402b. The NIO platform 402b would then perform the defined processing tasks and send the processed data back to the NIO platform 402a, which would produce the final output.

Referring specifically to FIG. 8C, the set of services is divided among the NIO platform 402a, the NIO platform 402b, and the NIO platform 402e. In this embodiment, the NIO platform 402a would be responsible for receiving input. The functions of performing the defined processing tasks and producing the final output may be split among the NIO platforms 402a, 402b, and 402e in many different ways. For example, the NIO platform 402a may perform part of the processing and send data to the NIO platform 402b. The NIO platform 402b may then perform additional processing and send the processed data to the NIO platform 402e. The NIO platform 402e may perform additional processing and produce the final output or may simply produce the final output with minimal processing.

In another example, the NIO platform 402a would be responsible for receiving input and would forward the input data to the NIO platform 402b. The NIO platform 402b may be configured to process the data and then send the processed data to the NIO platform 402e for the final output. In yet another example, the NIO platform 402a would be responsible for receiving the input and performing initial processing, and would then send the processed data to the NIO platform 402b. The NIO platform 402b may be configured to simply pass the received data on to the NIO platform 402e for further processing and the final output. It is understood that the final output may be produced by any of the NIO platforms 402a, 402b, and 402e and sent to any of the other NIO platforms.

Accordingly, as illustrated by FIGS. 8A-8C, the use of the NIO platform in a multi-tiered arrangement enables services to be distributed as desired. For example, the device 702 on which the NIO platform 402a is running may have limited processing resources available (e.g., the device 702 may have limited CPU and/or memory resources), while the device 704 may have considerably more processing resources. In such an embodiment, the services may be divided so as much processing as possible is performed on the device 702, and the remainder is moved to the device 704. In another example, the device 702 may be capable of performing all the needed processing, and so may be configured to provide all of the processing and the final output. If the device 702 is capable of performing all the needed processing, configuring it to do so may result in less data being sent to the device 704, which may lower the amount of bandwidth needed for such data transfers (depending on the output of the NIO platform 402a). This can be particularly beneficial if the amount of bandwidth is relatively limited and/or shared by other devices.

The interchangeability of the NIO platforms, where a primary NIO platform can be replaced by a backup NIO platform with the same configuration, also makes the provision of failover or backup platforms relatively simple. For example, referring again to FIG. 7, the NIO platform 402a may be a backup or failover platform for the NIO platform 402c. In this example, the NIO platform 402a may not have any inputs or may have the exact same inputs as the NIO platform 402c. The NIO platform 402a or the NIO platform 402b would monitor the NIO platform 402c and, if the NIO platform 402c fails or becomes unresponsive, the NIO platform 402a would take over some or all of the functionality provided by the NIO platform 402c.

In another example, the NIO platform 402a may aid the NIO platform 402c if the NIO platform 402c receives an input data surge that it is unable to handle with its current processing capabilities. The NIO platform 402a would handle the overflow processing in such cases. Once the surge subsides, the NIO platform 402c would no longer need help handling the overflow processing and the NIO platform 402a could return to a standby mode.

In another example, the NIO platform 402a may be configured to run services that are also configured to be run on multiple other NIO platforms. This enables the single NIO platform 402a to aid different NIO platforms as the need arises. For example, the NIO platform 402a may be running on a relatively powerful device that matches the processing resources of the other devices on the NIO platforms are running, which in turn enables the NIO platform 402a to aid multiple other NIO platforms simultaneously. This allows a relatively powerful device to be used to run a backup, failover, and/or overflow NIO platform for multiple other NIO platforms. As the NIO platform 402a can be configured with whatever services are desired, this provides a very flexible solution that can be easily reconfigured to match changes in the configurations of the other NIO platforms and ensure continued support.

Referring to FIG. 9 and with continued reference to FIG. 7, one embodiment of the system 700 organizes the various NIO platforms 402a-402e in an arrangement of edge nodes, a supervisor node, and a mother node. In this example, the NIO platforms 402a, 402c, and 402d are edge nodes, the NIO platform 402b is a supervisor node, and the NIO platform 402e is a mother node. This hierarchy is shown in FIG. 9 for the NIO platforms 402a, 402b, and 402e.

For purposes of example, the edge nodes provided by the NIO platforms 402a, 402c, and 402d are distributed around a manufacturing facility. The NIO platforms 402a, 402c, and 402d connect to sensors, process all sensor data, and perform any local actuations (e.g., turning an LED on or off, or actuating a motor). The edge nodes are generally located out in the facility and so may be distributed based on logical locations for edge nodes within that facility.

The supervisor node provided by the NIO platform 402b monitors some or all of the edge nodes (only the NIO platforms 402a and 402c in FIG. 7) and their services. The NIO platform 402b detects when a primary node goes down and commands a backup node to take over. The supervisor node may also aggregate data from the NIO platforms being supervised, as well as make decisions that require data from multiple NIO platforms. The supervisor node may also handle any internet actuations (e.g., publish to a socket or save data to a cloud or local database). In some embodiments, the supervisor node may perform its actuations directly, while in other embodiments the supervisor node may perform its actuations via the mother node. The supervisor node may be located in different places, such as on a server local to the manufacturing facility or in the cloud.

The mother node provided by the NIO platform 402e monitors external access to the supervisor node and monitors that the supervisor node is running. The mother node is generally located in the cloud, although on site placement is also possible.

This arrangement of NIO platforms enables the formation of tiered systems where higher level NIO platforms can monitor lower level NIO platforms. The lowest level NIO platforms are edge nodes that interface with the devices, systems, and/or applications that are outside of the NIO platform network. Adding additional tiers of NIO platforms may enable the control structure to be extended with additional granularity. It is understood that the processing described in the preceding examples, as well as the communications between NIO platforms, may occur in real time. A real time system created using NIO platforms arranged in a tiered fashion as described herein is highly adaptable.

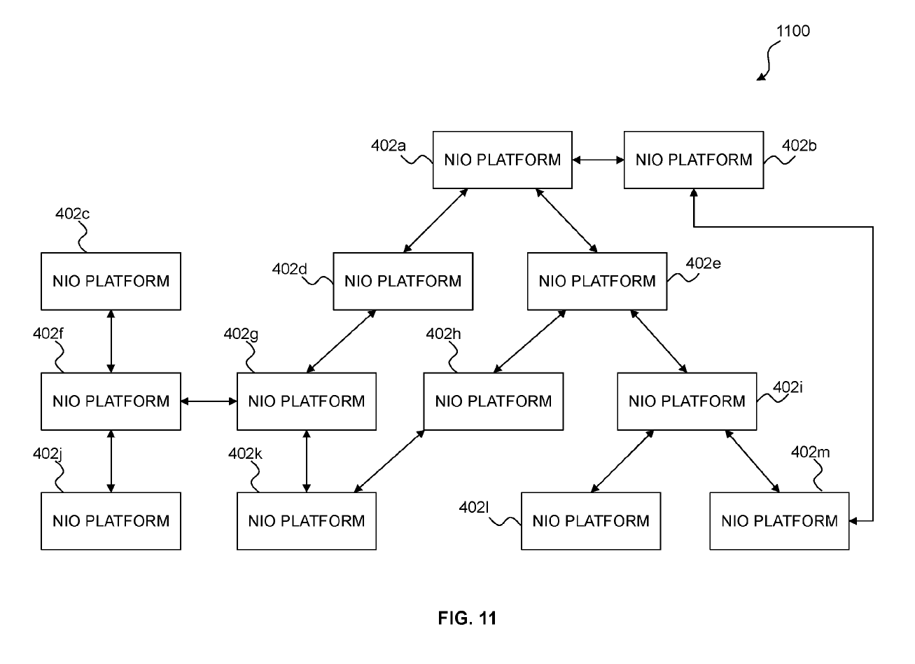

Referring to FIG. 10, a method 1000 illustrates one embodiment of a process that may be executed to create a system of NIO platforms, such as the system 700 of FIG. 7. It is understood that the method 1000 may be executed over a period of time and may be iterative in nature, with steps being repeated as needed until the overall method has been performed.

In step 1002, the services 230 and blocks 232 that are needed to perform the system's functionality are defined. The particular services 230 and blocks 232 may vary widely across different systems due to the various requirements of a particular system. For example, a system for process control in a manufacturing facility will have very different requirements compared to an agricultural control system or a point of sale/inventory system. While many systems will have similar high level requirements (e.g., the need for real time processing, communication, and actuation) and will use the same basic NIO platform architecture to meet those requirements, the particular services 230 and blocks 232 will likely be significantly different for each system.

In step 1004, a determination is made as to which NIO platform in the system 700 will run a particular block 232 and/or service 230. This step may include an analysis of the processing capabilities of various devices on which the NIO platforms are to be run. This allows the blocks 232 and/or services 230 to be distributed to take advantage of available processing resources. Alternatively, devices may be selected for particular NIO platforms based on the processing requirements imposed by the services 230 assigned to that particular NIO platform. Accordingly, step 1004 may be approached in different ways depending on such factors as whether the devices to be used can be selected or whether already installed devices must be used.

In step 1006, one or more of the services 230 may be modified if needed. For example, if a service 230 defined in step 1002 would be more efficient if distributed across multiple NIO platforms or if the service 230 as originally designed is too resource intensive for a particular device, the service 230 may be redesigned as multiple separate but connected services. Step 1006 may be omitted if not needed. In step 1008, the core 228, services 230, and blocks 232 for each NIO platform within the system 700 are configured. In step 1010, the service 230 are started to run the system 700.

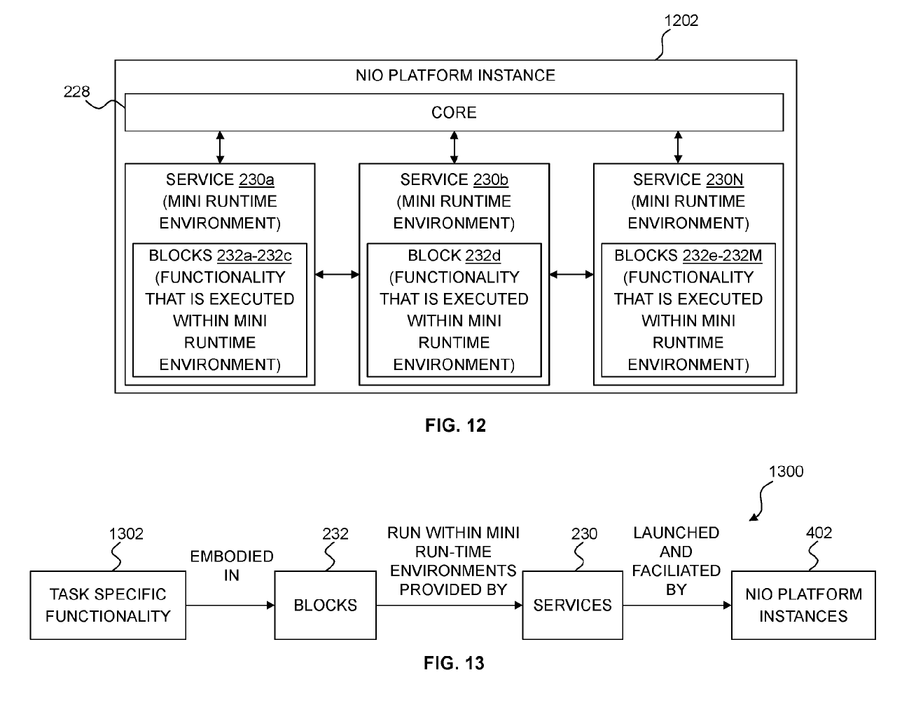

Referring to FIG. 11, one embodiment of a system 1000 includes NIO platforms 402a-402m. The various NIO platforms 402a-402m may be configured identically or each of the NIO platforms 402a-402m may have a different configuration. As shown in FIG. 11, there are many possible connections between NIO platforms in the tiered system 1100, including vertical connections between higher/lower tiered NIO platforms and horizontal connections between NIO platforms in the same tier. As shown by the direct connection between NIO platforms 402b and 402m, intermediate tiers may be bypassed if desired. Services may be distributed in many different ways throughout the system 1100.

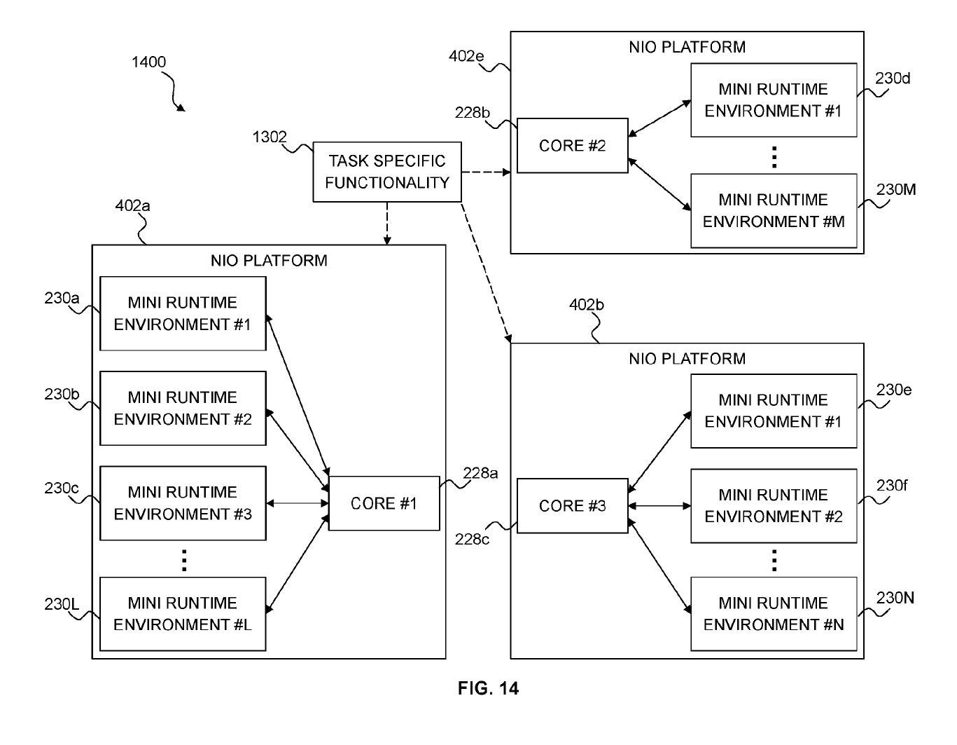

Referring to FIG. 12, one embodiment of a NIO platform instance 1202 illustrates a different perspective of the NIO platform instance 402 of FIG. 3B. The NIO platform instance 1202 (which may be similar or identical to the NIO platform 100 of FIG. 1A, 200 of FIG. 2A, 300 of FIG. 3A, and/or 402 of FIGS. 4A and 4B) is illustrated from the perspective of the task specific functionality that is embodied in the blocks. As described in previously referenced U.S. patent application Ser. No. 14/885,629, services 230 provide a framework within which blocks 232 are run, and a block cannot run outside of a service. This means that a service 230 can be viewed as a wrapper around a particular set of blocks 232 that provides a mini runtime environment for those blocks.

From this perspective, a service 230 is a configured wrapper that provides a mini runtime environment for the blocks 232 associated with the service. The base service class 202 is a generic wrapper that can be configured to provide the mini runtime environment for a particular set of blocks 232. The base block class 406 provides a generic component designed to operate within the mini runtime environment provided by a service 230. A block 232 is a component that is designed to run within the mini runtime environment provided by a service 230, and generally has been extended from the base block class 406 to contain task specific functionality that is available when the block 232 is running within the mini runtime environment. The purpose of the core 228 is to launch and facilitate the mini runtime environments.

To be clear, these are the same services 230, blocks 232, base service class 202, base block class 406, and core 228 that have been described previously in detail. However, this perspective focuses on the task specific functionality that is to be delivered, and views the NIO platform 1202 as the architecture that defines how that task specific functionality is organized, managed, and run. Accordingly, the NIO platform 1202 provides the ability to take task specific functionality and run that task specific functionality in one or more mini runtime environments. Multiple NIO platforms 1202 can be combined into a distributed system of mini runtime environments.

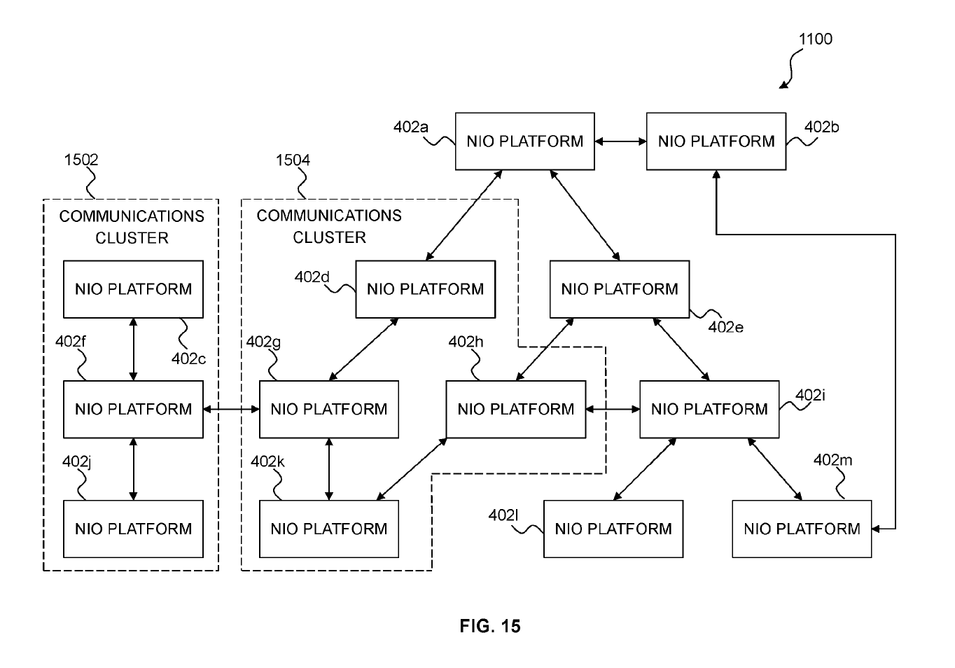

Referring to FIG. 13, a diagram 1300 illustrates one embodiment of a hierarchical flow that begins with task specific functionality 1302 and ends with NIO platform instances 402. More specifically, the task specific functionality 1302 is encapsulated within blocks 232, and those blocks may be divided into groups (not shown). Each group of blocks is wrapped in a service 230. Each service 230 is configured to run its blocks 232 within the framework (e.g., the mini runtime environment) provided by the service 230. The configuration of a service may be used to control some aspects of that particular service's mini runtime environment. This means that even though the basic mini runtime environment is the same across all the services 230, various differences may still exist (e.g., the identification of the particular blocks 232 to be run by the service 230, the order of execution of those blocks 232, and/or whether the blocks 232 are to be executed synchronously or asynchronously).

Accordingly, the basic mini runtime environment provided by the base service class 202 ensures that any block 232 that is based on the base block class 406 will operate within a service 230 in a known manner, and the configuration information for the particular service enables the service to run a particular set of blocks. The services 230 can be started and stopped by the core 228 of the NIO platform 402 that is configured to run that service.

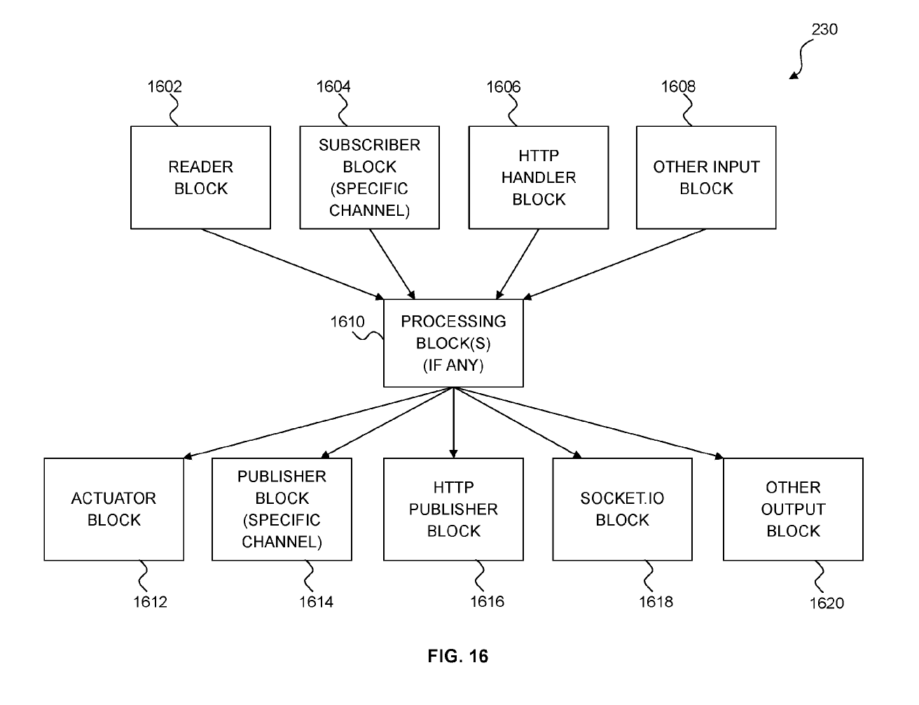

Referring to FIG. 14, one embodiment of a system 1400 is illustrated with the task specific functionality 1302 of FIG. 13. As described with respect to FIGS. 5-21, the flexibility provided by the use of blocks 232 and services 230 enables task specific functionality to be added, removed, modified, and/or distributed across a system containing multiple NIO platform instances in many different ways without requiring major modifications to the system architecture. This is further illustrated in FIG. 14 with NIO platforms 402a, 402b, and 402e, which may correspond, for example, to identically labeled platforms in FIGS. 8A-8C.

Each NIO platform 402a, 402b, and 402e can support multiple mini runtime environments (i.e., services) within which the task specific functionality 1302 can be executed. For example, the NIO platform 402a includes a core 228a (core #1) and multiple mini runtime environments 230a-230L. The NIO platform 402b includes a core 228b (core #2) and multiple mini runtime environments 230d-230M. The NIO platform 402c includes a core 228c (core #3) and multiple mini runtime environments 230e-230N. The task specific functionality 1302 can be located in some or all of the mini runtime environments, with each mini runtime environment being stopped and started as needed by the respective cores.

Accordingly, to develop a distributed system, various device/network capabilities (e.g., processor speed, memory, communication protocols, and/or bandwidth) may be identified (for an existing system) or specified (for a new system or a system being modified). The desired task specific functionality 1302 can then be distributed using a block/service distribution that accounts for those capabilities. Because of the NIO platform's architecture and the way it is able to run asynchronous and independent blocks in any mini runtime environment, the functionality can be divided in many different ways without requiring any substantial system changes as long as the device on which a particular block/service is to be run meets any requirements.

For example, in one system, edge devices may be sufficiently powerful to process relatively large amounts of data, thereby reducing network traffic. In another system, edge devices may not be so powerful and will have to transfer more data to NIO platforms on other devices for processing, thereby increasing network traffic. Because of the flexibility provided by the NIO platforms, this balancing of tradeoffs may be accomplished by distributing the same task specific functionality in different ways for each system.

For example, moving a block from a service on one device to a service on another device may be as simple as modifying the core and service configurations on both NIO platforms, updating the block's configuration (if needed), storing the block on the second NIO platform (if not already there), and updating existing input/output blocks or adding additional input/output blocks to the services (if needed) to move data from one service to another. Additionally, if a device running a NIO platform instance is powerful enough, additional services can be run by the existing NIO platform instance and/or another NIO platform instance with overlapping or totally different functionality can be started on the same device.

Accordingly, the use of distributed NIO platforms enables the design and implementation of systems where functionality, including real time processing functionality, can be shifted between NIO platforms as desired. Although some system limitations may not be addressed by moving functionality from one NIO platform to another (e.g., an edge device may not have the processing speed needed to process enough data to reduce network load as desired on a slow network), such flexibility can be advantageous when planning a system and/or modifying/upgrading an existing system. The use of NIO platforms provides a flexible distributed solution that does not lock a user into a particular configuration, but rather allows changes to be made on a per block or per service basis at any time and allows functionality to be added or removed, or simply stopped and started, as desired.

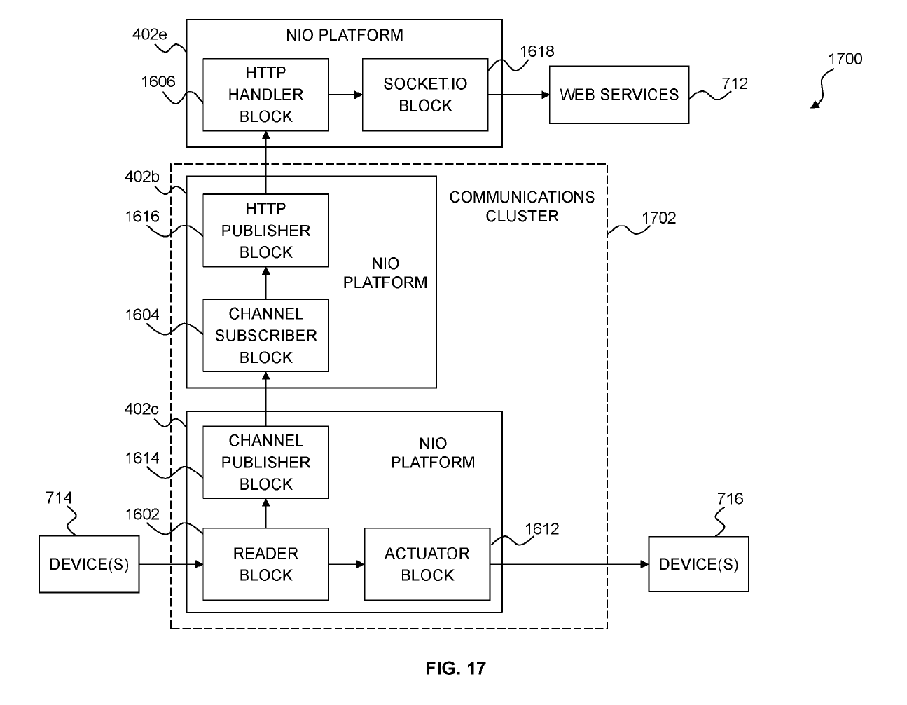

Referring to FIG. 15, another embodiment of the system 1100 of FIG. 11 illustrates how various NIO platforms 402a-402m may be grouped for communication purposes. The types of input(s) and output(s) for a specific NIO platform 402a-402m can be configured by modifying the services and their blocks as needed. It is understood that such configurations may include the use of modules and/or core components described with respect to FIGS. 9A and 9B of previously referenced U.S. patent application Ser. No. 14/885,629.

The ability to configure communication capabilities for a NIO platform at the service level provides flexibility by enabling the selection of communication types within a single NIO platform (e.g., between services), between two or more NIO platforms, and between a NIO platform and non-NIO enabled devices and software. Such selections may be used to account for particular network configurations, software and hardware requirements, protocol requirements, a particular distribution of services within a NIO platform and/or across multiple NIO platforms, and similar issues without requiring that the underlying NIO platform be changed. For example, the input and/or output communications for a particular service may be configured to use a publication/subscription model, a direct model (e.g., a TCP/IP connection), and/or another communication model as needed, and the input(s)/output(s) can use the same or different communication models. It is understood that a communication model may use one or more different communication protocols, standards, specifications, and/or implementations, and the particular model used may vary depending on the defined communication needs of a NIO platform or a group of NIO platforms.

In the present example, the options for communications between NIO platforms vary based on whether the particular NIO platforms 402a-402m are in a communications cluster. More specifically, the system 1100 includes a communication cluster 1502 and a communications cluster 1504. Communications among the NIO platforms within a communications cluster are handled by a single communications broker using a publication/subscription model. Any NIO platform that is configured to use the broker and is able to do so (e.g., is on a device that has the correct permissions for the network) is part of the communications cluster and can publish and subscribe to channels within that communications cluster. Any NIO platforms that are not configured to use that broker or are unable to do so are outside of the communications cluster and cannot publish and subscribe to those channels.

While a communications cluster can extend over multiple networks (e.g., may simultaneously include both LAN and cloud based NIO platforms), it is often located on a single network. The broker is typically located on one of the NIO platforms within the communications cluster, but may be located elsewhere (e.g., on a server) in other embodiments. It is noted that communications between NIO platforms within a communications cluster may use other communication models in addition to, or as an alternative to, the publication/subscription model.

Accordingly, the NIO platforms 402c, 402f, and 402j are configured to use the same broker within the communications cluster 1502. The NIO platforms 402d, 402g, 402h, and 402k are configured to use the same broker within the communications cluster 1504. The remaining NIO platforms 402a, 402b, 402e, 402i, 4021, and 402m are not part of a communications cluster.

Although not shown, it is understood that each NIO platform within a communications cluster can generally communicate with any other NIO platform within the same communications cluster (e.g., via pub/sub channels managed by the communications cluster's broker). Accordingly, in addition to the connections shown between the NIO platforms 402c and 402f and the NIO platforms 402f and 402j in the communications cluster 1502, the NIO platforms 402c and 402j may also communicate directly. Similarly, each of the NIO platforms in the communications cluster 1504 may communicate directly with the other NIO platforms in the communications cluster 1504. It is understood that, in some embodiments, authentication requirements, whitelist verification, and/or other security processes may need to be satisfied before such communications occur even in the same communications cluster.

Communications can occur between NIO platforms in different communication clusters, as illustrated by the line between the NIO platform 402f of the communications cluster 1502 and the NIO platform 402g of the communications cluster 1504. Such communications may be based on TCP/IP, UDP, or another suitable communication protocol. Communications can also occur between a NIO platform within a communication cluster and a NIO platform outside of a communication cluster. This is illustrated by the line between the NIO platform 402d of the communications cluster 1504 and the NIO platform 402a that is not in a communications cluster 1504, and by the lines between the NIO platform 402h of the communications cluster 1504 and the NIO platforms 402e and 402i that are not in a communications cluster 1504. Such communications may be based on TCP/IP, UDP, or another suitable communication protocol.

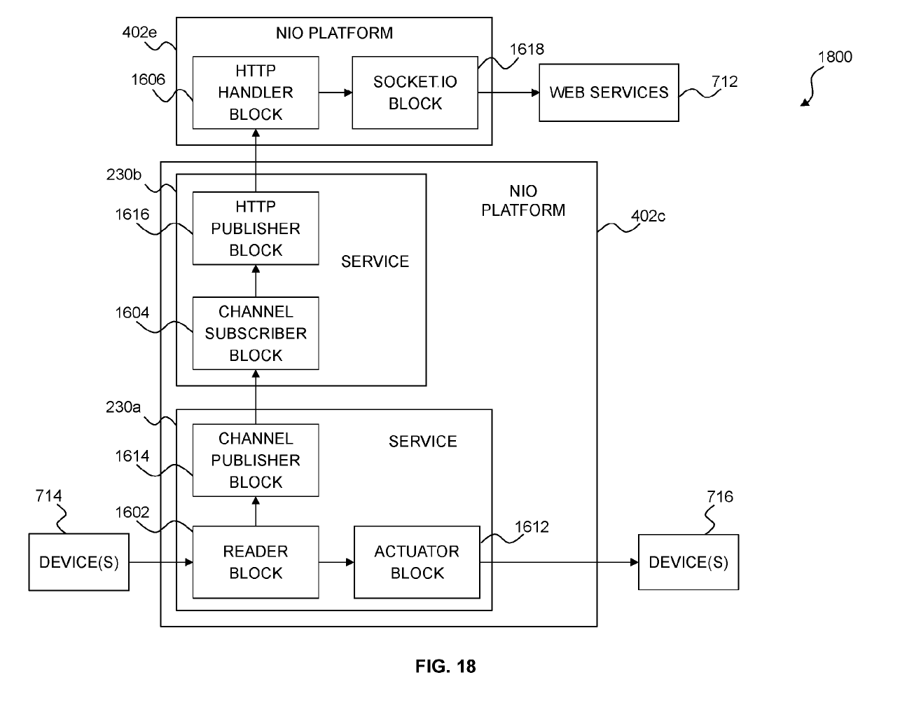

Referring to FIG. 16, one embodiment of a service 230 is illustrated with various blocks 1602-1620 that may be used to provide input and output functionality to the service 230. It is understood that not all services may be configured with input and output blocks as shown, and that some services may have input and/or output blocks located at positions within the service (e.g., not as the first or last block to be executed). However, the service 230 of the present example provides an illustration of the different ways in which a service may receive input from one or more sources and send output to one or more destinations, regardless of where the particular blocks are located in the service.

The service 230 may be configured with one or more input blocks, such as a reader block 1602 to receive data from an analog or digital device (e.g., by polling a pin or a port), a subscriber block 1604 that is configured to receive data from a particular publication channel, an HTTP handler block 1606 to receive HTTP formatted data via a TCP/IP connection, and an “other input” block 1608 that may receive data via any type of communications channel for which the block is configured. The input is passed to one or more processing blocks 1610 if such blocks are present and the service 230 is configured to do so.

The service 230 may be configured with one or more output blocks, such as an actuator block 1612 to perform an actuation, a publisher block 1614 that is configured to send data to a particular publication channel, an HTTP publisher block 1616 to send HTTP formatted data via a TCP/IP connection, a socket.io block 1618 that is configured to send data directly to a socket server, and an “other output” block 1620 that may send data via any type of communications channel for which the block is configured.

The “other” input block 1608 and “other” output block 1620 may be customized for use with any desired communication protocol, standard, specification, and/or implementation. For example, one or both of the blocks may be configured for communications based on Global System for Mobile Communications (GSM), Enhanced Data rates for GSM Evolution (EDGE), Universal Mobile Telecommunications System (UMTS), High Speed Packet Access (HSPA), Long-Term Evolution (i.e., 4G LTE), Bluetooth, Wi-Fi, RuBee, Z-Wave, near field communication (NFC), iBeacon, Eddystone, radio frequency identification (RFID), open systems interconnection (OSI), secure socket layer (SSL), point to point protocol (PPP), IPv6 over Low power Wireless Personal Area Networks (6LoWPAN), IEEE 802.11, IEEE 802.15.4, and implementations based on such standards, such as Thread and Zigbee.

It is understood that each particular customization of an input block or an output block may be directed to one or more such protocols, standards, specifications, and/or implementations, and may include configuration options that are used to configure the block for use with a particular service on a particular NIO platform. For example, the blocks 1604 and 1614 include a configurable parameter for the channel to which the block 1604 is to publish and the channel to which the block 1614 is to subscribe. The same base publisher and subscriber blocks can then be used by different services with the configurable parameters differing based on the channel to be used by the corresponding service. In another example, the block 1618 contains the task specific functionality to send content to a socket.io server room. To accomplish this, the block 1618 includes configurable parameters for a host (e.g., a location of a socket.io server), a port (e.g., a port of the socket.io server), a room (e.g., a room on the socket.io to which the content should be sent), and an option to configure the block 1618 to listen for messages from the socket.io room.

In other embodiments, an input block or an output block may not handle such protocols, standards, specifications, and/or implementations directly. In such embodiments, the block may communicate with the operating system and/or device on which the NIO platform is running, and the operating system or device may then handle the actual formatting of the data as required by the particular protocol, standard, specification, and/or implementation.

It is further understood that the ease with which changes to communications can be made depends somewhat on the design of the input blocks 1602-1608, the output blocks 1612-1620, and the processing blocks 1610. For example, if the processing block 1610 that receives the input from one of the input blocks 1602-1608 is able to handle input from any of the input blocks, then modifying the service 230 to receive a different type of input may be accomplished by simply replacing the current input block with a different input block. This scenario may occur, for example, if the task specific functionality of the input blocks 1602-1608 is customized to produce a similar or identical output, or the task specific functionality of the processing block 1610 is customized to handle different types of information to account for differences between the input blocks 1602-1608. However, if the processing block 1610 is only able to receive input from a particular one of the input blocks 1602-1608 (e.g., the input is in a format produced by the particular output block but other output blocks use different formats), then the processing block 1610 may also need to be replaced or modified for compatibility if the input block is changed.

The same issue exists with the processing blocks 1610 and the output blocks 1612-1620, with the ease of change depending on how the processing block 1610 formats and presents information to the output blocks 1612-1620 and how the output blocks 1612-1620 handle the information received from the processing block 1610. In the present example, the input blocks 1602-1608 and output blocks 1612-1620 are designed to be swappable without requiring any changes to the processing blocks 1610. In other embodiments, one or more of the processing blocks 1610 may require changes when one of the input blocks 1602-1608 or output blocks 1612-1620 is changed.

Accordingly, the service 230 can be configured to receive and send data as desired by selecting and configuring the appropriate input and output blocks for the service 230 to use. Multiple input blocks and output blocks can be used to configure the service 230 with alternate or additional receive and send functionality. This means that a single service 230 can handle multiple types of inputs and outputs, either simultaneously or as alternatives based on defined criteria, which provides a great deal of flexibility. As each service 230 on a NIO platform can be configured individually, the communications capability of the NIO platform can be modified simply by adding, removing, and/or changing the input and/or output blocks used by a service. This flexibility is extremely useful when the NIO platform is being configured for use as part of a tiered structure of NIO platforms, as the services can be configured for whatever communications are desired simply by configuring each service to use the desired input and output blocks.

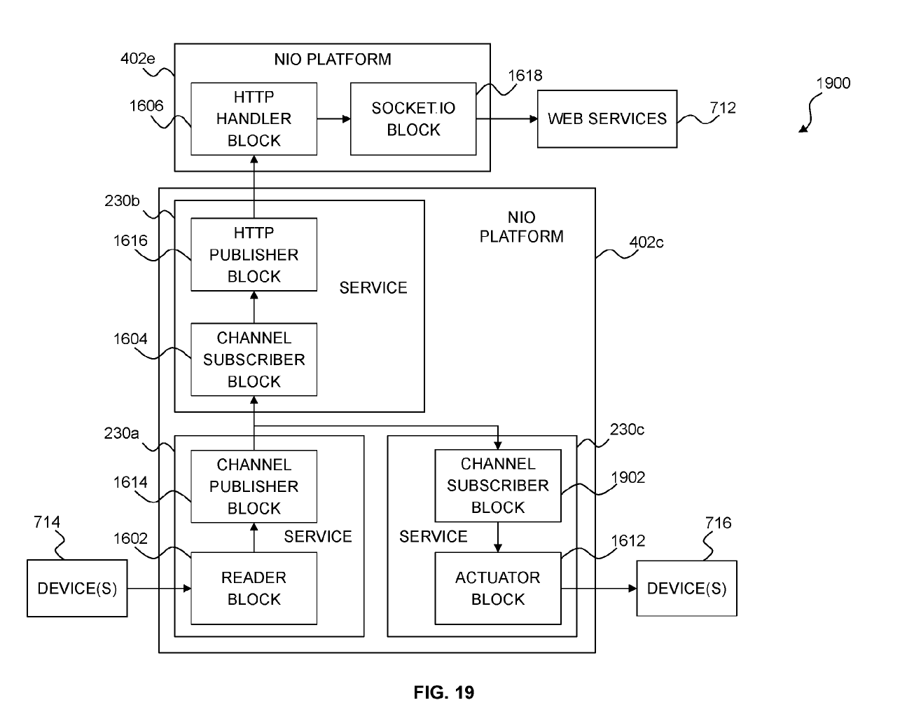

Referring to FIG. 17, one embodiment of a system 1700 is illustrated with the NIO platforms 402b, 402c, and 402e, and the devices 714 and 716 of FIG. 7. In the present example, the NIO platform 402c receives input from the device 714 and actuates the device 716. It is understood that the devices 714 and 716 may be the same device in some embodiments. The NIO platforms 402b and 402c are in a communications cluster 1702, and the NIO platform 402e is not in the communications cluster 1702.

The system 1700 is illustrated with only input and output blocks present for each NIO platform 402b, 402c, and 402e in order to illustrate how the NIO platforms may communicate. The services and other processing blocks are omitted, as are any intra-platform input and output blocks that may be used between services on a single NIO platform.

The NIO platform 402c receives input from the device 714 using a reader block 1602. The NIO platform 402c sends output as an actuation to device 716 using an actuator block 1612 and as a publication to a specific channel using channel publisher block 1614. The outputs may be sent by a single service or by different services. If different services are used, the inter-service communications may be accomplished via a publication/subscription model or in a different way.

The NIO platform 402b receives input from the NIO platform 402c using a channel subscriber block 1604, and sends HTTP compliant output to the NIO platform 402e using an HTTP publisher block 1616. The NIO platform 402e receives input from the NIO platform 402b using an HTTP handler block 1606, and sends an output to the web services 712 using a socket.io block 1618.

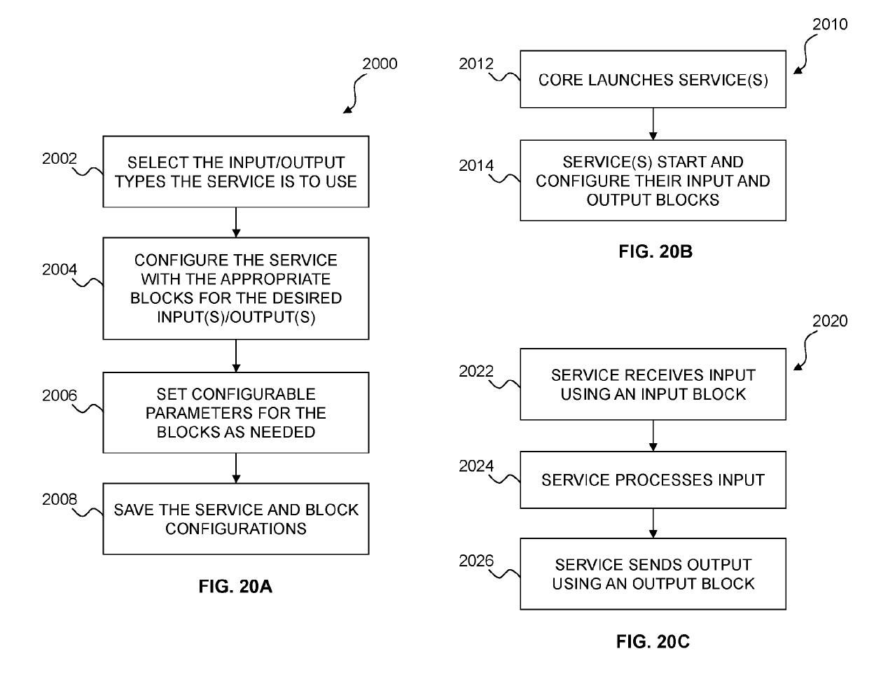

Referring to FIG. 18, one embodiment of a system 1800 is illustrated with the NIO platforms 402c and 402e and the devices 714 and 716 of FIG. 17. In the present example, the NIO platform 402c includes services 230a and 230b that provide the functionality that was previously divided between the NIO platforms 402b and 402c in FIG. 17. The channel publisher block 1614 and channel subscriber block 1604 are now used to route information from the service 230a to the service 230b on the single NIO platform 402c, rather than between two different NIO platforms as illustrated in FIG. 17. This illustrates the ease with which services can be distributed or consolidated on a per platform basis, and also illustrates the usefulness of being able to configure communications on a per service basis.

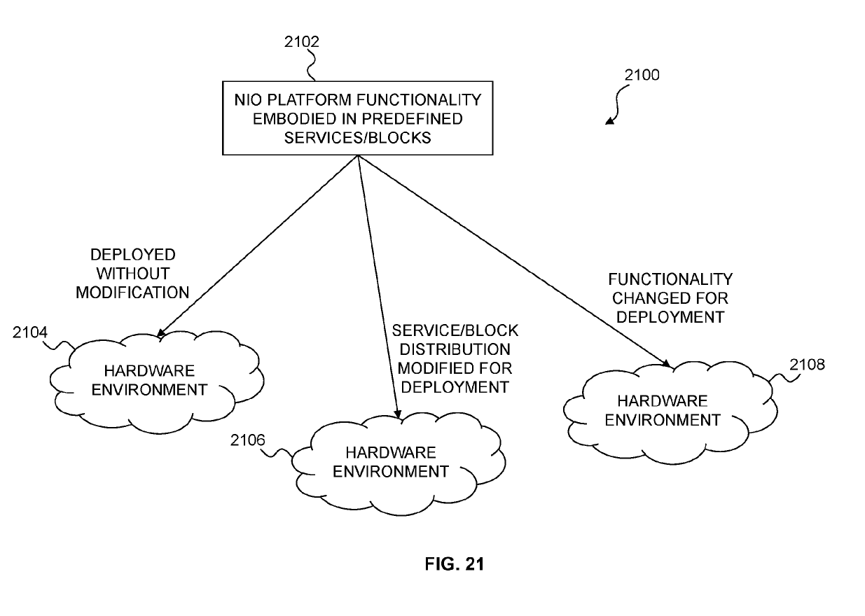

Referring to FIG. 19, one embodiment of a system 1900 is illustrated with the NIO platforms 402c and 402e and the devices 714 and 716 of FIG. 18. In the present example, the NIO platform 402c includes services 230a and 230c that provide the functionality that was previously contained in the service 230a in FIG. 18. The channel publisher block 1614 and a channel subscriber block 1902 in the service 230c are now used to route information from the service 230a to the service 230c. This illustrates the ease with which services can be distributed or consolidated on a per platform basis, and also illustrates the usefulness of being able to configure communications on a per service basis.

It is understood that the embodiments of FIGS. 17-19 may be provided using multiple NIO platform instances running on a single device as shown in FIG. 11 of previously referenced U.S. patent application Ser. No. 14/885,629. Some or all of the NIO platform instances on the device may be part of a communications cluster and/or may use other communication channels to communicate with each other, to communicate with NIO platforms external to the device, and to communicate with devices that do not use NIO platforms. For example, the services 230a-230c of FIG. 19 may be run by separate NIO platform instances, rather than the single NIO platform instance 402c, and those NIO platform instances may be running on a single device. In some embodiments, the NIO platform 402e may also be running on the same device as the other NIO platforms. In some embodiments, different NIO instances on the same device may be part of different communications clusters.

Accordingly, the various communication channels described herein may be used within a single NIO platform instance, between NIO platform instances on a single device, and between NIO platform instances on different devices. In addition, a NIO platform instance may use one or more of the communication channels described herein to communicate with the device or a part of the device (e.g., a sensor) on which the NIO platform instance is running, in addition to or as an alternative to communicating with an operating system and/or any APIs running on the device using defined OS and API calls.

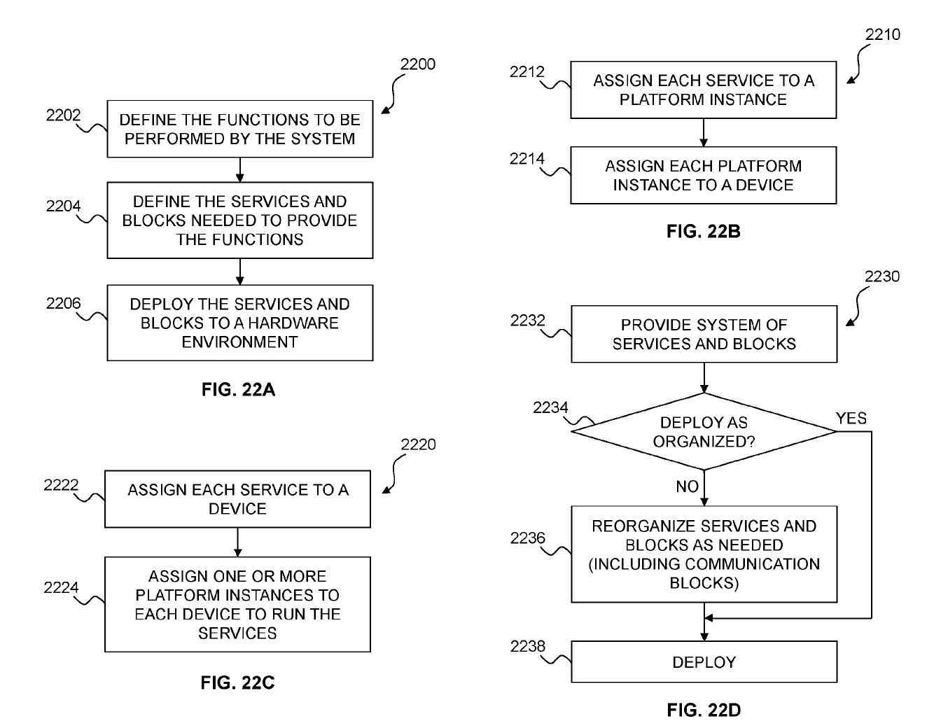

Referring to FIG. 20A, a method 2000 illustrates one embodiment of a process that may be executed to configure a service (e.g., the service 230 of FIG. 16) of a NIO platform for communication. As previously described, various blocks may contain task specific instructions for providing particular types of communications. Such blocks may include configurable parameters that can be used to configure a block for use by the particular service 230.

In step 2002, the input(s) and output(s) that the service 230 will be using are selected. As illustrated in previous examples, this may depend on the other services and/or devices with which the service 230 will be communicating, whether the NIO platform running the service 230 is within a communications cluster, and similar factors. In step 2004, the service 230 is configured with the appropriate blocks for the desired input(s) and output(s). In step 2006, configurable parameters within the blocks may be set as needed. In step 2008, the service and block configurations are saved for use by the NIO platform.

Referring to FIG. 20B, a method 2010 illustrates one embodiment of a process that may be executed by a NIO platform. In step 2012, the NIO platform's core launches the services as previously described. In step 2014, the services start and configure their input and output blocks for use in communications.

Referring to FIG. 20C, a method 2020 illustrates one embodiment of a process that may be executed by a running service (e.g., the service 230 of FIG. 16). As previously described, various blocks may contain task specific instructions for providing particular types of communications. In step 2022, the service 230 receives input using an input block, which handles the input as configured. In step 2024, the service 230 processes the input. In step 2026, the service 230 produces output using an output block, which handles the output as configured. As described previously, the task specific functionality of the input and output blocks and their configurations may be modified to alter the input and output functionality of the service 230.

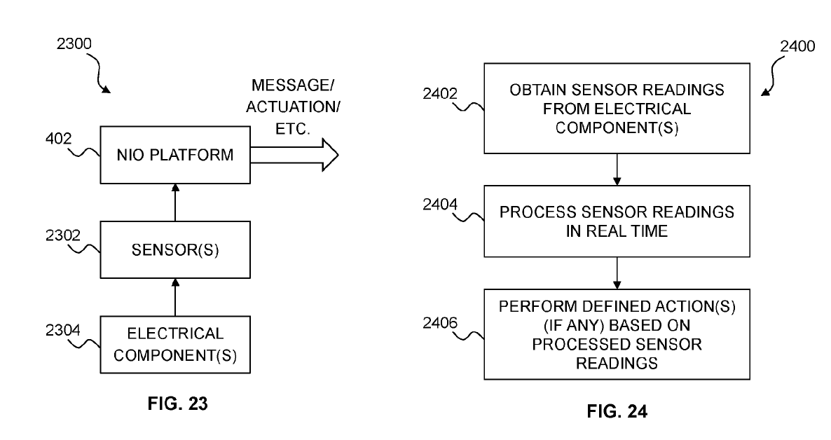

Referring to FIG. 21, one embodiment of an environment 2100 illustrates task specific NIO platform functionality 2102 that is embodied in services 230 and blocks 232 (not shown). The functionality 2102 may be of any level of complexity and may range from a single service that is expected to be run on a single NIO platform to many different interrelated services that are expected to be run on one or more NIO platforms (e.g., in a distributed manner). For example, the functionality 2102 may be for a specific task (e.g., a service configured to read from a specific sensor, monitor an external device or a data stream, report on device characteristics, or publish received information to a web socket) or may be for a more complex system such as a management and control system for an industrial environment or an agricultural environment. The functionality may provide a base level of functionality (e.g., a barebones system) or may be a fully realized management system capable of monitoring, controlling, actuating, reporting, and/or performing other tasks.

As previously described, services 230 and blocks 232 can be easily distributed as desired (assuming each target device has the processing capability needed to run the specified services) and service communication capabilities can be changed as needed. Accordingly, the NIO platform architecture enables the functionality 2102 to be designed and embodied in services and blocks as a system configuration for a system that can then be deployed to different hardware environments 2104, 2106, and 2108. In some embodiments, the system configuration may also identify NIO platform instances to which the services are assigned.

Although referred to herein as hardware environments, it is understood that the hardware environments 2104, 2106, and 2108 may include software, including operating systems and/or applications, and may also be referred to as computing environments. The different hardware environments 2104, 2106, and 2108 may have different requirements and/or capabilities, and may or may not be able to run the functionality 2102 in the exact configuration embodied by the services and blocks. However, by modifying the organization and/or distribution of the services and blocks to adjust for different processing and memory resources, different levels of network availability and network protocols, and/or other factors, the predefined functionality 2102 may be deployed to the different hardware environments 2104, 2106, and 2108 with relatively little effort. It is understood that NIO platforms may be distributed as desired to run the services.

For purposes of illustration, the functionality 2102 can be deployed to the hardware environment 2104 without modification to the organization and distribution of the services and blocks. It is understood that services and blocks may still need to be configured and some blocks may need to be modified or created (e.g., to read from and/or actuate a particular device within the hardware environment 2104) as needed for the hardware environment 2104, but the overall organization and distribution of services and blocks embodying the functionality 2102 will remain the same. For example, a generic read block may be positioned as a placeholder within a service, and the generic read block may be replaced with a customized read block when the service is deployed. This does not affect the organization of the service or the location of the block within the service, and is treated as a configuration action in the present example. The hardware environment 2104 may be pre-existing, but able to handle the services as designed, or may be a new environment that was created specifically to support the functionality 2102 as embodied in the services 230.

Deploying the functionality 2102 to the hardware environment 2106 requires that the services and/or blocks be organized and/or distributed in a modified manner. For example, if some services were intended to be deployed on edge nodes, the devices running the edge nodes within the hardware environment 2106 may not be powerful enough to properly run those services. To adjust for this, some or all services may be moved away from the edge nodes to more powerful devices that are not at the edge. In another example, services originally intended to be run away from the edge may be pushed to edge nodes due to the processing needs or capabilities of the hardware environment 2106. Services may also be subdivided into multiple services or combined into larger services if needed.

Accordingly, the functionality 2102 may be deployed to the hardware environment 2106 by modifying how the services and blocks are organized and distributed without changing the functionality 2102 itself. This example may require changes to the communication blocks of one or more services, such as is described with respect to FIGS. 18 and 19 when splitting a service into multiple services and adding additional channel publisher and channel subscriber blocks. Another example would be if a service is moved outside of a communications cluster and a channel publisher block in the service is changed to another communications block such as an HTTP publisher block.

Deploying the functionality to the hardware environment 2108 requires changes to the functionality 2102. For example, the hardware environment 2108 may not have the processing or network capacity to support the functionality 2102 in its entirety, and various features may need to be modified or removed. In other embodiments, changes may be made for compatibility purposes. Functionality may also be added. Such modifications may or may not require changes to the organization and distribution of the remaining services and blocks.

Accordingly, the NIO platform architecture enables an entire system of services and blocks to be built and then deployed to different hardware environments in whatever way is desired or needed for each hardware environment (assuming that a particular hardware environment has the ability to support the system). This means that the services can be modified to work within a pre-existing hardware environment or a hardware environment can be created that is ideal for the system. A pre-existing hardware environment can also be upgraded if needed to support the system of services and blocks. Services can be placed at the edge, upstream from the edge, or in the cloud depending on the needs (e.g., remote access) of the particular deployment and the resource availability of the hardware environment.

It is noted that the granularity provided by the service and block architecture enables relatively minor adjustments to be made easily and as needed. For example, if a NIO platform instance is to run services that require X computing resources (e.g., processing capability, available memory, and/or network bandwidth/availability) based on the original service organization and distribution, but is being deployed on a device that can only provide Y resources (where Y<X), then services and/or blocks can be offloaded to other devices as desired to reduce the resource usage to Y or fewer resources. This reduction can be accomplished in many different ways and may include moving one or more entire services or only parts of one or more services. For example, a single service that uses a large percentage of the resources may be moved or multiple smaller services may be moved. This flexibility in tailoring the location of the functionality enables an optimal organization and distribution of service and blocks to be selected for each part of the hardware environment while minimizing or eliminating changes to the organization and distribution of the remaining services and blocks.

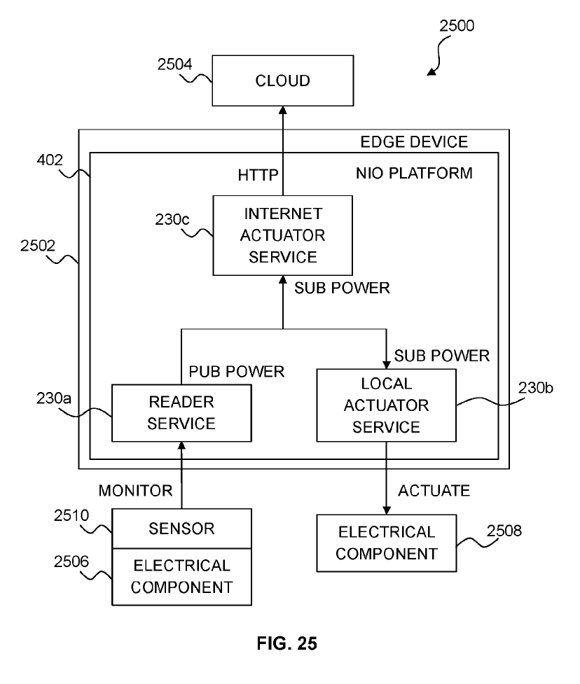

Referring to FIG. 22A, a method 2200 illustrates one embodiment of a process that may be used to create and deploy a system of services and blocks as described with respect to FIG. 21. In step 2202, the functionality of the system is defined. In step 2204, one or more services and blocks are defined to embody the functionality. As described previously, the system may be defined in many different ways and there is likely no single organization of services and blocks that is ideal for all hardware environments. Accordingly, many different combinations of services and blocks may be created to embody the functionality. In some embodiments, a target hardware environment may be used to provide structure in planning how the services and blocks are to be organized and distributed.

Furthermore, various methodologies may be adopted and applied, such as attempting to push functionality to the edge wherever possible in low bandwidth hardware environments or ensuring that there is a cloud node for data storage and remote visualization. Accordingly, various principles may be used to guide the organization of the services and blocks in step 2204 and such principles may vary depending on the hardware environment within which the system is intended to be deployed. For example, a system intended for deployment to a mobile device may have a different set of design principles than a system intended for deployment to a manufacturing or agricultural environment that uses a network of distributed devices.

In step 2206, the services and blocks are deployed. The deployment may use the original organization or may require modifications as described with respect to FIG. 21. The actual deployment process may vary depending on the hardware environment to which the system is being deployed and whether the hardware environment supports the originally designed organization and distribution of the services and blocks. Various examples are described with respect to FIGS. 22B-22D.

For example, referring to FIG. 22B, a method 2210 illustrates one embodiment of a process in which each service may be assigned to a platform instance in step 2212 and each platform instance may be assigned to a device within the hardware environment in step 2214. In another example, as shown in FIG. 22C, a method 2220 illustrates one embodiment of a process in which each service may be assigned to a device in step 2222 and one or more platform instances may then be assigned to each device to run the services in step 2224.

Referring to FIG. 22D, a method 2230 illustrates one embodiment of a process in which a system of services and blocks are provided in step 2232. In step 2234, a determination may be made as to whether the system should be deployed as currently organized. If the system is to be deployed as currently organized, the method 2230 moves to step 2238, where the system is deployed. If the system is not to be deployed as currently organized, the method 2230 moves to step 2236. This may occur, for example, if a review of the hardware environment indicates that the system cannot be deployed in its current state. In step 2236, the services and blocks are reorganized as needed, which may include modifying communication blocks. The method 2230 then moves to step 2238 and the system is deployed in its reorganized state.

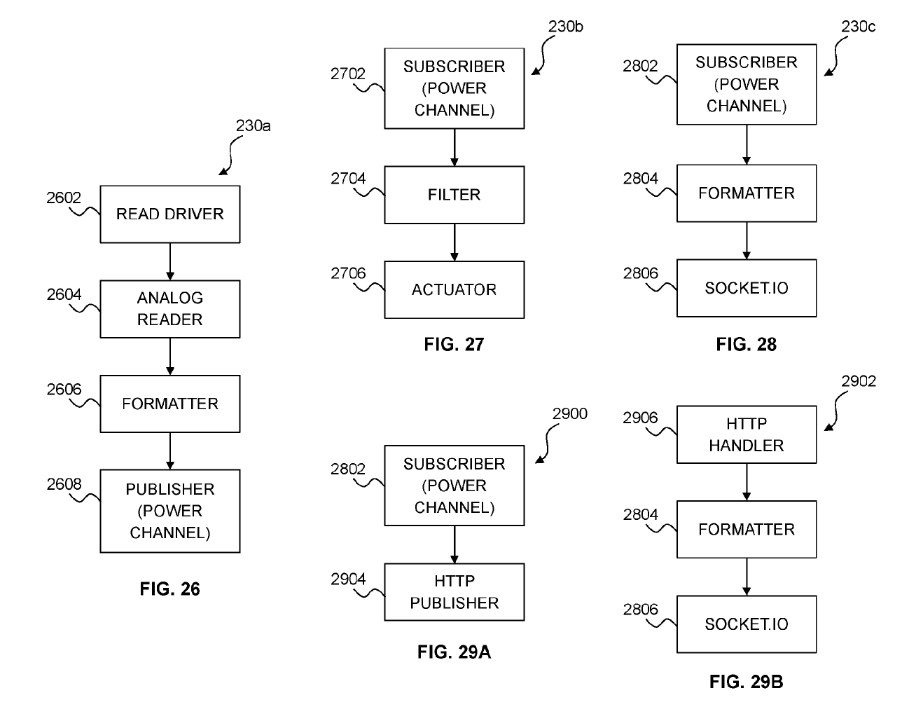

Referring to FIG. 23, one embodiment of an environment 2300 illustrates the NIO platform 402 of FIG. 4A, one or more sensors 2302, and one or more electrical components 2304. As will be described below in greater detail, the NIO platform 402 is configured to receive inputs from the sensor 2302 that is coupled to the electrical component 2304.

The electrical component 2304 may be any active, passive, or electromechanical discrete device or physical entity that uses, transfers, communicates with, and/or produces electricity in any form, and may be standalone or part of a larger device. Active components include semiconductors (e.g., diodes, transistors, integrated circuits, and optoelectronic devices), display technologies, vacuum tubes, discharge devices, and power sources. Passive components include resistors, capacitors, magnetic (inductive) devices, memristors, networks, transducers, sensors, detectors, antennas, assemblies, modules, and prototyping aids. Electromechanical components include piezoelectric devices (including crystals and resonators), terminals and connectors, cable assemblies, switches, protection devices, and mechanical accessories (e.g., heat sinks and fans). The sensor 2302 is any type of sensor that is capable of sensing the desired characteristic(s) of the electrical component 2304 and producing a signal representing the characteristic(s).

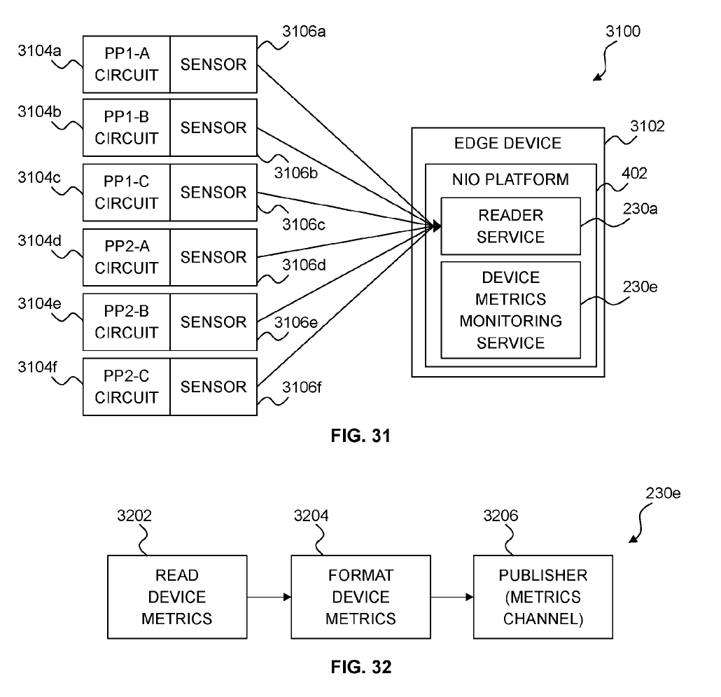

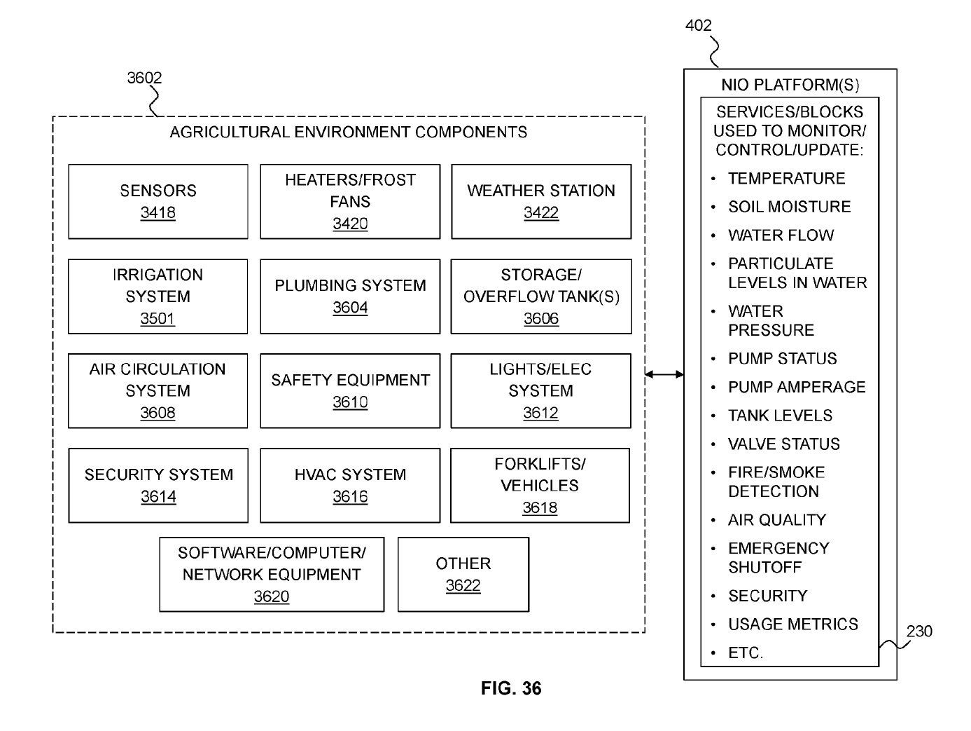

The NIO platform 402 processes the inputs from the sensor 2302 based on the platform's configuration and produces one or more outputs, which may include messages and/or actuations. The functionality of the NIO platform 402 may be provided on a single platform (as will be described below with respect to FIG. 25) or may be distributed across multiple platforms (as will be described below with respect to FIG. 30).

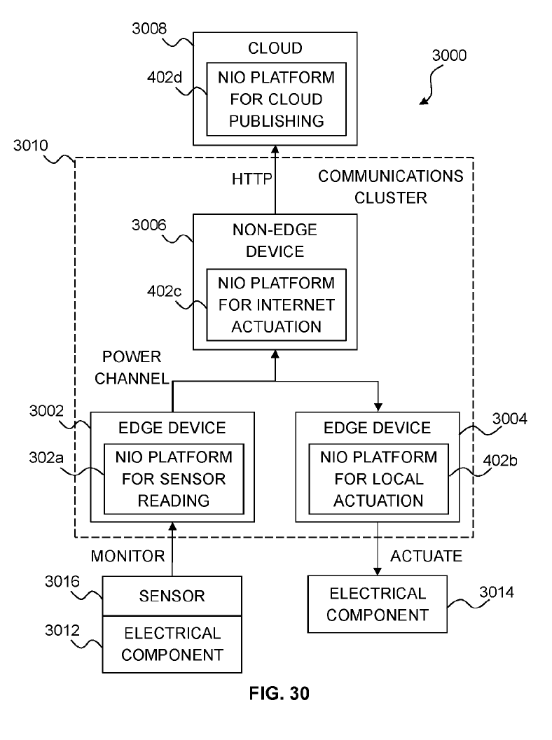

Referring to FIG. 24, a method 2400 illustrates one embodiment of a process that may be executed by the NIO platform 402 of FIG. 23. Alternatively, the method 2400 may be executed by multiple NIO platforms if the functionality has been distributed. In step 2402, the NIO platform 402 obtains sensor readings from the sensor 2302 about the electrical component 2304. In step 2404, the sensor readings are processed by the NIO platform 402 based on the particular configuration of the NIO platform. Accordingly, the NIO platform 402 will have blocks 232 (not shown) capable of receiving input from the sensor 2302 and processing that input. In step 2406, one or more defined actions may be taken based on the processed input. As described in previous embodiments, the receipt, processing, and performance of any actions may occur in real time due to the architecture of the NIO platform 402.

Referring to FIG. 25, one embodiment of a system 2500 illustrates a power monitoring and actuation system using the single NIO platform 402 of FIG. 23. The NIO platform 402 is located on an edge device 2502 and also has a communication link that enables the NIO platform 402 to communicate with the cloud 2504. The NIO platform 402 is coupled to an electrical component 2506 and an electrical component 2508. The electrical components 2506 and 2508 may be separate components (as shown) or may represent a single component.

For purposes of example, the NIO platform 402 is shown with a configuration of specific services for implementing the functions illustrated with respect to the method 2400 of FIG. 24. A reader service 230a receives input from the electrical component 2506 via a sensor 2510 and publishes to a channel named “Power.” A local actuator service 230b subscribes to the Power channel to receive input from the reader service 230a. The local actuator service 230b then controls the actuation of the electrical component 2508 based on the received input. An internet actuator service 230c subscribes to the Power channel, and formats and sends information to the cloud 2504 based on the input.

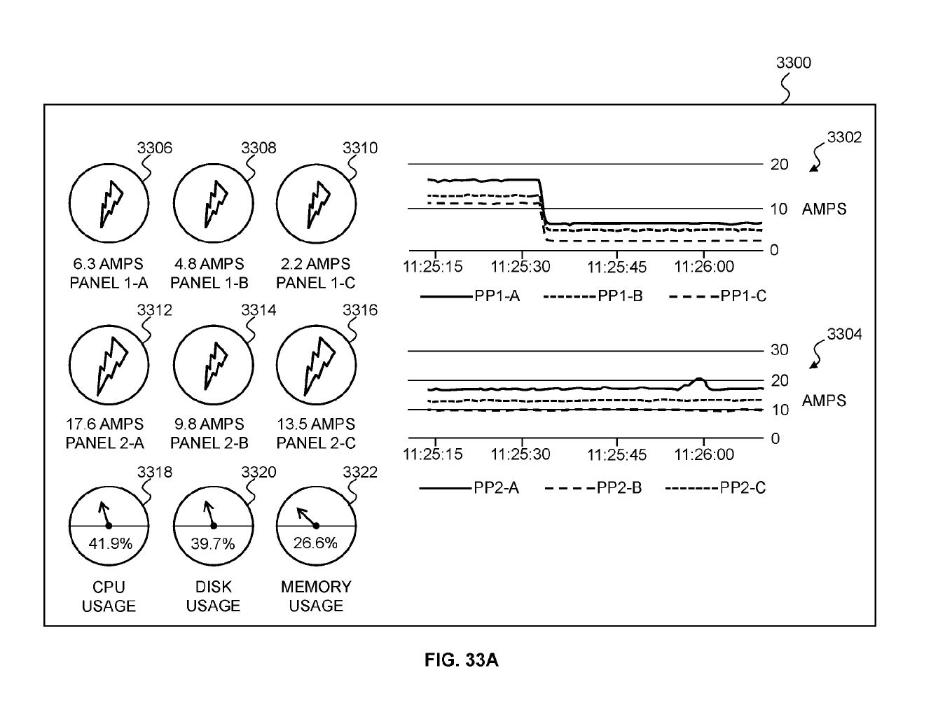

Referring to FIG. 26, one embodiment of the reader service 230a of FIG. 25 is illustrated. In the present example, the reader service 230a includes multiple blocks, including a read driver block 2602, an analog reader block 2604, a formatter block 2606, and a publisher block 2608.

The read driver block 2602, which may be omitted in some embodiments, is a simulator block that drives how frequently the sensor 2510 should be read. For example, the read driver block 2602 may have a parameter that can be set with a time (e.g., 0.1, 0.5, or one second) to trigger a sensor read. The output from the read driver block 2602 is directed to the analog reader block 2604 to trigger the actual read action. The analog reader block 2604 reads one or more values from the sensor 2510 coupled to the electrical component 2506 each time the analog reader block 2604 receives a trigger from the read driver block 2602. The output from the analog reader block 2604 is directed to the formatter block 2606. The formatter block 2606 formats the sensor data obtained by the analog reader block 2604 for use by other services if needed. The output from the formatter block 2606 is directed to the publisher block 2608. The publisher block 2608 publishes the data to the “Power” channel.

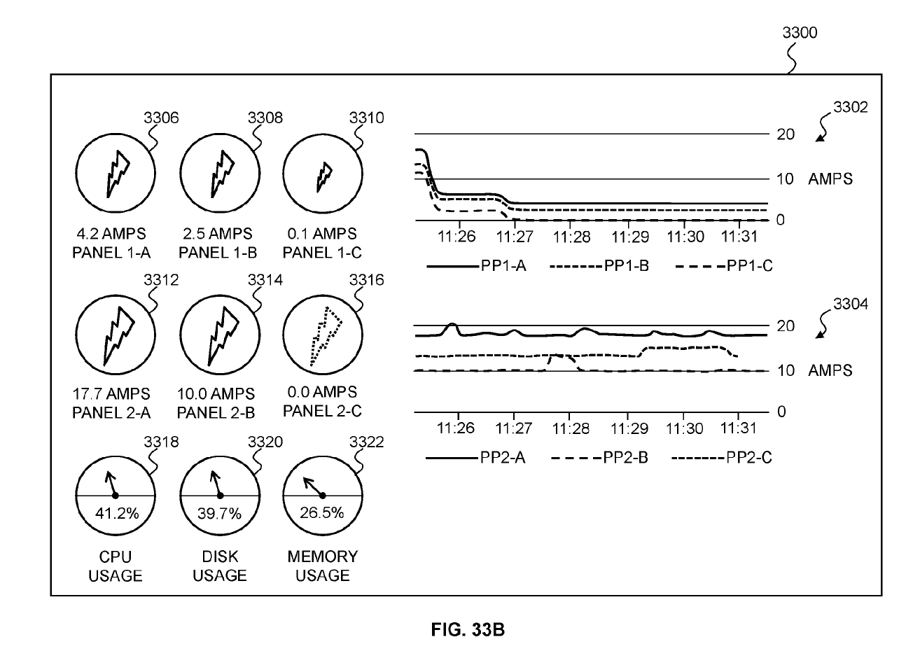

Referring to FIG. 27, one embodiment of the local actuator service 230b of FIG. 25 is illustrated. In the present example, the local actuator service 230b includes multiple blocks, including a subscriber block 2702, a filter block 2704, and an actuator block 2706.

The subscriber block 2702 subscribes to the Power channel to receive information from the reader service 230a. The output from the subscriber block 2702 is directed to the filter block 2704. The filter block 2704 determines whether or not an actuation of the electrical component 2508 should be performed based on the received information. It is understood that the logic executed by the filter block 2704 may be more complex than a simple filter and, in some embodiments, may be provided by another service or services. By positioning the actuation logic of the filter block 2704 on the edge device 2502, edge filtering is provided that minimizes the amount of noise transmitted across a network. This edge filtering also minimizes response time as there is no need to account for any network round trip transmission time that might delay an actuation. The output from the filter block 2704 is directed to the actuator block 2706. The actuator block 2706 performs any needed actuation of the electrical component 2508.

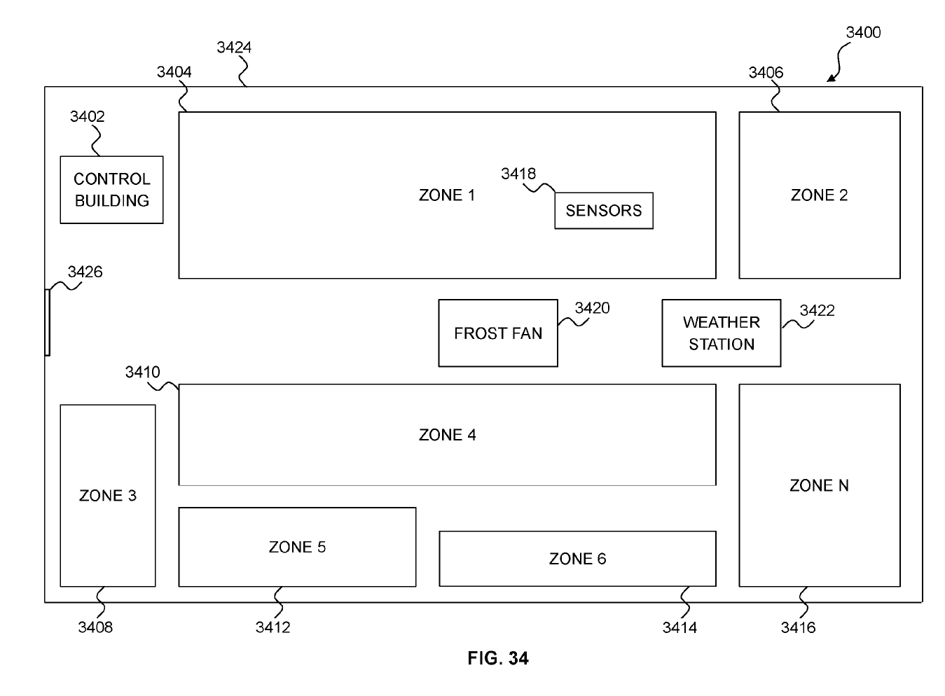

Referring to FIG. 28, one embodiment of the internet actuator service 230c of FIG. 25 is illustrated. In the present example, the internet actuator service 230c includes multiple blocks, including a subscriber block 2802, a formatter block 2804, and a socket.io block 2806.

The subscriber block 2802 subscribes to the Power channel to receive information from the reader service 230a and may be the same basic block as the subscriber block 2702 of the local actuator service 230b. The output from the subscriber block 2802 is directed to the formatter block 2804. The formatter block 2804 may handle formatting of the information as needed. For example, if the information is to be visualized, the formatter block 2804 would handle the formatting needed for visualization. The output from the formatter block 2804 is directed to the socket.io block 2806. The socket.io block 2806 sends the information to a socket.io server (not shown) so that the information can be visualized on a web page. For example, the socket.io block 2806 may send the information directly to the web services 712 of FIG. 7, which may be running on a socket.io server in the cloud.

Referring to FIG. 30, one embodiment of a system 3000 illustrates a power monitoring and actuation system using multiple NIO platforms 402a-402d. The functionality described with respect to the services 230a-230c of FIG. 25 are distributed among the NIO platforms 402a-402d, rather than being located on a single NIO platform as described with respect to FIG. 25. It is understood that the functionality may be distributed in many different ways, and the current embodiment is only one possible distribution.

The NIO platforms 402a-402d are positioned in a tiered arrangement. More specifically, the NIO platform 402a is located on an edge device 3002 and is coupled to an electrical component 3012 via a sensor 3016. The NIO platform 402b is located on an edge device 3004 and is coupled to an electrical component 3014. The electrical components 3012 and 3014 may be separate components (as shown) or may represent a single component. The NIO platform 402c is located on a non-edge device 3006 and has a communication link that enables the NIO platform 402c to communicate with the NIO platform 402d located in the cloud 3008.

For purposes of example, the NIO platform 402a is configured with the reader service 230a of FIGS. 25 and 26 to read the sensor 3016. The NIO platform 402b is configured with the local actuator service 230b of FIGS. 25 and 27 to handle the actuation of the electrical component 3014. The NIO platforms 402c and 402d each handle part of the internet actuator service 230c of FIGS. 25 and 28, although this may require additional blocks as will be described below.

Communications among the NIO platforms 402a-402c are handled by a communications broker and the NIO platforms 402a-402c form a single communications cluster 3010. As described previously with respect to FIG. 15, any NIO platform that is configured to use the broker is part of the communications cluster 3010 and can publish and subscribe to channels within that cluster (e.g., the Power channel). Any NIO platforms that are not configured to use the broker are outside of the communications cluster 3010 and cannot publish and subscribe to those channels. Accordingly, the NIO platform 402d cannot subscribe to the Power channel. With respect to FIG. 30, as only the NIO platform 402c is handling non-local communications outside of the communications cluster 3010, only the NIO platform 402c needs communication access to the cloud 3008.

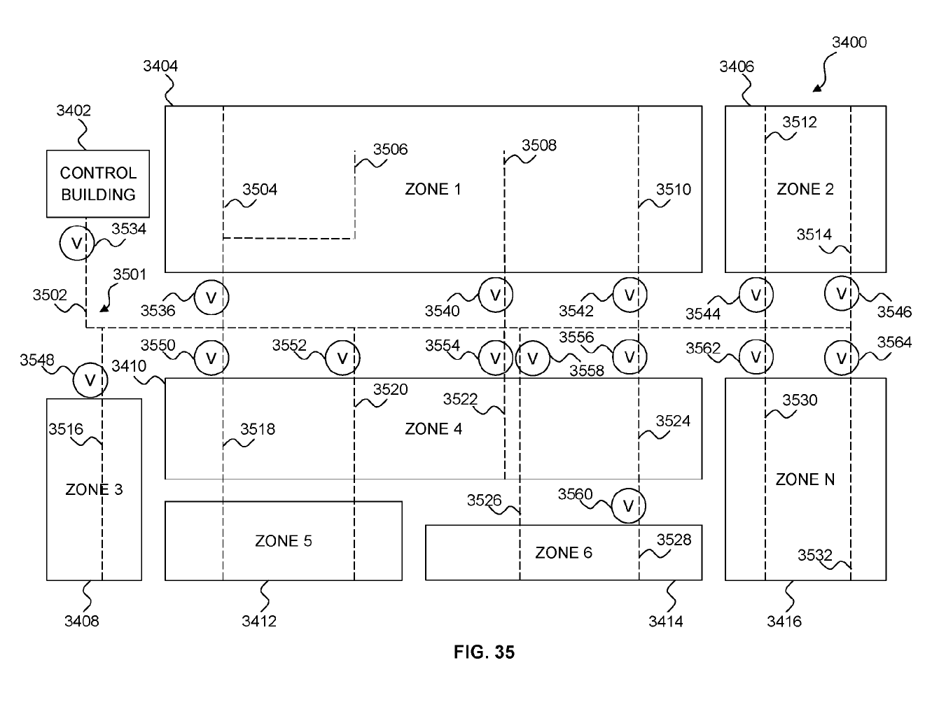

Referring to FIGS. 29A and 29B, one embodiment of the internet actuator service 230c of FIG. 25 is illustrated after being separated between the NIO platform 402c and the NIO platform 402d of FIG. 30. More specifically, the NIO platform 402c runs an internet actuator service 2900 (FIG. 29A) and the NIO platform 402d runs a cloud publishing service 2902 (FIG. 29B).

In the present example, the internet actuator service 2900 includes multiple blocks, including the subscriber block 2802 of FIG. 28 and an HTTP publisher block 2904. As described previously, the subscriber block 2802 subscribes to the Power channel to receive information from the reader service 230a. The output from the subscriber block 2802 is directed to the HTTP publisher block 2904. The HTTP publisher block 2904 is different than the publisher block 2608 and does not use the broker of the communications cluster 3010. The HTTP publisher block 2904 instead sends information out of the communications cluster 3010 via HTTP to the NIO platform 402d.

The cloud publishing service 2902 includes multiple blocks, including an HTTP handler block 2906, the formatter block 2804 of FIG. 28, and the socket.io block 2806 of FIG. 28. The HTTP handler block 2906 provides an HTTP endpoint to which the internet actuator service 2900 can send data. The output from the HTTP handler block 2906 is directed to the formatter block 2804, which operates with the socket.io block 2806 as previously described.

It is understood that the functionality may be distributed into more or fewer NIO platforms as desired. Furthermore, each NIO platform may be configured with one or more services to handle the particular functions assigned to that NIO platform. Accordingly, a great deal of flexibility is provided.

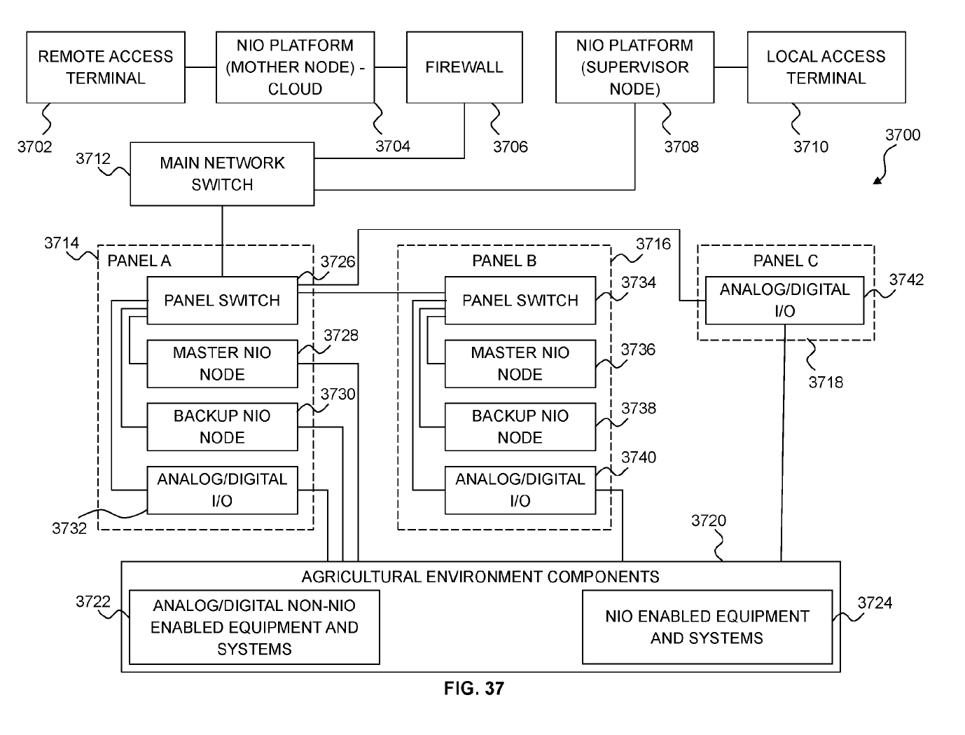

Referring to FIG. 31, another embodiment of a system 3100 illustrates a power monitoring system using a single NIO platform 402. The NIO platform 402 is located on an edge device 3102 and is running the reader service 230a of FIG. 25. The NIO platform 402 may be a standalone monitoring platform as described with respect to FIG. 25, or may be part of a tiered system as described with respect to FIG. 30. It is understood that other services (e.g., the services 230b and 230c of FIG. 25) may also be running on the NIO platform 402, but only the reader service 230a is illustrated for purposes of the present example.

The NIO platform 402 is configured to monitor multiple electrical components 3104a-3104f that form two power panels labeled “Power Panel 1” (PP1) and “Power Panel 2” (PP2), each of which has three circuits labeled A, B, and C. Accordingly, the six circuits monitored by the NIO platform are 1-A, 1-B, 1-C, 2-A, 2-B, and 2-C. Each circuit 3104a-3104f is read by a sensor 3106a-3106f, respectively. The sensors 3106a-3106f are read by, or push data to, the reader service 230a.

It is understood that the NIO platform 402 may be used to monitor the circuits 3104a-3104f even if the circuits 3104a-3104f have different configurations and/or the sensors 3106a-3106f are measuring different characteristics. In such cases, the flexibility of the NIO platform 402 may be leveraged by modifying the configuration of the service 230a and/or blocks. In some embodiments, depending on the particular circuits 3104a-3104f and/or sensors 3106a-3106f, additional services and/or blocks may be needed to configure the NIO platform 402 with the desired monitoring functionality.

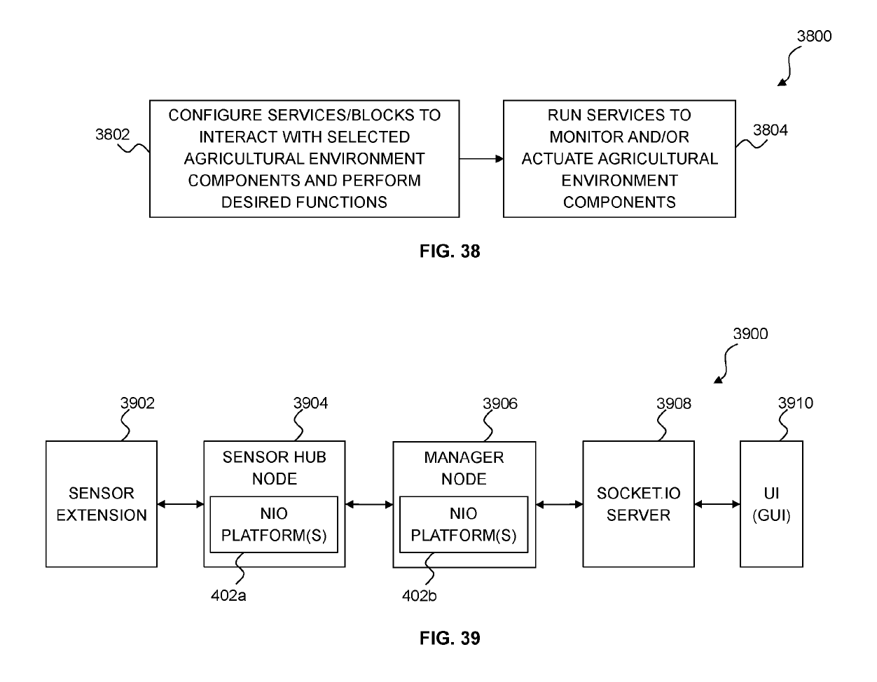

With additional reference to FIG. 32, one embodiment of the device metrics monitoring service 230e of FIG. 31 is illustrated. In the present example, the device metrics monitoring service 230e includes multiple blocks, including a read device metrics block 3202, a format device metrics block 3204, and a publisher block 3206.

The read device metrics block 3202 reads information from the device 3102 at timed intervals using, for example, an I/O interface provided by the device 3102. The information may include, but is not limited to, information about socket connections, CPU percentage, swap memory, process identifiers, disk I/O statistics, network I/O statistics, disk usage, and virtual memory. The output from the read device metrics block 3202 is directed to the format device metrics block 3204. The format device metrics block 3204 formats the information obtained by the read device metrics block 3202 for use by other services if needed. The output from the format device metrics block 3204 is directed to the publisher block 3206. The publisher block 3206 publishes the data to a “Metrics” channel. This channel may then be subscribed to by another service (e.g., the internet actuator service 230b of FIG. 27 or the internet actuator service 2900 of FIG. 29A) and published.

Referring again to FIG. 31, the NIO platform 402, either itself or in conjunction with other NIO platforms, produces the information needed to provide a real time display of the current amperage of each of the circuits 3104a-3104f, as well as information on the performance of the device 3102 on which the NIO platform is running. It is understood that the actual display may be generated by a NIO platform or may use additional services, such as the web services 712 of FIG. 7.

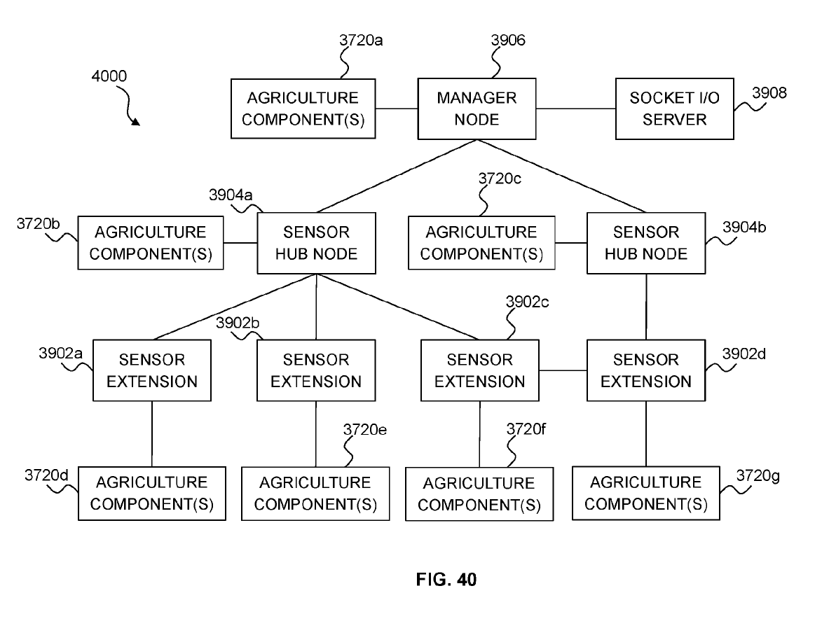

With additional reference to FIGS. 33A and 33B, one embodiment of a GUI 3300 is illustrated with real time information relating to the circuits 3104a-3104f obtained by the reader service 230a of FIG. 31. The GUI 3300 also provides real time information on the performance of the device 3102 using the device usage monitoring service 230e. It is noted that the services 230a and 230e, as well as the blocks within each service, may run asynchronously as described in previous embodiments, and therefore can update the GUI 3300 as desired without interfering with one another. Information may be obtained and streamed to the GUI 3300 by one or more NIO platforms in real time or near real time (e.g., without first being stored in a persistent memory). In addition, various aspects of the visualization, alerts, and/or actuations described herein may be set, toggled, and/or otherwise modified by configuration commands sent to the NIO platform(s).

Referring specifically to FIG. 33A, the GUI 3300 provides two graphs 3302 and 3304, each having an x-axis representing time and a y-axis representing amperage. The graph 3302 illustrates the amperage of the circuits 3104a-3104c (i.e., PP1-A, PP1-B, and PP1-C) as individual lines. The graph 3304 illustrates the amperage of the circuits 3104d-3104f (i.e., PP2-A, PP2-B, and PP2-C) as individual lines. The current amperage of each circuit 3104a-3104f is shown on the far right of each graph 3302 and 3304 with historical data moving to the left. It is noted that the historical data is maintained in the present example by the web services and not by a NIO platform, although a NIO platform may store the historical data if configured to do so.

The current amperage for the circuits 3104a-3104f is also shown by indicators 3306-3316, respectively, and the text accompanying each indicator. For example, indicator 3306 corresponds to Panel 1-A (circuit 3104a) and indicates that the current amperage value is 6.3 amps. This corresponds to the line for PP1-A at the far right on graph 3302. Similarly, indicator 3316 corresponds to Panel 2-C (circuit 3104f) and indicates that the current amperage value is 13.5 amps. This corresponds to the line for PP2-C at the far right on graph 3302. As the graphs 3302 and 3304 illustrate the current amperage in real time, the previously graphed information will shift to the left and may eventually disappear if the graph does not scale over time. Because the monitoring in the present example was started just before 11:25:15 and occurs in real time, there is no data to graph before the start time.

The indicators 3306-3316 may use colors and/or other representations to indicate a particular state. For example, a currently active circuit may have a green indicator, while an inactive circuit may have a red or gray indicator. In addition, the size of a symbol (e.g., a lightning bolt) may scale based on the corresponding amperage, with higher levels of amperage having larger symbols. For example, the 9.8 amps of the indicator 3314 is represented by a visually smaller lightning bolt than the higher 17.6 amps of the indicator 3312. Such visual indications may provide an easily readable overview of the current state of each of the circuits 3104a-3104f.

The GUI 3300 also illustrates three indicators that provide real time performance information on the device 3102. More specifically, an indicator 3318 represents the current CPU usage of the device 3102 as 41.9%. An indicator 3320 represents the current disk usage (e.g., the amount of available disk space being used) of the device 3102 as 39.7%. An indicator 3322 represents the current memory usage of the device 3102 as 26.6%.

Referring specifically to FIG. 33B, the graphs 3302 and 3304 have scaled with respect to time. For example, the current scale is now in one minute increments rather than the fifteen second increments of FIG. 33A. This scaling enables a larger timeframe to be displayed and provides a longer term view of the amperage values for each circuit 3104a-3104f. The graphs 3302 and 3304 may also smooth the lines as more data becomes available.

As shown by the indicator 3316, the circuit 3104f is not currently active. It is noted that the indicator is not showing minimal current or even zero current, it is showing that there is no reading at all. The graph 3304 reveals that sensor data was last received for the panel PP2-C from the sensor 3106f at approximately 11:31. The last reading of the circuit 3104f showed approximately thirteen amps. The lack of current sensor data may be due to a malfunction in the circuit 3104f or the sensor 3106f, and/or one or more other problems.

The real time data obtained by the NIO platform 402 can be used to proactively diagnose problems and, when a problem occurs, to react in real time. For example, the rise in current just after 11:29 and the subsequent fall just before 11:31 may have indicated a developing problem. If the NIO platform 402 was configured to monitor for such problems, it might have shut down the circuit 3106f before failure occurred or might have shut down one or more devices attached to the circuit to reduce the load. The NIO platform 402 may also be configured with information regarding the expected load levels to determine if the load level is within bounds during a spike. Alternatively or additionally, a more detailed level of monitoring may be started when a defined threshold is surpassed.

If configured to send alerts, the NIO platform 402 (or another NIO platform) could respond to this failure in real time by sending a message and/or taking other action. For example, if an actuation response is defined, the NIO platform 402 could activate an audible or visual alarm.

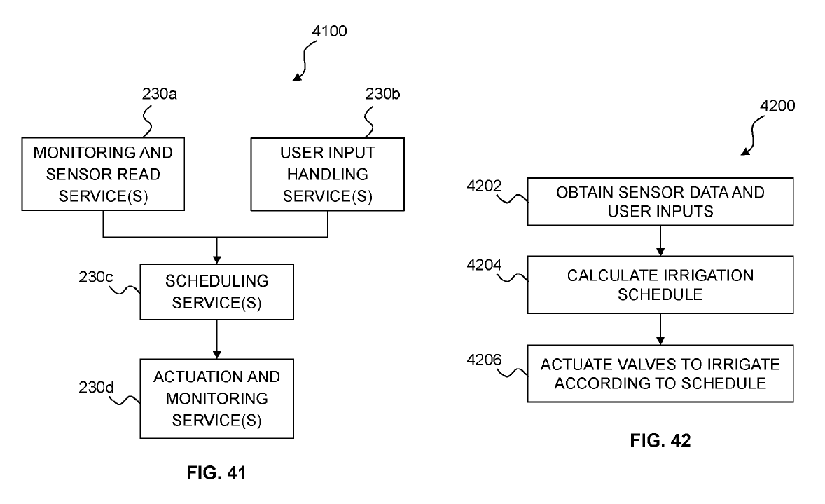

Referring to FIG. 34, an environment 3400 illustrates one embodiment of an agricultural location within which a NIO platform, such as the NIO platform 402 of FIG. 4A, may be used for purposes such as monitoring (as discussed previously with respect to FIGS. 33A and 33B) and actuation. As is known, agricultural environments may use a variety of equipment from different manufacturers, may perform many different processes, and have differing needs even if the general output of two locations is similar or identical. For example, geographic differences may result in differences in soil, weather, and types of pests, and those differences may in turn result in different water, fertilizer, and pesticide needs even if the crops being grown are the same. Even in a single location, differences may occur as crops with different needs are rotated over time, changes in weather occur, and pest populations rise and fall.

The amount of possible variation complicates such issues as standardization of equipment and crop care parameters (e.g., fertilizer, pesticide, and watering volumes and schedules). Furthermore, due partly to the size of many agricultural locations, cost containment and production efficiency can become extremely important and the lack of standardized solutions makes these considerations more difficult. However, due to the flexibility provided by the NIO platform 402, the NIO platform 402 can be used to provide a standard configurable solution regardless of the needs of any particular agricultural environment.

For the present embodiment, the environment 3400 represents a vineyard. It is understood that the illustrated vineyard is for purposes of example only, and crop location and/or equipment may be modified, added, removed, or rearranged in many different ways. It is further understood that the agricultural environment may be directed to many different locations and types of crops and is not limited to a vineyard.

The NIO platform 402 may be used in multiple areas of the vineyard, with different instances of the NIO platform 402 configured as needed to perform various tasks required for the specific area in which a particular instance has been deployed. As described previously, the NIO platforms 402 may communicate with one another and may be organized in a tiered system with services distributed across the NIO platforms in whatever way is desired. The following description is directed to one embodiment of the vineyard and how the NIO platform may be used in such an environment.

The vineyard has a general plot layout as illustrated with zones 3404 (zone 1), 3406 (zone 2), 3408 (zone 3), 3410 (zone 4), 3412 (zone 5), 3414 (zone 6), and 3416 (zone N, where N is any number greater than 6). It is understood that the illustrated zones 3404-N are for purposes of example only. Accordingly, more or fewer zones may be present and a zone may be of any desired shape. While the present embodiment is directed to crops (e.g., any cultivated plant, fungus, and algae), other embodiments may be directed to livestock (e.g., fish, cows, pigs, and sheep). Accordingly, the zones may represent fields, greenhouses, fisheries, pens, and/or any other area used to grow crops and/or livestock and may include structures (not shown).

Each zone 3404-3416 typically requires moisture, nutrients (e.g., fertilizer), and/or pesticides. The delivery of each required element may be performed in different ways. For example, water may be delivered via an irrigation system and fertilizer and/or pesticides may be delivered separately, or the irrigation system may enable fertilizer and/or pesticides to be delivered with the water. For purposes of example, the environment 3400 includes one or more NIO platforms that use information from distributed sensors 3418 to monitor, schedule, and adjust the delivery of water, nutrients, and pesticides to the zones 3404-3416. Although shown only in zone 3404, it is understood that the sensors 3418 may be distributed throughout the environment 3400, including in some or all of the zones 3406-3416, and may include sensors for soil moisture, pH levels, temperature, humidity, light intensity, transpiration, respiration, vine and leaf water percentage, and/or other conditions.

Control equipment, including one or more NIO platforms, may be located in a control building 3402 and/or elsewhere, including on edge nodes and/or intermediate nodes positioned in and/or proximate to the zones 3404-3416, and/or at remote locations (e.g., in the cloud). Additional equipment, such as one or more frost fans 3420 and weather stations 3422 may be present. The functions provided by the weather station 3422 may be complementary to the sensors 3418. In some embodiments, mobile nodes with sensors may be deployed and may include internal NIO platforms or may communicate with NIO platforms that are externally located. A large environment 3400 may use a distributed system with nodes and/or other components that are coupled wirelessly to manage and control the environment.

Other systems, such as a security system, may also be present. For example, a fence 3424 and a gate 3426 may be monitored by motion sensors, heat sensors, cameras, and/or other security equipment. The gate 3426 may be enabled for remote access. Such systems may include one or more NIO platforms, may be coupled to a NIO platform, and/or may be entirely separate from a NIO platform.

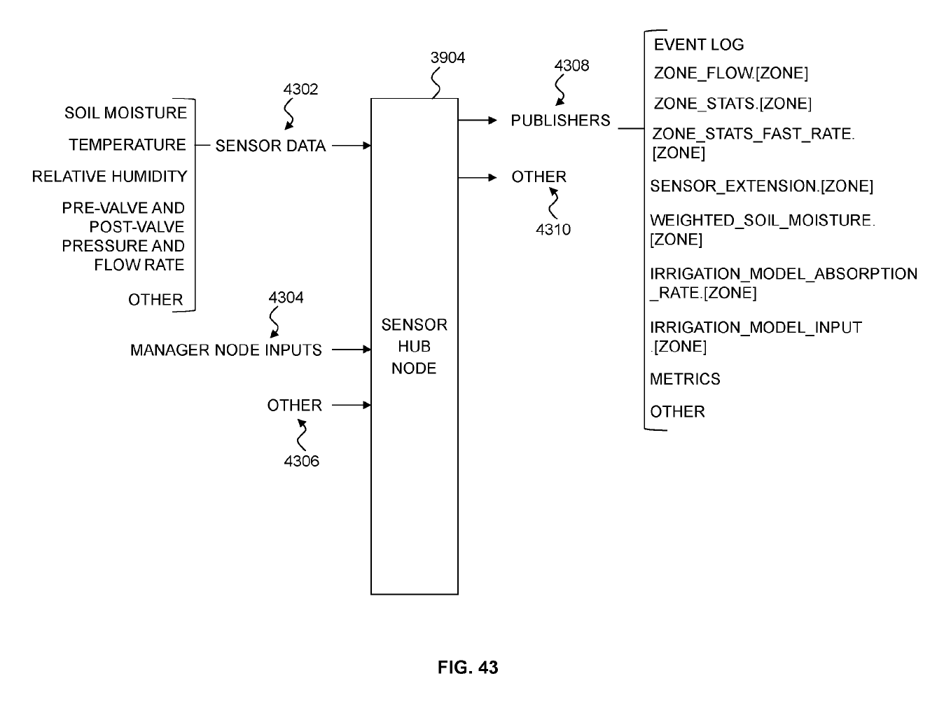

Referring to FIG. 35, one embodiment of the environment 3400 of FIG. 34 is illustrated with an irrigation system 3501 that includes a main irrigation line 3502 having a controllable valve 3534. The main line 3502 runs from the control building 3402 to the various zones 3405-3416 via separately controllable water lines. The main line 3502 is supplied by a water source such as one or more wells and/or external water lines (not shown). The irrigation system 3501 may include various pumps, valves, sensors (e.g., fluid flow sensors), metering devices, and/or other fluid control equipment that are used to monitor and control the irrigation system.

In the present example, the zone 3404 is serviced by a line 3504 and a line 3506 that are controlled by a valve 3536, a line 3508 that is controlled by a valve 3540, and a line 3510 that is controlled by a valve 3542. The zone 3406 is serviced by a line 3512 that is controlled by a valve 3534 and a line 3514 that is controlled by a valve 3546. The zone 3408 is serviced by a line 3516 that is controlled by a valve 3548. The zone 3410 is serviced by a line 3518 that is controlled by a valve 3550, a line 3520 that is controlled by a valve 3552, a line 3522 that is controlled by a valve 3554, and a line 3524 that is controlled by a valve 3556. The zone 3412 is serviced by the lines 3518 and 3520, and has no individually controllable valves and is watered any time the zone 3410 is watered. The zone 3414 is serviced by a line 3526 that is controlled by a valve 3558 and a line 3528 that is controlled by a valve 3560. The line 3526 does not provide irrigation to the zone 3410, but runs parallel to the line 3522. While the line 3528 is coupled to the line 3524, the separate valve 3560 enables irrigation of part of the zone 3414 to be shut off even if the zone 3410 is being irrigated. Accordingly, the valve 3560 provides a higher level of control over the zone 3414 than is possible over the zone 3412, which is irrigated with the zone 3410 whenever the lines 3518 and 3520 are in use. The zone 3416 is serviced by a line 3530 that is controlled by a valve 3562 and a line 3532 that is controlled by a valve 3564.

Fertilizer and/or pesticides may be mixed with the water and supplied to the zones 3404-3416. Metering of the amounts of fertilizer/pesticide and use of the valves 3536-3564 enables the delivery of different amounts of fertilizer and/or pesticide to different zones 3404-3416.

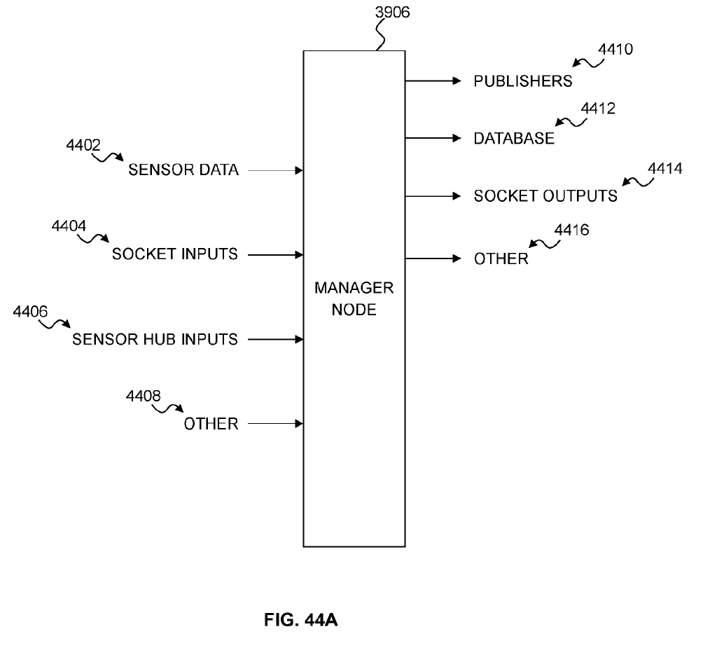

Referring to FIG. 36, one embodiment of the environment 3400 illustrates agricultural environment components 3602 and NIO platform(s) 402 with services 230. The agricultural processes performed within the environment 3400 may use many different components, including various types of equipment such as sensors 3418, heaters and/or frost fans 3420, weather station 3422, irrigation system 3501, a plumbing system 3604 (that may be part of the irrigation system 3501 in some embodiments), storage/overflow tanks 3606, an air circulation system 3608 (e.g., for a greenhouse or enclosed livestock pens), safety equipment 3610, lights, wiring, transformers, electrical panels, and other electrical system components 3612, a security system 3614, a heating, ventilation, and air conditioning (HVAC) system 3616 (that may be part of the air circulation system 3608 in some embodiments), various forklifts and other vehicles 3618, software, computers, and network equipment (e.g., gateways, routers, and switches) 3620, and other components 3622.

Each component 3602 includes its own operating parameters and operation outside of the parameters may result in lower efficiency or complete failure, which in turn may result in loss of some or all of a crop. Furthermore, weather variations and other uncontrollable occurrences may affect crop yield and identifying and responding to such variations can be important. For example, a broken water line or a single night of unexpected frost may cause a large amount of damage if not recognized and addressed quickly, and yet constantly monitoring and adjusting the various agricultural environment components 3602 can be a time consuming and inexact process.

The NIO platforms 402 can be configured to interact with, monitor, and/or control some or all of the agricultural environment components 3602. This includes both the components directly involved in the agricultural process (e.g., the irrigation system 3501 and the levels of water, fertilizer, and pesticide) and components needed within the environment in general (e.g., lights and security systems). As shown, the services 230 and their corresponding blocks can be configured to handle many different functions, including temperature, soil moisture, water flow, particulate levels in water, water pressure, pump status, pump amperage, tank levels, valve status, fire and smoke detection, air quality, emergency shutoff, security, usage metrics, and other functions.

The services 230 may be integrated with each other and the agricultural environment 3602 in many different ways to increase visibility and improve efficiency within the environment 3400. For example, water waste can be identified and addressed, which produces both cost and environmental benefits as overwatering not only wastes water and causes additional and unnecessary wear on the irrigation system, but can also damage crops and lower crop yields.

The environment 3400 may also be impacted by external factors, such as customer agreements, the timing of supply orders and deliveries (e.g., fertilizer and pesticide), labor needs, and similar issues. Various safety regulations and other legal obligations may also impact the process by specifying worker and equipment safety requirements, reporting requirements, pollution control measures, water metering, and similar obligations. Accordingly, there are many different factors that may impact the process flow within a particular agricultural environment. An environment that contains large areas and/or multiple crop types may introduce even more complications due to the need to account for and coordinate many different inputs and outputs.

The NIO platform 402 may be used in multiple areas of the environment 3400, with different instances of the NIO platform 402 configured as needed to perform various tasks required for the specific area in which a particular instance has been deployed. As described previously, the NIO platforms may communicate with one another and may be organized in a tiered system with services distributed across the NIO platforms in whatever way is desired.

By positioning the NIO platform 402 wherever needed throughout the environment 3400 and configuring each NIO platform instance to communicate with the desired environmental components 3602, a single platform solution can be used to provide real time or near real time monitoring and control of the agricultural environment 3400. For example, parameters associated with the sensors 3418, frost fan 3420, and irrigation system 3501 can be monitored and controlled in real time. Safety equipment 3610 and security equipment 3614 (e.g., cameras and fire/smoke detectors) can also be monitored and actuated. For example, if an intrusion or a fire is detected, alarms may be triggered, notifications may be sent, and various security and/or safety procedures may be initiated.

The NIO platform 402 can also be used to track the location of vehicles, provide real time updates of sensor information and system health and status, enable manual overrides of various components 3602, show totals such as overall usage of water, fertilizer, and pesticide, show changes in irrigation due to weather, and similar information. More general information can also be monitored and visualized, such as power consumption for one or more components 3602.

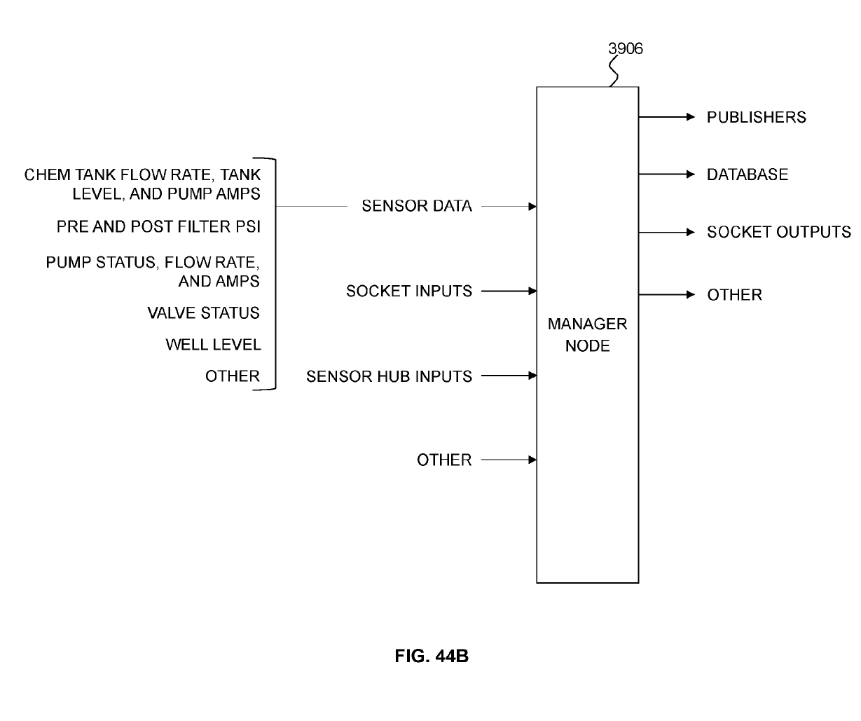

Referring to FIG. 37, one embodiment of a network environment 3700 illustrates how multiple NIO platforms may be distributed within the environment 3400 of FIG. 34. It is understood that the network environment 3700 is only one example of many possible implementations. The environment 3700 includes at least three tiers of NIO platforms with edge nodes, one or more supervisor nodes, and one or more mother nodes as described with respect to FIG. 23.

In the present example, a remote access terminal 3702 and a mother node 3704 are located outside of a firewall 3706 that forms the network boundary of the environment 3400. A supervisor node 3708 and a local access terminal 3710 are located inside the firewall 3706. Although shown with a direct connection to the supervisor node 3708, it is understood that the local access terminal 3710 may connect in other ways, such as via the main network switch 3712. The firewall 3706 and the supervisor node 3708 connect to a main network switch 3712 that handles communication routing within the internal network. It is understood that a simpler network environment 3700 may be used for many relatively small agricultural environments, but the network environment 3700 illustrates different ways in which the NIO platform can be connected and utilized within an agricultural environment.

NIO platforms are positioned within two panels 3714 (Panel A) and 3716 (Panel B), and those NIO platforms may be edge nodes or non-edge nodes, depending on the particular equipment connected to the panel and/or depending on the particular implementation of the network environment. A third panel 3718 (Panel C) is not provided with a NIO platform in the present example, but may include a NIO platform in other embodiments. The panels 3714, 3716, and 3718 are coupled to components 3720, which may be similar or identical to the components 3602 of FIG. 36. The components 3720 may include analog and/or digital equipment and systems that are not provided with their own local/embedded NIO platform (e.g., are not NIO-enabled) and/or equipment and systems that are provided with their own local/embedded NIO platform (e.g., are NIO-enabled).

The panel 3714 includes a panel switch 3726, a master NIO node 3728, a backup NIO node 3730, and one or more analog and/or digital I/O components 3732. The panel 3716 includes a panel switch 3734, a master NIO node 3736, a backup NIO node 3738, and one or more analog and/or digital I/O components 3740. The panel 3718 contains one or more analog and/or digital I/O components 3742.

In the present example, the panel switch 3726 of the panel 3714 is coupled to the main network switch 3712, the master NIO node 3728, the backup NIO node 3730, the I/O components 3732, the I/O components 3742, and the panel switch 3734. The master NIO node 3728 may be directly coupled to various components 3720 and/or may be coupled to various components 3720 via the I/O components 3732. The backup NIO node 3730 may be identical to the master NIO node 3728 in both configuration and connections to the components 3720, but is generally not active unless needed. For example, the supervisor node 3708 may monitor the master NIO node 3728 and activate the backup NIO node 3730 if a failure or other fault is detected in the master NIO node 3728.

The panel switch 3734 of the panel 3716 is coupled to the panel switch 3726, the master NIO node 3736, the backup NIO node 3738, and the I/O components 3740. However, unlike the master NIO node 3728 and the backup NIO node 3730 of the panel 3714, the master NIO node 3736 and the backup NIO node 3738 are only coupled to the I/O components 3740 and not directly to the components 3720.

The master NIO nodes 3728 and 3736, either alone or in coordination with the supervisor node 3708 and/or mother node 3704, may be configured with services to monitor, actuate, and otherwise interact with and control various processes within the agricultural environment. For purposes of simplicity, the master NIO node 3728 will be used in the following example, but it is understood that the services may be distributed across multiple NIO platforms as previously described.

Assume the entire zone 3404 is to be irrigated and also needs fertilizer and pesticide. The master NIO node 3728, in response to a trigger event such as a timer, a message, or a command, opens the valves 3536, 3538, 3540, and 3542. It is assumed that the valve 3534 is already open. As water moves through the main line 3502, the master NIO node 3728 actuates equipment that mixes a defined amount of fertilizer and pesticide into the water flow. During the watering process, the master NIO node 3728 monitors water pressure sensors 3418 that are placed in various locations (e.g., at each valve 3536, 3538, 3540, and 3542 and at the end of each line 3504, 3506, 3508, and 3510). If a deviation is detected that crosses a defined threshold, such as a pressure drop or spike, the master NIO node 3728 can send a notification message to alert someone, shut off the corresponding valve, and/or take other action.

The master NIO node 3728 may handle the irrigation process in different ways depending on the configuration of its services 230, such as using a time based and/or a sensor based approach. For example, the irrigation may have a scheduled start and stop time, but sensor information may be used to shorten the irrigation time (e.g., if the soil is moist enough before the stop time is reached) or extend the irrigation time (e.g., if the soil is still too dry after the scheduled stop time). This means that the master NIO node 3728 can automatically manage the water needs of the zones 3404-3416 in real time or near real time based on actual soil moisture levels, rather than blindly following a scheduled watering plan. Furthermore, by obtaining information from other sensors 3418 and/or the weather station 3422, even the scheduled irrigation time may be modified. For example, if rain is forecast, the master NIO node 3728 may postpone the scheduled irrigation and make adjustments later depending on the actual weather. At the later time, the master NIO node 3728 may cancel the current irrigation schedule if the rain provided adequate moisture or may continue with some or all of the schedule if the rain did not provide enough moisture.

While controlling the irrigation process and monitoring the various crop related sensors, the master NIO node 3728 may also be monitoring for fire, smoke, unauthorized access, and other safety and/or security issues. This enables the master NIO node 3728 to react if needed. For example, if a fire is detected, the master NIO node 3728 may turn on the irrigation system in that location, sound an alarm, send alerts, and/or perform other actions. Each action may include various substeps. For example, if a fire is detected, the master NIO node 3728 may divert all water to the location of the fire to ensure that there is enough water pressure. This may require that the master NIO node 3728 execute a series of actions, such as closing valves to other irrigation areas to stop any other ongoing irrigation, putting scheduled irrigation on hold, and opening the necessary valves to provide water to the affected area.

In addition, equipment usage may also be tracked, such as the time each vehicle is used or idle, the location of a vehicle, the amount of time a particular section of pipe is in use, and similar factors. Visualization of the various parameters, crop health, component status, and similar information may be available locally (e.g., via local access terminal 3710 or another interface device, such as a tablet or laptop computer) and remotely (e.g., via the remote access terminal 3702 or another interface device). This enables both current and historical information of the agricultural environment to be viewed regardless of the viewer's location. Furthermore, if enabled, parameters may be modified, various components may be activated or deactivated, and actuations may be performed via the NIO platforms.

Because the NIO platform can be configured to communicate with any desired component 3602, process information in real time or near real time, and monitor, actuate, update, and/or send data for visualization in real time or near real time, a current status of the environment 3400 can be monitored and control can be exerted using the NIO platform as a single solution regardless of the type of crop or livestock and the various processes executed within that environment.

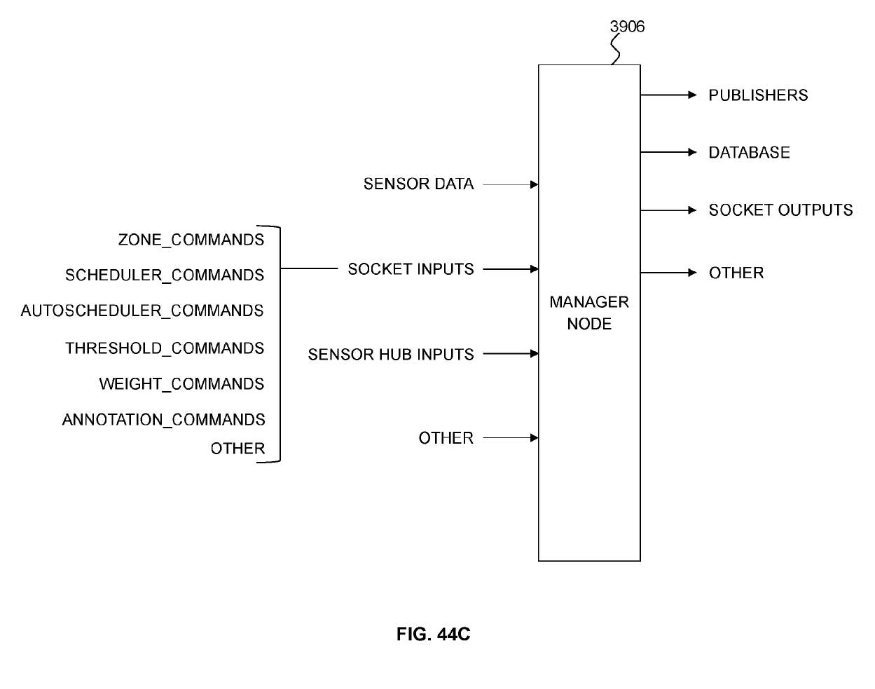

Referring to FIG. 38, one embodiment of a method 3800 illustrates a process that may be executed within the environment 3400 of FIG. 34. For example, the method 3800 may be used with one or more of the mother node 3704, supervisor node 3708, master NIO nodes 3728 and 3736, and/or backup NIO nodes 3730 and 3738 of FIG. 37. In step 3802, various services 230 and blocks 232 are configured to interact with selected components 3602 and perform desired functions as described previously. In step 3804, the services are run to monitor and/or actuate various components 3602.

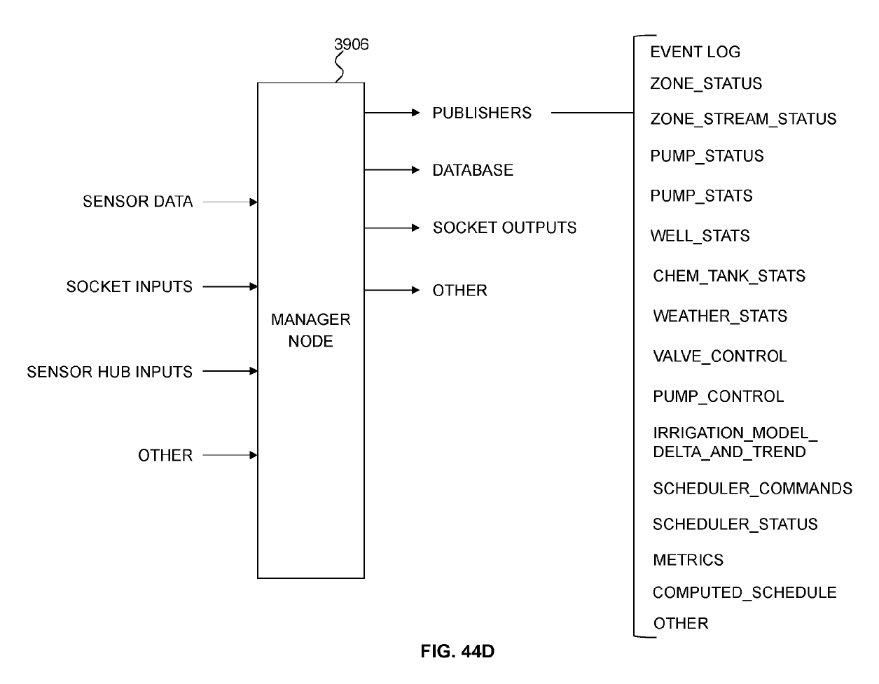

Referring to FIG. 39, one embodiment of an agriculture management system 3900 that may be used to monitor and control components within an agricultural environment is illustrated with a sensor extension 3902, a sensor hub node 3904, a manager node 3906, and a socket.io server 3908. Depending on the size of the area to be covered by the system 3900, there may be multiple sensor extensions 3902, sensor hub nodes 3904, manager nodes 3906, and/or socket.io servers 3908, although the system 3900 will generally only use a single manager node 3906 and socket.io server 3908. Other nodes, such as field nodes (not shown), may be positioned between the sensor extension 3902 and the sensor hub node 3904, and/or between the sensor hub node 3904 and the manager node 3906. Although such additional nodes may be omitted entirely in some embodiments of the system 3900, larger areas may use such nodes to merge data and/or to manage smaller zones by offloading processing from the sensor hub node 3904 and/or the manager node 3906.

For purposes of example, the sensor hub node 3904 and the manager node 3906 contain one or more NIO platforms 402a and 402b, respectively. The sensor extension 3902 and/or the socket.io server 3908 may include NIO platforms in other embodiments. It is understood that a single NIO platform may be configured to provide the functionality needed for the entire system 3900 (assuming the device running the NIO platform instance is capable of the necessary processing), in which case only a single node may be present. However, the use of a distributed system of NIO platform instances may provide advantages, particularly when faced with limited bandwidth and/or other constraints. Accordingly, as described previously, the functionality described below with respect to the sensor extension 3902, the sensor hub node 3904, the manager node 3906, the socket.io server 3908, and/or the UI 3910 may be distributed in many different ways.

The sensor extension 3902 contains and/or is coupled to one or more sensors, such as temperature sensors that may be positioned above and/or below canopy and/or in the ground, relative humidity (RH) sensors, soil moisture sensors, light intensity sensors, ultraviolet index sensors, and/or any other type of sensor that may be used for agricultural purposes. For purposes of example, the soil moisture sensors may include multiple sensors that are distributed along a vertical plane, a horizontal plane, and/or in any other configuration to obtain soil moisture readings at different vertical and/or horizontal locations. In the present embodiment, the soil moisture sensors include six sensors that are arranged along a shaft that is positioned approximately perpendicular to the surface. This provides soil moisture readings at six different depths, such as six, eight, sixteen, twenty-four, thirty-two, and forty inches. It is understood that the number of sensors and their respective depths are for purposes of example only and may be any number of sensors positioned at any depths, including multiple sensors positioned at the same depth.

The sensor hub node 3904 is coupled to one or more valves (e.g., the valves of FIG. 35) that control fluid flow to one or more zones and to pressure sensors and/or fluid flow sensors that provide data on fluid flow through the valves. For example, there may be a pressure sensor on each side of a valve to measure pressure (e.g., in pounds per square inch (psi)) and a fluid flow sensor to measure the flow (e.g., in gallons per minute (gpm)). The sensor hub node 3904 is coupled to the sensor extension 3902. All connections between the components of FIG. 39 may be wireless and/or wired, depending on the particular layout of the system 3900. The sensor hub node 3904 includes one or more NIO platforms 402a. If the area covered by the sensor hub node 3904 is divided into zones, such as the zones of FIG. 34, a single NIO platform may cover multiple zones or one or more NIO platforms may be assigned to each zone. For example, one sensor hub node 3904 may be responsible for two zones and run two NIO platform instances, another sensor hub node 3904 may be responsible for three zones and run three NIO platform instances, and another sensor hub node 3904 may be responsible for two zones and run a single NIO platform instance. The allocation of one NIO platform instance per zone may be particularly useful if the zones contain different crops and/or growing conditions (e.g., types of soil or different available levels of irrigation), as each NIO platform can be configured for the needs of the particular zone for which that NIO platform is responsible.

In the present example, the manager node 3906 is coupled to one or more valves, such as the valves of FIG. 35, that control fluid flow to one or more zones and is responsible for actuating the valves when needed. This enables irrigation to continue even if the sensor hub node 3904 is not available, although data obtained via the sensor hub node may be unavailable. The manager node 3906 also handles communications with the socket.io server 3908, which enables data to be displayed via a UI (e.g., a GUI) 3910 and instructions to be received from the GUI 3910. Is it understood that the socket.io server 3908 and/or the UI 3910 may or may not be considered part of the system 3900 in other embodiments depending on the configuration of the system 3900, and the system 3900 may be operated without one or both of those components. The manager node 3906 includes one or more NIO platforms 402b.

In operation, the sensor extension 3902 obtains sensor data, such as temperature, relative humidity, and soil moisture data, and sends the data to the sensor hub 3904. The data is processed by services running on the NIO platform 402a of the sensor hub node 3904 and/or the NIO platform 402b of the manager node 3906. As described previously, the services may be distributed in many different ways between the sensor hub node 3904 and the manager node 3906. This processing may automatically perform actuations for irrigation and/or other actions, may present information and suggestions to a user via the GUI 3910, and/or may use feedback and/or instructions provided by the user via the GUI as triggers for actuations, modifications to monitoring parameters, and/or other actions.

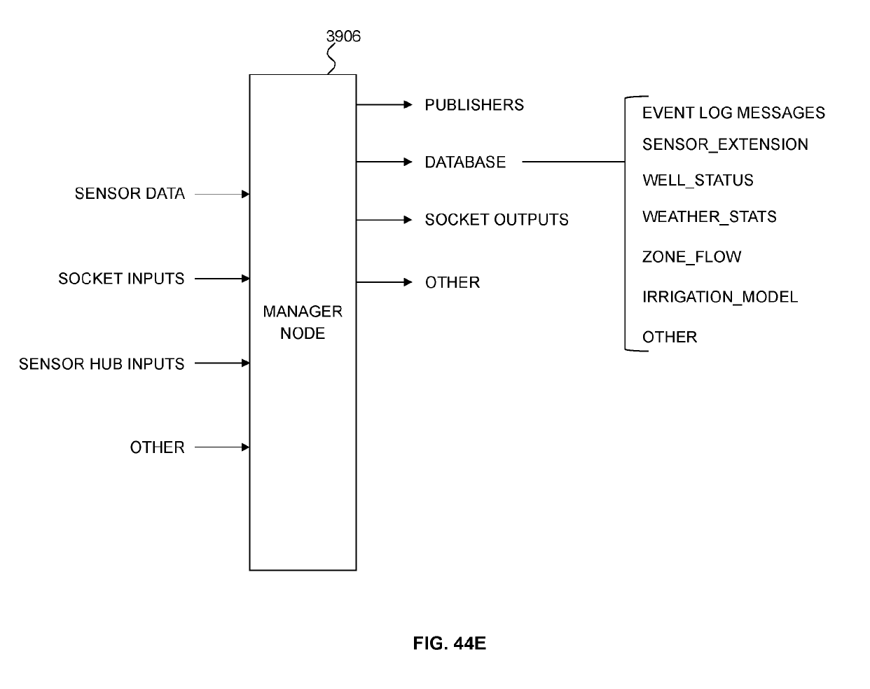

Referring to FIG. 40, one embodiment of an agriculture management system 4000 is illustrated with multiple sensor extensions 3902a-3902d, multiple sensor hub nodes 3904a and 3904b, the manager node 3906, and the socket.io server 3908 as described with respect to FIG. 39. In the present example, the manager node 3906 is coupled to agriculture component(s) 3720a (FIG. 37), the sensor hub node 3904a is coupled to agriculture component(s) 3720b, and the sensor hub node 3904b is coupled to agriculture component(s) 3720c. The sensor extensions 3902a-3902d are coupled to agriculture component(s) 3720d-3720g, respectively.

In some embodiments, the sensor hub nodes 3904a and 3904b and/or the manager node 3906 may not be coupled to agricultural components. In addition, lateral connections may exist between components at the same level, such as is shown between the sensor extensions 3902c and 3902d. Such lateral connections may be used for data transfer if one node cannot connect to the higher tier due to communication link failure or if distances are too great for such connections. For example, if the sensor extension 3902d in unable to communicate with the sensor hub node 3904b, data may be transferred from the sensor extension 3902d via the sensor extension 3902c. Such data may be transferred to the sensor hub node 3904 via the manager node 3906, via a lateral connection between the sensor hub nodes 3904a and 3904b, or may be processed elsewhere, such as by the sensor hub node 3904a or the manager node 3906.

It is understood that the distribution of nodes illustrated in FIG. 40 can be arranged in many different ways, with nodes being added, removed, combined, and/or divided. Furthermore, entire tiers of nodes can be added or removed as needed, depending on factors such as the geographic size of the environment in which the system 4000 is deployed and the amount of processing needed at particular nodes or tiers. Accordingly, the physical arrangement of the system 4000, as well as the organization and distribution of the functionality embodied within the system, has a great deal of flexibility due to the architecture of the NIO platforms used by the system.

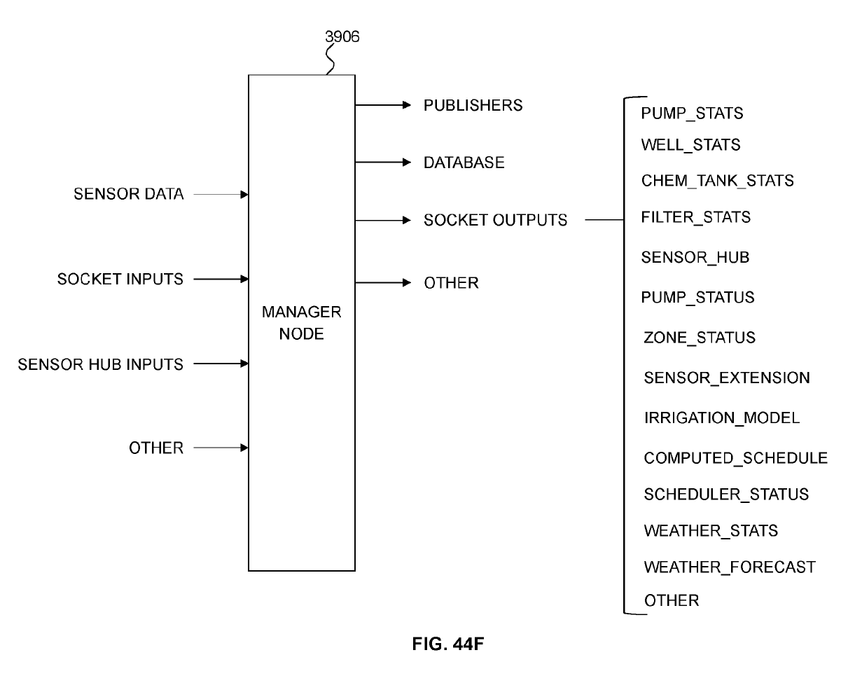

Referring to FIG. 41, a diagram 4100 illustrates one embodiment of a basic service flow that may be executed within the system of FIG. 39 or the system of FIG. 40 to provide scheduled irrigation and/or other functionality. Monitoring and sensor reading services 230a obtain information about the state of the environment in which the sensors are located. Input handling services 230b receive input (if any) from users. Scheduling services 230c determine and manage schedules if applicable. Actuation and monitoring services 230d turn various components off and on, and may monitor the state of those components as well as other attributes, such as the volume of water that has been distributed and the duration of a particular irrigation cycle. The monitoring services 230d may be the same as the monitoring services 230a or the services may be different.

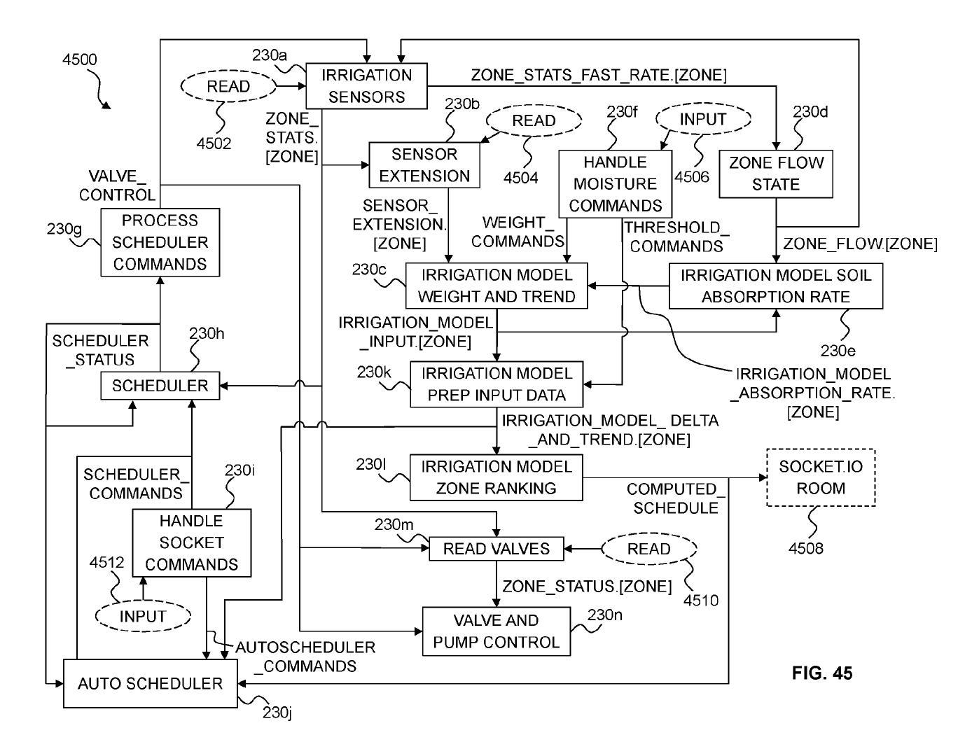

Referring to FIG. 42, one embodiment of a method 4200 illustrates a process that may be executed within the system of FIG. 39 or the system of FIG. 40 to provide scheduled irrigation. In step 4202, sensor data and user inputs are obtained. In step 4204, this information is used to calculate an irrigation schedule. In step 4206, one or more valves are actuated according to the irrigation schedule. The steps may be asynchronous, with currently available sensor data and user data used to perform step 4204. As new sensor data and user inputs are received asynchronously in step 4202, step 4204 may be repeated to determine whether the current schedule needs to be updated and/or corrected.

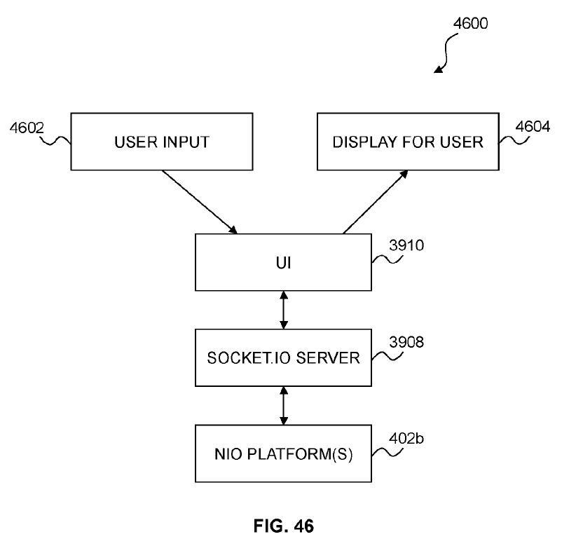

Referring to FIG. 43, one embodiment of the sensor hub node 3904 (FIG. 39) is illustrated with various inputs and outputs for the NIO platform(s) 402a. In the present example, the inputs include sensor data 4302, inputs 4304 from the manager node 3906, and any other inputs 4306 for which the NIO platform 402a may be configured. The outputs include publishers 4308 and any other outputs 4310 for which the NIO platform 402a may be configured. Although one example of how processing may be divided between the sensor hub node 3904 and the master node 3906 is described below, it is understood that processing may be divided in many different ways by splitting or combining services and/or moving functionality between nodes (or to another node). The sensor hub node 3904 is responsible for multiple zones and so may be configured to identify a particular zone for input/output corresponding to that zone.

In the present example, the environment 3400 is a vineyard as previously described. Each zone may be a particular varietal of grape, with different optimal growing conditions for each varietal. Accordingly, different zones may be configured differently.

The sensor data 4302 includes inputs for soil moisture levels, temperature, relative humidity, pre-valve and post-valve pressure, flow rate, and other information (if needed). The pre-valve and post-valve pressure data enables a determination to be made as to whether there is leakage and/or whether the valve is on or off.

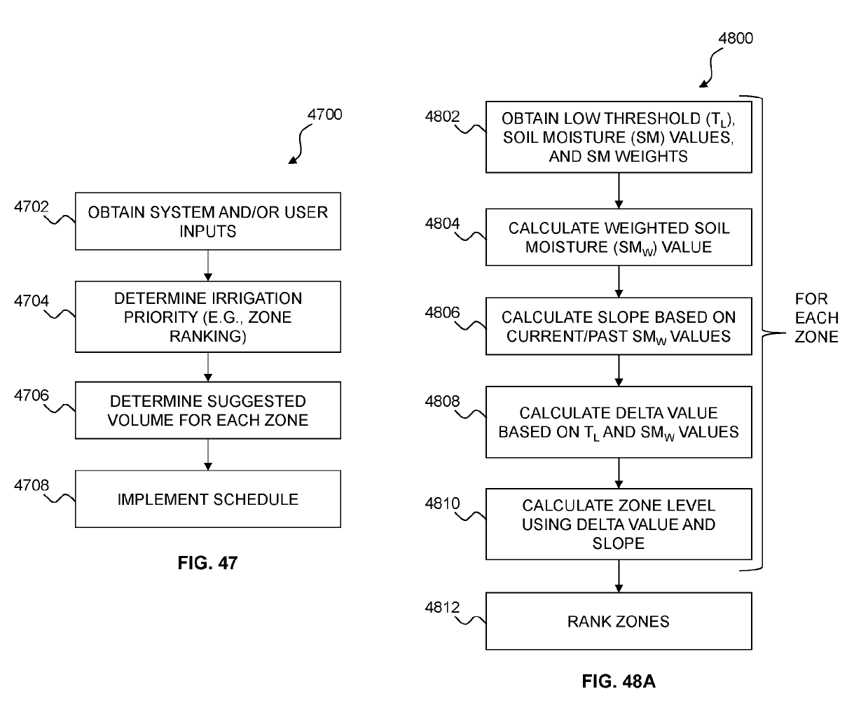

The manager node inputs 4304 will be discussed later with respect to the publishers 4410 (FIG. 44D) of the manager node 3906.

The publishers 4308 include an event log, zone_flow.[zone], zone_stats.[zone], zone_stats_fast rate.[zone], sensor_extension.[zone], weighted_soil_moisture.[zone], irrigation_model_absorption rate.[zone], irrigation_model_input.[zone], metrics, and other outputs (if needed).

The publisher for the event log publishes a message if certain criteria are met. For example, if a zone's valve is closed but the zone's flow rate is greater than a certain threshold, a message may be sent with the format “Closed valve has flow rate: {{$flow_rate}} (Zone {{$zone}}).” If the zone's valve is open and the flow rate is less than a certain threshold, a message may be sent with the format “Open valve has no flow rate: {{$flow_rate}} (Zone {{$zone}}).” If the zone's flow rate behavior returns to normal, a message may be sent with the format “Flow rate for {{“open” if $is_valve_open else “closed” }} valve is back to normal: {{$flow rate}} (Zone {{$zone}}).” If flow stops at a zone, a message may be sent with the format “Zone {{$zone}} watered for {{round($duration, 1)}} hours and received a total of {{$total_gallons}} gallons ({{$gallonsper_plant}} per plant).” It is understood that these are for purposes of example only and that may different events and messages may be defined.

The publisher zone_flow.[zone] sends a signal on state change. Valve flow threshold is defined at a certain level (e.g., 0.1 gpm from the flow_rate). Events from False to True trigger immediately upon crossing the threshold, but close events must be under the threshold for a defined period of time (e.g., 5 seconds) before triggering an event. When is_valve_flow is False (i.e., when flow has stopped) information about the watering period is also reported. Otherwise, those additional values are None. An example of such a publication is:

```
{
  ‘is_valve_flow’: False,
  ‘zone’: 1,
  ‘duration’: 6, # Watering duration in hours
  ‘total_gallons’: 100, # Total gallons delivered to zone
  ‘gallons_per_plant’: 1.0.
  ‘number_of_plants’: [number of plants],
}
```

The publisher zone_stats.[zone] sends irrigation signals once every defined period of time (e.g., two seconds) when flow is detected and once every defined period of time (e.g., one minute) when it is not. For purposes of example, the flow rate is in gallons per minute and the pressure is PSI. Historic flow rate is the average flow rate over a past period of time (e.g., the last two weeks) during times when flow is detected. An example of such a publication is:

```
{
  ‘zone’: 1,
  ‘flow_rate’: 0.0,
  ‘historic_flow_rate’: 18.0,
  ‘flow_start_time’: datetime.datetime.utcnow( ), # The time
at which the zone was commanded to open
  ‘total_gallons’: 0.0, # The amount of gallons delivered since
  flow_start_time
  ‘gallons_per_plant’: 0.0, # total_gallons divided by the number of
  plants in the zone
  ‘number_of_plants’: [number of plants],
  ‘pre_valve_psi’: 0.0,
  ‘post_valve_psi’: 0.0,
  ‘datetime’: datetime.datetime.utcnow( )
}
```

The publisher zone_stats_fast_rate.[zone] is the same as zone_sensor.[zone], but always streams at a particular rate (e.g., once every two seconds).

The publisher sensor_extension.[zone] sends sensor extension data for each received reading from a sensor extension. An example of such a publication is:

{

‘zone’: 1,
‘sensor_extension’: ‘1’,
‘time_received’: datetime.datetime.utcnow( ),
‘rssi’: 61,
‘batt_voltage’: ‘3.81’,
‘solar_voltage’: ‘0.00’,
‘temperature’: 24.24,
‘humidity’: 28.71,
‘soil1’: 52.0609,
‘soil2’: 73.9542,
‘soil3’: 72.0243,
‘soil4’: 71.1676,
‘soil5’: 70.4207,
‘soil6’: 68.4634,
‘flow_rate_zone’: 0.0,

}

The publisher weighted_soil_moisture.[zone] publishes a single weighted value for a sensor_extension reading after the six soil moisture readings are converted to one weighted value. A more detailed description of weighting is provided below in a later embodiment. An example of such a publication is:

{

“zone”: 1,
“sensor_extension”: “1”,
“soil_moisture”: 2.3734,

}

The publisher irrigation_model_absorption_rate.[zone] reports the soil moisture absorption rate for the previous watering period and the historical average each time a zone starts watering. If the gallons per plant are less than one, the signal may not be published or counted towards the historic average. An example of such a publication is:

{

“zone”: 1
“gallons_per_plant”: 1.2,
“starting_moisture”: 80.0,
“max_moisture”: 95.0,
“absorption_rate”: 0.2, # Average of previous 10 waterings
“last_absorption_rate”: 0.2,

}

The publisher irrigation_model input.[zone] reports the trend (e.g., the linear slope) of the most recent weighted_soil_moisture data and the data point at the end of that line on a regular timed schedule (e.g., every ten minutes). This may be merged in the latest absorption rate from irrigation_model_absorption_rate.[zone]. An example of such a publication is:

{

“zone”: 1,
“soil_moisture”: 2.3734,
“trend”: 0.0,
“trend_end_moisture”: 0.0,
“absorption_rate”: 0.2,
“weight”: [25, 25, 50, 0, 0, 0],

}

The publisher metrics adds the name of the NIO platform instance and the zone and publishes the metrics. An example of such a publication is:

{

‘instance_name’: ‘instance_name’
‘zone’: 1,
‘cpu_percentage_per_cpu’: 61.0,
‘cpu_percentage_overall’: 60.8,
‘disk_usage_free’: 4089815040,
‘disk_usage_percent’: 40.7,
‘disk_usage_total’: 7494909952,
‘disk_usage_used’: 3049119744,
‘virtual_memory_active’: 295436288,
‘virtual_memory_available’: 302919680,
‘virtual_memory_buffers’: 83419136,
‘virtual_memory_cached’: 141709312,
‘virtual_memory_free’: 77791232,
‘virtual_memory_inactive’: 52396032,
‘virtual_memory_percent’: 33.6,
‘virtual_memory_total’: 456437760,
‘virtual_memory_used’: 378646528,

}

Referring to FIG. 44A-44F, one embodiment of the manager node 3906 (FIG. 39) is illustrated with various inputs and outputs for the NIO platform(s) 402b. In the present example, the inputs include sensor data 4402, socket inputs 4404, publishers 4406 from the sensor hub node 3904, and any other inputs 4408 for which the NIO platform 402b may be configured. The outputs include publishers 4410, database 4412, socket outputs 4414, and any other outputs 4416 for which the NIO platform 402b may be configured.

Sensor data 4402 (FIG. 44B) may include data for a chemical tank (e.g., flow rate, tank level, and pump amperage), pre and post filter pressure of a filter or filter system associated with a main pump, the main pump (status, flow rate, and amperage), valve statuses (e.g., open or closed), a well level (overall level and location of the pump in the well), and other information (if needed).

Socket inputs 4404 (FIG. 44C) may include zone_commands, scheduler_commands, autoscheduler_commands, threshold_commands, weight_commands, annotation_commands, and other information (if needed).

The zone_commands socket input enables the reception of start and stop commands to open zone valves and control the well pump. If no valves are open, the main well pump may be turned on when the open valve command is received. If the last valve is closing, the main well pump may be turned off when a close valve command is received. When using a volume argument (if available), the gallons per plant is obtained from the zone_sensor.[zone] published signals for the corresponding zone. Those signals have an attribute of “gallons_per_plant” which is the number of gallons since the valve was commanded to open. In some embodiments, if the zone_sensor.[zone] publisher is not sending data, then the flow rate from the well pump may be used to calculate the gallons per plant that has been delivered to the zone. An example of such an input is:

{

“commandId”: “088dc883-e4c3-45f5-8372-67b40005883e”,
“command”: “open”, # “open” or “close”
“zone”: 1, # zone number to open valve for
“duration”: 60, # (optional) minutes before closing valve after it

opens with an “open” command

“volume”: 60, # (optional) amount of gallons per plant to water

before closing valve after “open” command

“delay”: 60 # (optional) minutes before opening the valve after an
“open” command

}

The scheduler_commands socket input enables the reception of start and stop commands for scheduling. A “start” command starts a new watering schedule. A “stop” command cancels a running schedule. Examples of support step commands are: “wait” and “start.” They may be configured to require a duration and “start” commands may be configured to need a list of zones. An example of such an input is:

{

“command”: “start”,
“commandId”: “088dc883-e4c3-45f5-8372-67b40005883e”,
“steps”: [

{

“duration”: 0.1,
“command”: “wait”

},
{

“zones”: [

1,
2

],
“duration”: 0.1,
“command”: “start”

},
{

“zones”: [

3

],
“duration”: 0.1,
“command”: “start”

}

],

}

The autoscheduler_commands socket input enables the reception of start and stop commands for an automated irrigation scheduler. An example of such an input is:

{

″commandId″: ″088dc883-e4c3-45f5-8372-67b40005883e″,
″enabled″: True,
″type″: ″status″, # Use a ‘type‘ to store current state on socket.io
server

}

The threshold_commands enable the reception of user input to set high and low thresholds for irrigation control. Examples of high and low thresholds are described below in a later embodiment. An example of such an input is:

{

“zone”: 1,
“high”: 75,
“low”: 50,

}

The weight_commands socket input enables the reception of user input to set moisture weights for calculating weighted soil moisture levels from soil moisture readings. Examples of moisture weights are described below in a later embodiment. An example of such an input is:

{

“zone”: 1,
“weight”: [25, 25, 50, 0, 0, 0],

}

The annotation_commands socket input enables user input to be saved to an event log. An example of such an input is:

{

“message”: “the message”, # A human readable message/summary
of the event
“to”: None, # The recipient of the message (null === everyone)
“sender”: “sender”, # The sender of the message
“type”: “annotation”, # Message type for interpreting details
“details”: { }, # A JSON object container (or another object type) for

details/whatever the user inputs about the event
}

The sensor hub inputs 4406 are discussed above with respect to the publishers 4308 (FIG. 43) of the sensor hub node 3904.

The publishers 4410 (FIG. 44D) include publishers for an event_log, zone_status, zone_stream_status, pump_status, pump_stats, well_stats, chem_tank_stats, weather_stats, valve_control, pump_control, irrigation_model_delta_and_trend, scheduler_commands, scheduler_status, metrics, computed_schedule, and other information (if needed). In the present example, “*_status” channels are generally used only when a status changes occurs, while “*_stats” channels are used for streaming data.

The publisher event_log publishes a message if certain criteria are met. Additional event logs may come from user annotations that are sent from the GUI 3910 to the socket room annotation_commands. Signals published to the event_log publisher are verified to a message and sender, and then are tagged with an id and time before going to a database. Examples of events include the following criteria and message types. For each published zone_stream_status signal, a message may be sent with the format “Data from zone {{$zone}} is {{“fresh” if $zone_stream_status else “stale”}}.” For each published pump_status signal, a message may be sent with the format “The main pump was turned {{“on” if $is_pump_on else “off”}}.” For each valid published valve_control signal, a message may be sent with the format “{{“Opening” if $value else “Closing” }} zone {{$zone}}.” For each published pump_control signal, a message may be sent with the format “Turning {{$command}} main well pump.”

For scheduler publications, for each published scheduler_status of “continue,” a message may be sent with the format “Scheduler starting zone(s) {{$steps[$step_index][“zones”] }} for {{round($steps[$step_index][“duration”]/60, 1)}}hours (step {{$step_index+1}} of {{len($steps)}}).” For scheduler publications, for each published scheduler_status of “complete,” a message may be sent with the format “Schedule has completed all {{len($steps)}} steps.” For scheduler publications, for each published scheduler_status of “cancel,” a message may be sent with the format “Scheduled watering has been cancelled.”

If the well level drops below a defined threshold (e.g., 400 feet), a message may be sent with the format “The well level has dropped below 400 ft.” If the well level drops below 420 feet, a message may be sent with the format “The well level has dropped below 420 ft. You should consider turning off the main pump until the well level can stabilize.” If the well level drops below 440 feet, a message may be sent with the format “The well level has dropped below the pump (440 ft.). Turn off the main pump.” It is understood that the triggering events, parameters, and language of various event messages described herein may vary, and the listed messages are for purposes of example only. In some embodiments, one or more actions may be taken in addition to, or as an alternative to, sending a message. For example, the main pump may be shut off if the water level reaches a certain point.

The publisher zone_status sends an event signal on state change and polls for valve status every defined period of time (e.g., five seconds). An example of such a publication is:

{

‘is_valve_open’: False,
‘zone’: 1,
‘last_opened’: datetime,
‘last_duration’: 500, # on valve close, minutes valve was open, on
valve open, is None.
‘scheduled_duration’: 500, # (optional) minutes specified by last
zone open command
‘last_volume”: 6, # on valve close, gallons watered per plant, on
valve open, is None.
‘scheduled_volume’: 6, # (optional) gallons per plant specified by
last zone open command

}

The publisher zone_stream_status subscribes to data from the sensor hubs (type.sensor (e.g., zone_stats)) and determines if a zone ever stops sending data (e.g., goes dry) for a defined period of time (e.g., 150 seconds). The zone_stream_status is True when the stream is normal (e.g., when receiving data at least every 150 seconds) and False when data has stopped and is not received in the defined time frame. An example of such a publication is:

{

‘zone_stream_status’: True,
‘zone’: 1,

}

The publisher pump_status sends a signal each time the main well pump turns on and off. An example of such a publication is:

{

“is_pump_on”: false,

}

The publisher pump_stats streams pump stats data at defined times (e.g., every minute). An example of such a publication is:

{

“flow_rate”: 0.0,
“amps”: 0.0,

}

The publisher well_stats streams well stats data at defined times (e.g., every ten minutes). An example of such a publication is:

{

“well_level”: 314,

}

The publisher chem_tank_stats stream chemical tank stats data at defined times (e.g., every minute). An example of such a publication is:

{

“flow_rate”: 0.0,
“amps”: 0.0,
“chem_tank_level”: 314,

}

The publisher weather_stats polls a weather station at defined times (e.g., every fifteen minutes). The weather station may be a local station (e.g., positioned within or proximate to the vineyard) or may be remote and accessed online or in another manner. An example of such a publication is:

{

‘type’: ‘weather_stats’,
‘time’: datetime.datetime(2016, 7, 7, 20, 9, 27, 377795),
‘solar_radiation’: 1188,
‘barometer’: 29.781,
‘start_date_of_current_storm’: “b'\\xff\\xff”,
‘inside_temperature’: 96.2,
‘day_rain’: 0.0,
‘inside_humidity’: 32,
‘year_et’: 30.3,
‘outside_temperature’: 87.9,
‘wind_direction’: 200,
‘time_of_sunrise’: 519,
‘10_min_avg_wind_speed’: 0,
‘rain_rate’: 0,
‘time_of_sunset’: 1928,
‘uv’: 134,
‘month_et’: 1.21,
‘year_rain’: 2.75,
‘wind_speed’: 0,
‘day_et’: 0.22,
‘month_rain’: 0.53,
‘outside_humidity’: 37,
‘storm_rain’: 0.0,
‘head_index’: 93,
‘dew_point’: 60,

}

The publisher valve_control opens and closes zone valves for irrigation control. Valid commands are “open” and “close.” An example of such a publication is:

{

“zone”: 1,
“command”: “open”,
“duration”: 500, # (optional) minutes before closing valve after it

opens with an “open” command

“volume”: 6, # (optional) minutes before closing valve after it opens

with an “open” command
}

The publisher pump_control turns on and off the main well pump. An “on” command is published when the system detects that no valves were open and now one or more valves are open. An “off” command is published when the system detects that one or more valves were open and now none are. Valid commands are “on” and “off.” An example of such a publication is:

{

“command”: “open”,

}

The publisher irrigation_model_delta_and trend prepares input data for an irrigation model. The model ranks zones by which zone needs water most and gives suggested water amounts. An example of this process is described below in a later embodiment. An example of such a publication is:

{

“zone”: 1,
“soil_moisture”: 57.00, # rounded, weighted soil moisture for the
given sensor extension
“trend”: 1.0, # rounded, slope of soil moisture trend over time
“delta”: 7.0, # distance of soil_moisture from low threshold
“need”: 8.0, # the calculated need of water for this zone- lower

number means water is needed more desperately

“low”: 50, # user configured low soil moisture threshold level
“high”: 50, # user configured high soil moisture threshold level
“rnd”: 0.1,# value to round calculated trend, delta and score to
“absorption_rate”: 0.0 # published from input data
“volume_suggestion”: 1.0 # amount of gallons suggested to water
per zone

}

The publisher scheduler_commands re-publishes zone_commands and scheduler_commands from the socket.io server 3908 for use by the NIO platform services. Zone_commands may be reformatted as scheduler_commands with a single step. “Start” commands start a new watering schedule. “Stop” commands cancel a running schedule. Support step commands are “wait” and “start.” In the present example, steps must include either a duration or volume, but not both. “Start” commands need a list of zones. An example of such a publication is:

{

“command”: “start”,
“commandId”: “088dc883-e4c3-45f5-8372-67b40005883e”,
“steps”: [

{

“zones”: [

1,
2

],
“duration”: 0.1,
“command”: “start”

},
{

“zones”: [

3

],
“duration”: 0.1,
“command”: “start”

}

],

}

The publisher scheduler_status provides a current scheduler status indication. A status_type can be: “continue,” “complete,” or “cancel.” The step_index is the current step, starting at 0. Therefore, a “complete” job will have a step index equal to the length of all steps. A “cancel” job has a step index of the current step at the time of the stop command. When watering multiple zones at once by volume, an additional field “complete_zones” is included on a “continue” signal when some zones complete their watering cycle, but other zones have not yet completed for the step. When “complete_zones” is not applicable, it is set to “none,” and when it is applicable, it contains a list of the relevant zones. An example of such a publication is:

{

“datetime”: “2016-04-27 21:17:35.764380”,
“commandId”: “088dc883-e4c3-45f5-8372-67b40005883e”,
“steps”: [

{

“duration”: 0.1,
“command”: “wait”

},
{

“zones”: [

1,
2

],
“duration”: 0.1,
“command”: “start”

},
{

“zones”: [

3

],
“duration”: 0.1,
“command”: “start”

}

],
“step_index”: 0,
“status_type”: “continue”

}

The publisher metrics publishes metrics data to {“type”: “metrics” }. An “instance_name” is added to the signal from the SystemMetrics and published. An example of such a publication is:

{

‘instance_name’: ‘instance_name’,
‘cpu_percentage_per_cpu’: [61.0],
‘cpu_percentage_overall’: 60.8,
‘disk_usage_free’: 4089815040,
‘disk_usage_percent’: 40.7,
‘disk_usage_total’: 7494909952,
‘disk_usage_used’: 3049119744,
‘virtual_memory_active’: 295436288,
‘virtual_memory_available’: 302919680,
‘virtual_memory_buffers’: 83419136,
‘virtual_memory_cached’: 141709312,
‘virtual_memory_free’: 77791232,
‘virtual_memory_inactive’: 52396032,
‘virtual_memory_percent’: 33.6,
‘virtual_memory_total’: 456437760,
‘virtual_memory_used’: 378646528,

}

The publisher computed_schedule sends a ranked zone list for use in watering. The first zone is the zone prioritized to be watered next. An example of such a publication for twelve zones is:

{

“type”: “computed_schedule”,
“ranking”: [9, 5, 10, 8, 3, 2, 12, 1, 7, 4, 6, 11],
“recently_watered”: [11], # zones that have started watering within
the last 12 hours

}

The database 4412 (FIG. 44E) may be used to store event log messages, sensor_extension information, well_status information, weather_stats information, zone_flow information, irrigation model information, and other information (if needed). New indexes may be created as desired (e.g., each day). For the sensor_extension information, a document may be stored for each publication from sensor_extension. For well_status information, a document may be stored for each publication from well_status. For weather_stats information, a document may be stored for each weather_stats publication. For zone_flow information, a document may be stored for each zone_flow publication. This data may be used to see how much water was delivered to each zone. For irrigation_model information, a document may be stored for each irrigation_model_delta_and_trend publication. This data, which may include weighted soil moisture, high threshold, low threshold, soil absorption rate, suggested watering volume, etc., may be used for creating charts to show historical moisture per zone.

Socket outputs 4414 (FIG. 44F) include pump_stats, well_stats, chem_tank_stats, filter_stats, sensor_hub, pump_status, zone_status, sensor_extension, irrigation_model, computed_schedule, scheduler_status, weather_stats, weather_forecast, and other information (if needed). Some socket outputs are similar or identical to the corresponding publishers that have been discussed above and are not repeated in detail below.

The filter_stats socket output streams filter stats data every defined period of time (e.g., every minute). An example of such an output is:

{

“type”: “manager”,
“pre_filter_psi”: 0.0,
“post_filter_psi”: 0.0,

}

The sensor_hub socket output forwards irrigation sensor data from sensor hub nodes to the socket.io server 3908. When the manager node 3906 has not received data from a zone for some time, it determines that the data is stale and sends an appropriate message instead of the data. The type is the zone identifier so that on connection to the socket.io room, the latest data for each zone is received. An example of such an output is:

{

‘type’: 1,
‘zone’: 1,
‘flow_rate’: 0.0,
‘pre_valve_psi’: 0.0,
‘post_valve_psi’: 0.0,

}

The sensor_extension socket output stores a document for each publication from sensor_extension. An example of such an output is:

{

‘zone’: 1,
‘type’: ‘1’,
‘sensor_extension’: ‘1’,
‘time_received’: datetime.datetime.utcnow( ),
‘rssi’: 61,
‘batt_voltage’: ‘3.81’,
‘solar_voltage’: 0.00',
‘temperature’: 24.24,
‘humidity’: 28.71,
‘soil1’: 52.0609,
‘soil2’: 73.9542,
‘soil3’: 72.0243,
‘soil4’: 71.1676,
‘soil5’: 70.4207,
‘soil6’: 68.4634,
‘flow_rate_zone’: 0.0,

}

The irrigation_model socket output stores a document for each irrigation_model_delta_and_trend publication. This may be used for creating charts to show historical moisture per zone and the data may include weighted soil moisture, high threshold, low threshold, soil absorption rate, and/or suggested watering volume. An example of such an output is:

{

“zone”: 1,
“type”: 1,
“soil_moisture”: 57.00, # rounded, weighted soil moisture for the
given sensor extension
“trend”: 1.0, # rounded, slope of soil moisture trend over time
“delta”: 7.0, # distance of soil_moisture from low threshold
“need”: 8.0, # the calculated need of water for this zone- lower

number means water is needed more desperately

“low”: 50, # user configured low soil moisture threshold level
“high”: 50, # user configured high soil moisture threshold level
“rnd”: 0.1,# value to round calculated trend, delta and score to
“absorption_rate”: 0.0 # published from input data
“volume_suggestion”: 1.0 # amount of gallons suggested to water
per zone

}

The weather_forecast socket output produces a weather forecast that is obtained from a weather forecast service, such as may be available online, every defined period of time (e.g., ten minutes). In other embodiments, the socket output may include information obtained from the weather station. An example of such an output is:

{

“time”: “2016-08-08 23:47:46.602088”,
“hourly”: [

{

“time”: 1470697200,
“temperature”: 87.7,
“precipIntensity”: 0.003,
“precipProbability”: 0.09

},
{

“time”: 1470704400,
“temperature”: 86.12,
“precipIntensity”: 0.0135,
“precipProbability”: 0.41

},
{

“time”: 1470711600,
“temperature”: 81.43,
“precipIntensity”: 0.0029,
“precipProbability”: 0.09

},
{

“time”: 1470718800,
“temperature”: 75.67,
“precipIntensity”: 0.0256,
“precipProbability”: 0.51

},
{

“time”: 1470726000,
“temperature”: 73.47,
“precipIntensity”: 0,
“precipProbability”: 0

},
{

“time”: 1470733200,
“temperature”: 70.72,
“precipIntensity”: 0,
“precipProbability”: 0

},
{

“time”: 1470740400,
“temperature”: 67.81,
“precipIntensity”: 0,
“precipProbability”: 0

}

],
“daily”: [

{

“time”: 1470639600,
“precipProbability”: 0.55,
“temperatureMax”: 91.64,
“precipIntensity”: 0.0072,
“temperatureMin”: 68.97

},
{

“time”: 1470726000,
“precipProbability”: 0.54,
“temperatureMax”: 89.38,
“precipIntensity”: 0.0104,
“temperatureMin”: 67.29

},
{

“time”: 1470812400,
“precipProbability”: 0.65,
“temperatureMax”: 80.94,
“precipIntensity”: 0.0613,
“temperatureMin”: 66.32

},

{

“time”: 1470898800,
“precipProbability”: 0.5,
“temperatureMax”: 82.41,
“precipIntensity”: 0.008,
“temperatureMin”: 62.9

},
{

“time”: 1470985200,
“precipProbability”: 0.09,
“temperatureMax”: 81.33,
“precipIntensity”: 0.0004,
“temperatureMin”: 61.97

},
{

“time”: 1471071600,
“precipProbability”: 0.01,
“temperatureMax”: 84.73,
“precipIntensity”: 0.0003,
“temperatureMin”: 61.37

},
{

“time”: 1471158000,
“precipProbability”: 0.15,
“temperatureMax”: 79.19,
“precipIntensity”: 0.0012,
“temperatureMin”: 62.38

},
{

“time”: 1471244400,
“precipProbability”: 0.18,
“temperatureMax”: 75.57,
“precipIntensity”: 0.0011,
“temperatureMin”: 60.75

}

],
“daily_gdd”: 30.305000000000007,
“type”: “weather_forecast”

}

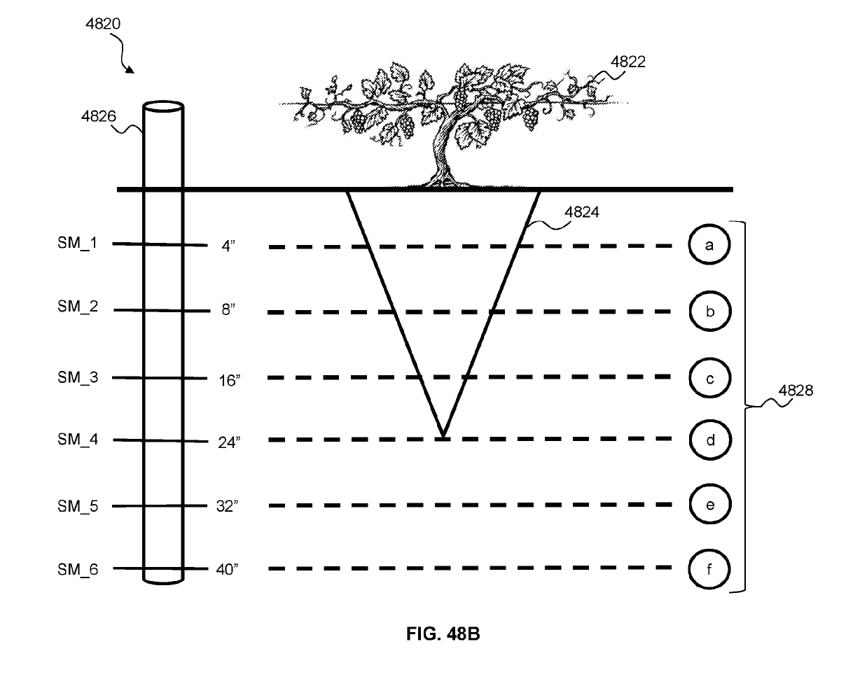

Referring to FIG. 45, one embodiment of a service structure 4500 that may be executed within the system of FIG. 39 or the system of FIG. 40 to provide scheduled irrigation and/or other functionality is illustrated. In the present example, services 230a-230n are executed by one of the NIO platforms 402a and 402b running on the sensor hub node 3904 and the manager node 3906, respectively. The services 230a-230n communicate using a publisher/subscriber model, with each service publishing to and subscribing to various channels as configured. The publishers include publishers 4308 described with respect to the sensor hub node 3904 of FIG. 43 and publishers 4410 described with respect to the manager node 3906 of FIG. 44D.

For purposes of illustration, the services 230a-230e are located on the sensor hub node 3904 and the services 230f-230n are located on the manager node 3906. It is understood that the services 230a-230n may be divided, combined, and/or distributed in many different ways as previously described.

The service structure 4500 is configured to obtain data from sensors and/or users, determine an irrigation schedule, and execute that irrigation schedule. The irrigation schedule may be overruled by user input and irrigation may be handled manually (e.g., by actuating various valves based on user input commands).

In operation, an IrrigationSensors service 230a reads sensor data 4502, such as pre and post valve pressure and fluid flow rate of sensor data 4302 (FIG. 43), and publishes this via the publishers zone_stats.[zone] and zone_stats_fast rate.[zone], where [zone] identifies the particular zone corresponding to the data.

A SensorExtension service 230b receives information 4504 from a sensor extension 3902 and receives the zone_stats.[zone] publication. The SensorExtension service 230b appends the zone_stats information to the sensor extension values and publishes this information via the sensor_extension.[zone] publisher.

A ZoneFlowState service 230d receives the zone_stats_fast_rate.[zone] publication, determines any valve state changes, and publishes zone_flow.[zone]. Zone_flow.[zone] feeds back into the IrrigationSensors service 230a and into an IrrigationModel_SoilAbsorptionRate service 230e.

The IrrigationModel_SoilAbsorptionRate service 230e receives the zone_flow.[zone] publication and an irrigation_modelinput.[zone] publication from an IrrigationModel WeightAndTrend service 230c. The IrrigationModel_SoilAbsorptionRate service 230e calculates and publishes the irrigation_model_absorption_rate.[zone].

A HandleMoistureCommands service 230f receives user input 4506 that provides weight_commands and threshold_commands.

The IrrigationModel WeightAndTrend service 230c receives the sensor_extension.[zone] publication and the weight_commands publication, and uses this information to calculate the trend of the zone's soil moisture data. This is merged with the irrigation_model_absorption rate.[zone] publication and published as the irrigation_model_input.[zone].

An IrrigationModel_PrepInputData service 230k receives the irrigation_model input.[zone] publication and the threshold_commands publication and calculates a delta between the zone's current soil moisture level and the low threshold. This provides an indication of “need” for the zone with respect to irrigation. The IrrigationModel_PrepInputData service 230k may also calculate a volume suggestion for the zone (e.g., how much water should be used in the next irrigation period). This information is published as irrigation_delta_model_and_trend[zone].

An IrrigationModel_ZoneRanking service 230l receives the irrigation_delta_model_and_trend[zone] and ranks the different zones based on their need. This provides a ranked zone list for irrigation that takes each zone's current need into account and provides water volume suggestions. It is understood that the model may account for many different variables and is highly flexible in how zones may be ranked. The IrrigationModel_ZoneRanking service 230l publishes a computed_schedule and may also sent the computed_schedule to a socket.io room 4508 for use with the GUI 3910.

A HandleSocketCommands service 230i may receive input 4512 and publish scheduler commands and autoscheduler commands.

A Scheduler service 230h receives any scheduler_commands and the zone_stats.[zone] publication. The Scheduler service 230h determines whether a schedule is currently running and, if so, where the current irrigation cycle is in the schedule. The Scheduler service 230h publishes the scheduler_status, which also serves as feedback to the Scheduler service 230h itself.

An AutoScheduler service 230j receives the computed_schedule publication, any autoscheduler_commands, the irrigation_model_delta_and_trend, and the scheduler_status. The AutoScheduler service 230j determines whether autoscheduling is enabled and, if so, pulls the next zone from the computed_schedule, merges the volume suggestion, and publishes scheduler_commands to initiate the autoschedule.

A ProcessSchedulerCommands service 230g receives the scheduler_status and determines the current status (e.g., “continue,” “complete,” or “cancel”). Depending on the status, the ProcessSchedulerCommands service 230g determines whether to turn off or on various valves to comply with the schedule and publishes valve_control. The valve_control publication is received by the IrrigationSensors service 230a, a ReadValves service 230m, and a ValveAndPumpControl service 230n.

The ReadValves service 230m reads the state 4510 (e.g., open or closed) of the valve(s) and receives the valve_control and zone_stats.[zone] publications. The ReadValves service 230m calculates the last duration and volume for the valve(s) and publishes zone_status.[zone].

The ValveAndPumpControl service 230n receives the valve_control and zone_status.[zone] publications. The ValveAndPumpControl service 230n actuates the valves based on the valve_control input and actuates the pump based on the zone_status.[zone] input.

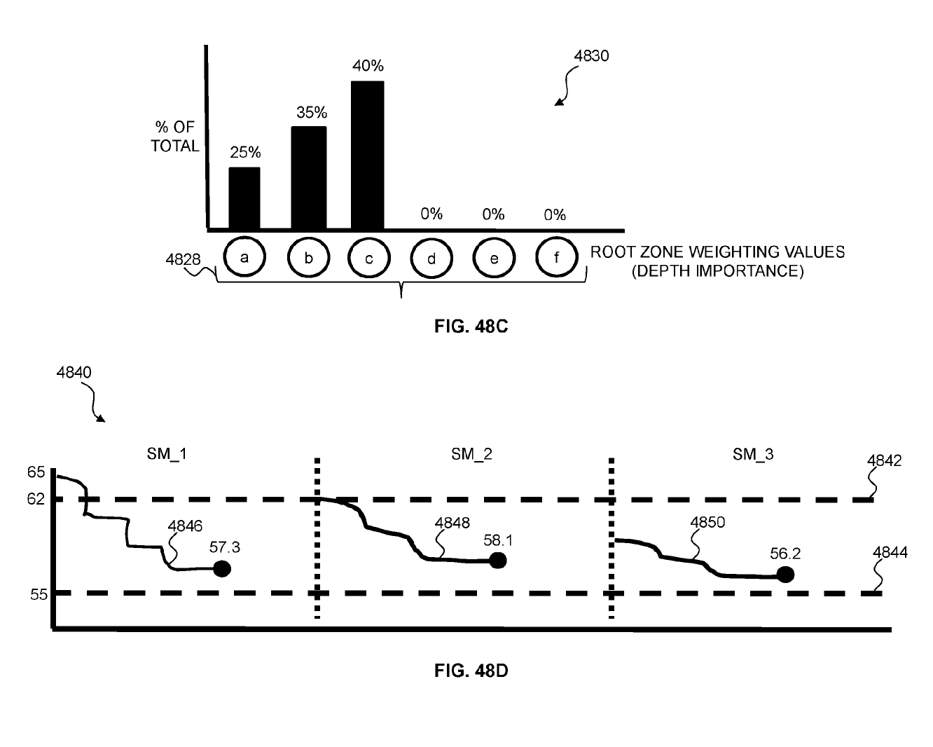

Referring to FIG. 46, one embodiment of an environment 4600 is illustrated. The environment 4600 may include a portion of the system 3900 of FIG. 39, including the NIO platform 402b, the socket.io server 3908, and the UI 3910. As shown in FIG. 46, the UI 3910 provides an interface with which a user (not shown) can interact with the NIO platform(s) 402b. While such interaction is possible without the socket.io server 3908, the socket.io server 3908 may be used to provide a graphical interface for the user. The UI 3910 enables the NIO platform 402b to receive user input 4602 and produce output 4604 for user consumption.

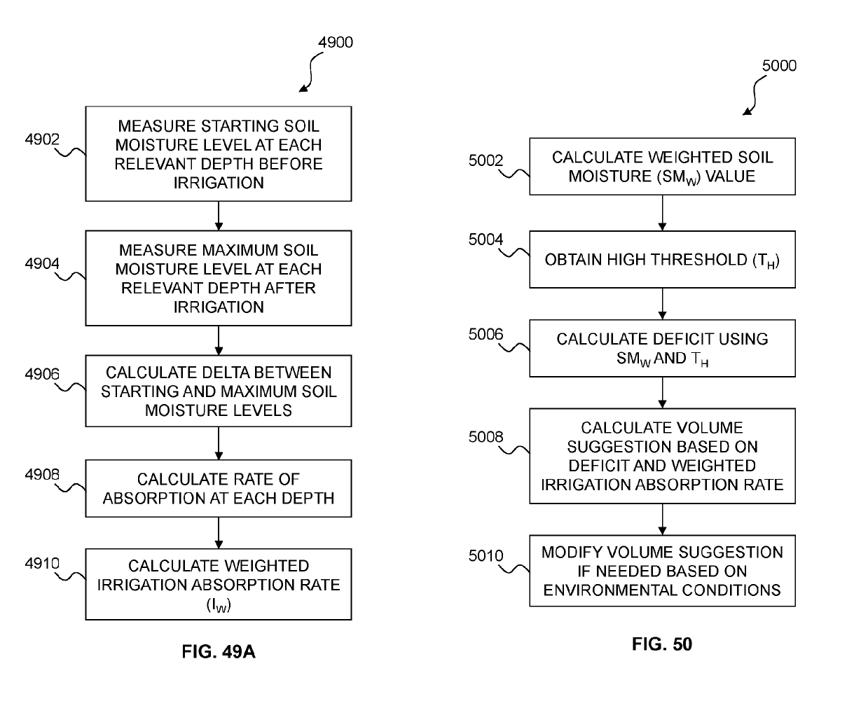

Referring to FIG. 47, a method 4700 illustrates one embodiment of an irrigation process that may be executed within an agricultural system, such as the system of FIG. 39 or the system of FIG. 40. The irrigation process uses information gathered from sensors, any applicable user inputs, and available irrigation components to determine and execute an irrigation schedule. In the present example, the irrigation process uses the sensor extension 3902, sensor hub node 3904, manager node 3906, socket.io server 3908, and GUI 3910 of FIGS. 39-45. It is understood that this is for purposes of illustration only, and the irrigation process can be implemented within many different systems, including systems that do not use NIO platforms. The irrigation process may be fully automated or may be configured to enable manual modification and/or control.

In step 4702, the irrigation process obtains system inputs (e.g., sensor data) and any applicable user inputs. In step 4704, an irrigation priority is determined. This may be done when there are multiple zones that cannot be watered simultaneously. For example, if the irrigation infrastructure does not have enough water pressure to water all zones at once, the zones may be ranked by priority to ensure that the zones that need water the most will be watered first. In step 4706, a suggested volume of water may be determined for each zone. In step 4708, the schedule is implemented. For example, this may be accomplished using the service structure of FIG. 45 or in another way.

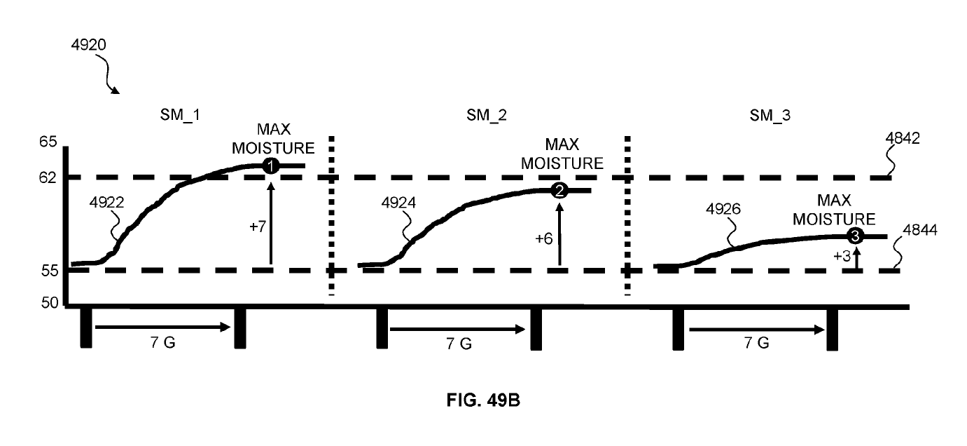

Referring to FIG. 48A, a method 4800 illustrates one embodiment of a process that is a more detailed example of steps 4702 and 4704 of FIG. 47. In step 4802, a low threshold (T_{L}), soil moisture (SM) values, and soil moisture weights are obtained. The use of weighted soil moisture values is described in greater detail with respect to FIGS. 48B and 48C.

With additional reference to FIG. 48B, which is not necessarily to scale, one embodiment of an environment 4820 is illustrated with a vine 4822 having a root system that extends downwards into an area 4824. It is understood that the area 4824 is for purposes of illustration and does not necessarily accurately represent a root system for a plant such as the vine 4822. The area 4824 may be thought of as an area of interest for irrigation purposes and may change during the plant's growth cycle. In the present example, a series of soil moisture (SM) sensors are coupled to a probe 4826 and are positioned at various depths. More specifically, soil moisture sensor 1 (SM_1) is positioned at four inches, soil moisture sensor 2 (SM_2) is positioned at eight inches, soil moisture sensor 3 (SM_3) is positioned at sixteen inches, soil moisture sensor 4 (SM_4) is positioned at twenty-four inches, soil moisture sensor 5 (SM_5) is positioned at thirty-two inches, and soil moisture sensor 6 (SM_6) is positioned at forty inches. Each soil moisture sensor SM_1-SM_6 may be associated with a corresponding weight 4828, which are labeled a-f, respectively.

With additional reference to FIG. 48C, which is not necessarily to scale, one embodiment of a chart 4830 provides an x-axis with the weights a-f (FIG. 48B) and a y-axis with a percentage of the total available water distribution. The weights a-f are illustrated with percentages that assign an irrigation importance level to a particular depth. For example, weight “a” (at a depth of four inches) has been assigned a twenty-five percent weight. Weight “b” has been assigned a thirty-five percent weight and weight “c” has been assigned a forty percent weight. Weights d-f are weighted at zero. These weights may be set by a user (e.g., as input 4506 forming the weight_commands obtained by the HandleMoistureCommands service 230f of FIG. 45) or may be determined in other ways, including automatic modification over a period of time using soil moisture sensor information and other inputs representing the health and/or growth characteristics of the plant 4822.

With additional reference to FIG. 48D, which is not necessarily to scale, one embodiment of a chart 4840 illustrates readings by the three soil moisture sensors SM_1, SM_2, and SM_3. SM_4-SM_6 are not shown as they are weighted at zero. An x-axis represents time and a y-axis represents soil moisture levels in percentages. A high threshold 4842 is set at sixty-two percent soil moisture and a low threshold 4844 is set at fifty-five percent soil moisture. The trend line 4846 for SM_1 shows that the soil moisture level at four inches has decreased from approximately sixty-five percent to its current value of 57.3 percent. The trend line 4848 for SM_2 shows that the soil moisture level at eight inches has decreased from approximately sixty-two percent to its current value of 58.1 percent. The trend line 4850 for SM 3 shows that the soil moisture level has decreased from approximately fifty-eight percent to its current value of 56.2 percent. Each value is currently below the high threshold 4842 and above the low threshold 4844.

Returning to FIG. 48A, in step 4804, a weighted soil moisture (SM_{W}) value is calculated after the low threshold, soil moisture values, and weights are obtained in step 4802. For example, using the example of FIGS. 48B-48D, the weighted soil moisture value may be calculated as: a(SM_1)+b(SM_2)+c(SM_3)=0.25(57.3)+0.35(58.1)+0.40(56.2)=57.14. As the percentages for weights d-f are zero, SM_4-SM_6 are omitted from the calculations. This value may be calculated for each defined time period (e.g., six minute intervals) or may be calculated based on one or more other criteria, including a trigger event or a user instruction.

In step 4806, a slope is calculated based on past and/or current weighted soil moisture values. For example, linear regression may be performed on the last hour of weighted soil moisture values and that value may be multiplied by 0.01 to find the slope. It is understood that smoothing may occur in some embodiments. For example, if readings are taken every ten minutes and a soil moisture value is read twice in the single ten minute window, the two values may be averaged.

In step 4808, a delta value may be calculated using the weighted soil moisture value and the low threshold as: SM_{W}−T_{L}=delta=57.14−55=2.14 units. This means that the weighted soil moisture level is 2.14 units above the low threshold. The delta value may be rounded if desired (e.g., rounded to the nearest 0.1 or using another modifier). This represents the “need” or priority of the zone for which the calculations are being performed. A lower delta value indicates a greater need than a higher delta value because the SM_{W} value is closer to the low threshold with the lower delta value. This value may be calculated for each defined time period (e.g., six minute intervals) or may be calculated based on one or more other criteria, including a trigger event.

In step 4810, a zone level for use in ranking the zone relative to other zones may be calculated by combining the delta and the slope. For example, if the slope is equal to zero, the current delta value may be used as the zone level. If the slope does not equal zero, the zone level may be calculated as: delta value+(slope*modifier(M)), where M=1 or another desired modifier. In this example, the slope serves as a tiebreaker. More specifically, if multiple zones have the same delta value, the zone with the steepest slope will be ranked at the top in watering priority as this indicates that the zone's delta is decreasing at a greater rate than the other zones. In other embodiments, the delta values alone may be sufficient for ranking the zones and slopes may not be calculated or may be calculated and ignored.

In step 4812, the zones are ranked based on their delta values or on their combined slope/delta values. The smallest delta value is the highest priority, with ascending delta values corresponding to decreasing levels of priority. This may result in the computed_schedule published by the IrrigationModel_ZoneRanking service 230l of FIG. 45.

It is understood that the high threshold (T_{H}) may be used to determine whether a zone is included in the rankings. For example, if the zone's soil moisture level is above the high threshold, the zone likely does not need water. In relatively arid climates or in environments that require consistently high soil moisture levels, this may rarely happen and the high threshold may be ignored. However, as a safety measure to prevent overwatering, the high threshold may be used to determine whether the zone needs to be watered. In such embodiments, the zone may be removed from the ranking list after the ranking calculations are performed or the ranking calculations for the zone may be skipped entirely. This prevents a zone from being watered when it does not need water, thereby preventing possible damage to the crops and saving water.

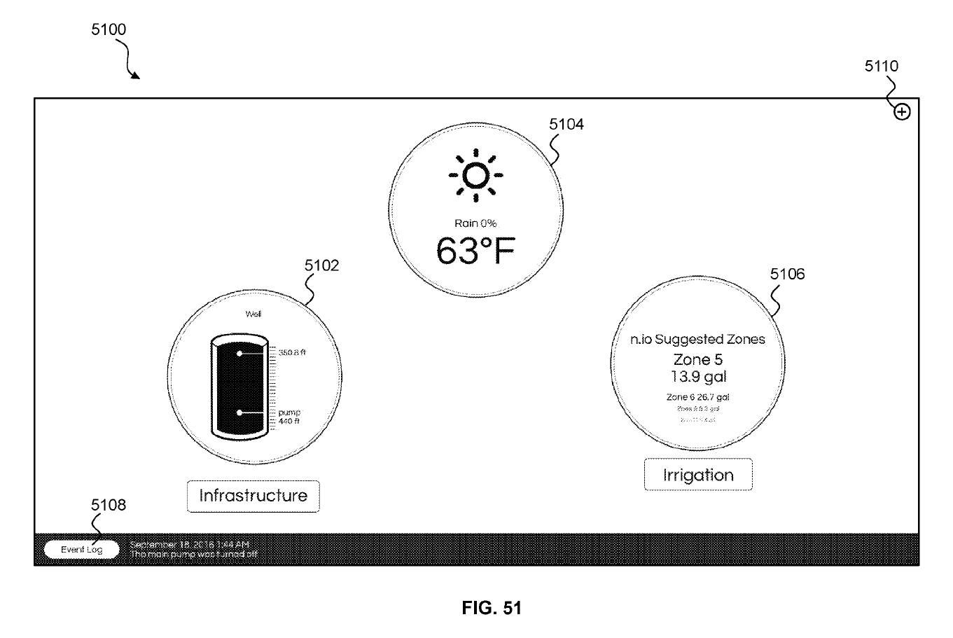

Referring to FIG. 49A, a method 4900 illustrates one embodiment of a process that is a more detailed example of steps 4702 and 4706 of FIG. 47. It may be desirable to calculate a volume of water (e.g., gallons/plant) needed to reach the user defined high threshold. This calculation may be performed for each defined time period (e.g., at ten minute intervals) or may be calculated based on one or more other criteria, including a trigger event or a user instruction. The calculated volume of water may then be delivered to the plant autonomously, according to a user defined schedule, or in response to manual actuation. If delivery is not automated, the user will know how much water needs to be delivered using the suggested volume.

Suggested volumes may also be useful in areas with water pressure fluctuations, as watering by duration may result in improper irrigation if the pressure dropped or spiked significantly while watering. Suggested volumes may also be used for future planning, which may be particularly useful in areas that rely on regulated access periods and/or volumes for water. For example, if water is being rationed by time and/or volume, the suggested volumes may be useful in identifying which crops to water and/or how to most efficiently use and/or distribute the available water.

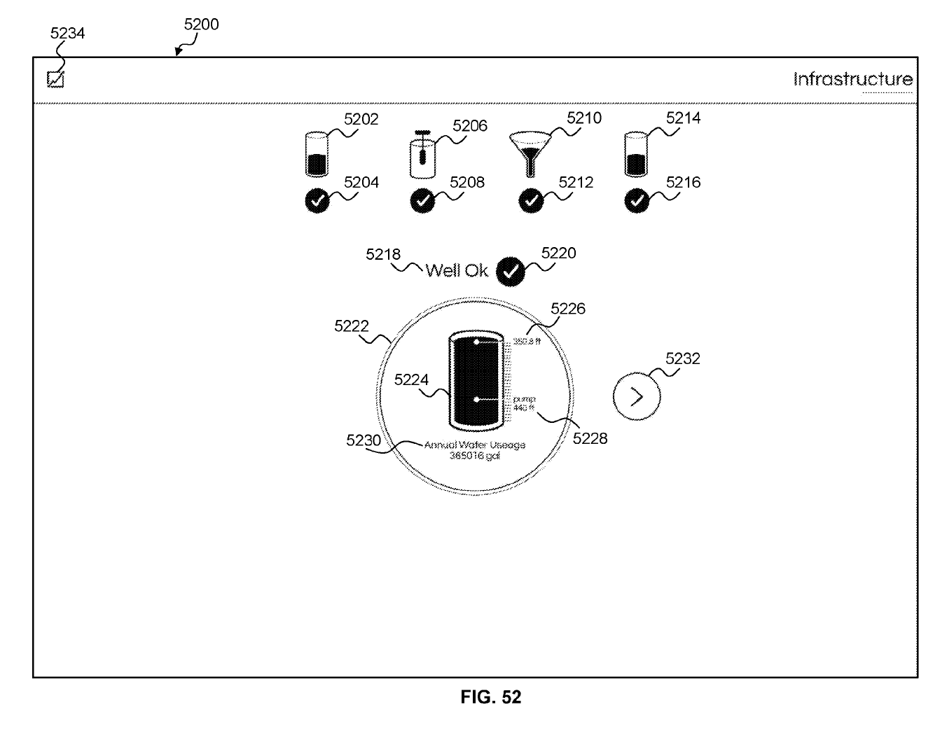

In order to make volume calculations, the method 4900 may use a weighted rate at which the soil absorbs the water (I_{W}) and the high threshold (T_{H}), which defines the desired weighted soil moisture level after the irrigation process has ended. The method 4900 is directed to determining the soil absorption rate and the method 5000 of FIG. 50 is directed to calculating the suggested volume based on the soil absorption rate determined by the method 4900 and the high threshold. For purposes of illustration, the previous example of FIGS. 48A-48D will be continued.

In step 4902, the starting soil moisture levels (e.g., before irrigation) are obtained at the relevant depths. These may have been previously obtained, such as in preparation for step 4802 of FIG. 48A, and step 4902 may be skipped if not needed.

In step 4904, the maximum soil moisture value at each relevant depth is measured after the irrigation event has ended. It is understood that the maximum moisture value per depth may be calculated at defined period of time (e.g., twelve hours after the end of each irrigation event for the zone) to aid in learning a relationship between the amount of water applied and the amount of water absorbed (and the depths at which it is absorbed) per zone. Due to differences in soil, temperature, relative humidity, weed levels, and other factors, this relationship may vary by zone and even within a zone during a growing season.

With additional reference to FIG. 49B, which is not necessarily to scale, one embodiment of a chart 4920 illustrates the three soil moisture sensors SM_1, SM_2, and SM_3. SM_4-SM_6 are not shown as they are weighted at zero. An x-axis represents time and a y-axis represents soil moisture levels in percentages. The high threshold 4842 is set at sixty-two percent soil moisture and the low threshold is set at fifty-five percent soil moisture. The trend lines 4922 for SM 1, 4924 for SM 2, and 4926 for SM 3 all show that the soil moisture percentages have increased.

Returning to FIG. 49A and with continued reference to FIG. 49B, in step 4906, a delta value is calculated between the starting and ending soil moisture values at each depth. For purposes of example, assume that the delta values are +7 for SM_1 (measured at point 1), +6 for SM_2 (measured at point 2), and +3 for SM_3 (measured at point 3). This is after an irrigation cycle of seven gallons per plant.

In step 4908, the absorption rate is calculated at each depth. For example, for each depth, the delta value may be divided by the volume of water delivered (e.g., seven gallons). Accordingly, the rate of absorption for SM_1 is delta/volume=7 units/7 gallons=1. The rate of absorption for SM_2 is delta/volume=6 units/7 gallons=approximately 0.857. The rate of absorption for SM_3 is delta/volume=3 units/7 gallons=approximately 0.429.

In step 4910, the weighted rate of absorption (I_{W}) is calculated using the defined weights of 0.25, 0.35, and 0.40 for SM_1, SM_2, and SM_3, respectively, as I_{W}=a(rate of absorption for SM_1)+b(rate of absorption for SM_2)+c(rate of absorption for SM_3). It is understood that steps 4908 and 4910 may be combined as follows: I_{W}=0.25(7/7 gal)+0.35(6/7 gal)+0.40(3/7 gal)=0.722 units/gallon. Accordingly, in this example, the weighted soil moisture value increases 0.722 units for every gallon that is applied to the plant.

Referring to FIG. 50, a method 5000 illustrates one embodiment of a process that is a more detailed example of steps 4702 and 4706 of FIG. 47. The method 5000 may be a continuation of the method 4900 of FIG. 49A as it determines a volume of water to be used in irrigation based on the weighted rate of absorption I_{W} calculated by the method 4900. For purposes of illustration, the previous example of FIGS. 48A-48D, 49A, and 49B will be continued.

In step 5002, the weighted soil moisture (SM_{W}) value is calculated. As this value may have already been calculated, this step may be skipped in some embodiments. In step S004, the high threshold (T_{H}) is obtained, which is sixty-two percent in the present example.

In step 5006, a deficit (D_{W}) is calculated. For example, the deficit may be calculated as deficit=T_{H}−SM_{W}=62.00−57.14=4.86.

In step 5008, a volume suggestion may be calculated based on the deficit and the rate of absorption for that zone. For example, the volume suggestion may be calculated as D_{W}/I_{W}=4.86/0.722=6.73 gallons. Accordingly, in this example, the volume suggestion is to irrigate at 6.73 gallons per plant in order to move the soil moisture level to the high threshold of sixty-two units. This calculation may be performed each time the zone's ranking calculation is performed (e.g., every ten minutes) and may be published to the socket.io server 3908 (FIG. 39) to be displayed by the GUI 3910.

In some embodiments, an additional step 5010 may be used to account for environmental conditions. This enables the method 5000 to account for additional information that may affect the soil moisture levels and/or plant moisture needs. For example, actual and/or predicted rainfall may be integrated into the model to reduce the suggested volume calculated in step 5008. If one inch of rain has just fallen, this may be used to calculate the impact of that rain on the soil moisture levels and reduce the suggested volume accordingly. Evaporation and/or transpiration may also be taken into account to more accurately model the watering needs and produce the volume suggestion. It is understood that these factors may be used in other calculations in FIGS. 47, 48A, 49A, and/or 50, and step 5010 may be omitted in such cases as the adjustments will have already been made to the irrigation model.

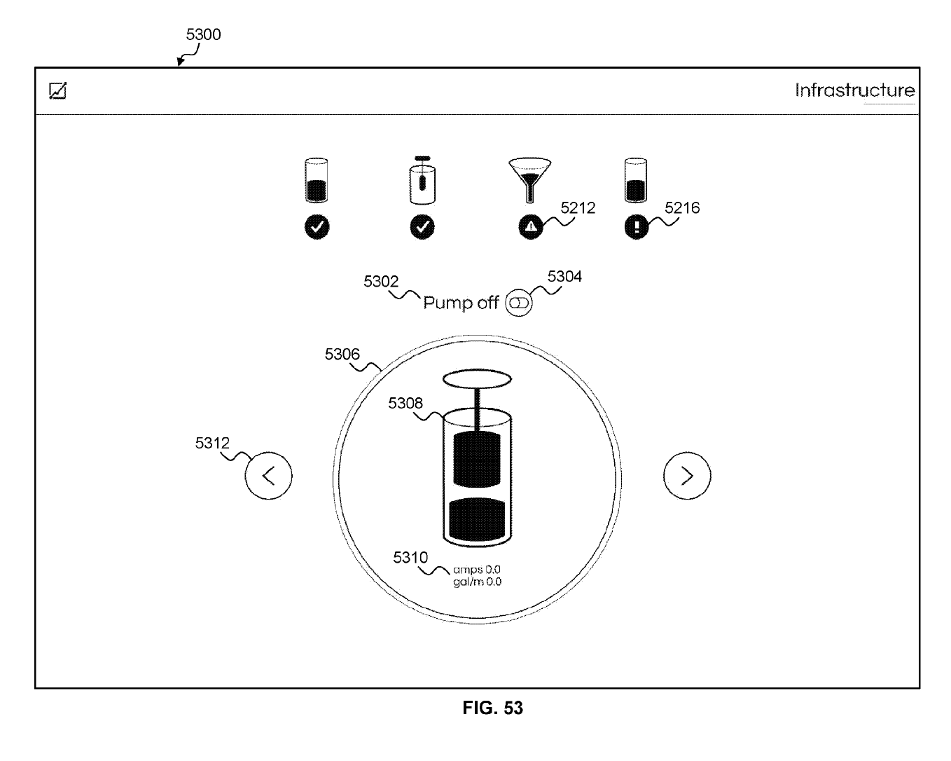

Referring to FIGS. 51-66, various embodiments of screens that may be used by the GUI 3910 (FIG. 39) are illustrated. The GUI 3910 may be used to interact with one or more NIO platforms in order to monitor and manage an agriculture system, which for purposes of example is a vineyard. In the present embodiment, the GUI 3910 receives information from, and may send information to, the socket.io server 3908 in order to interact with the NIO platform 402b on the manager node 3906. As described above, the NIO platform 402b may communicate with the NIO platform 402a, which enables the user to interact with the sensor hub node 3904. It is understood that the GUI 3910 may interact directly with one or more NIO platforms in some embodiments, and may be modified based on the design and configuration of the particular system being managed.

The screens illustrated in FIGS. 51-66 are configured for use with a vineyard. Accordingly, the screens are designed to provide information related to the vineyard and various components used to manage the vineyard, and to receive user input applicable to the vineyard in the form of instructions and/or annotations. It is understood that the particular information that is displayed by and input into the GUI 3910 may vary depending on the particular environment with which the GUI 3910 is configured to interact. Accordingly, different crops, zones, and even completely different environments (e.g., a manufacturing environment rather than an agricultural environment) may result in very different screens from those described below. However, the interactivity enabled by the GUI 3910, including the ability to overlay user annotations on the configurable environment provided by the NIO platforms, remains the same as that described with respect to FIGS. 51-66.

Referring specifically to FIG. 51, a screen 5100 illustrates an entry view or home page for the GUI 3910. The screen 5100 provides an overview of available information, including categories such as infrastructure 5102, weather 5104, and irrigation 5106. The information that is shown for each category may be modified, but for purposes of example provides current status, weather, and irrigation information. Each category 5102, 5104, and 5106 may be selected for a more detailed view of that particular category. An event log selector 5108 enables an event log to be opened. As shown, recent events may also be displayed on the screen 5100. Such information may include the time, date, and a description of the event. For example, the currently displayed event indicates that the main pump was turned off at 1:44 AM on Sep. 18, 2016. An annotation button 5110 enables a user to enter an annotation mode, which will be described in greater detail below.

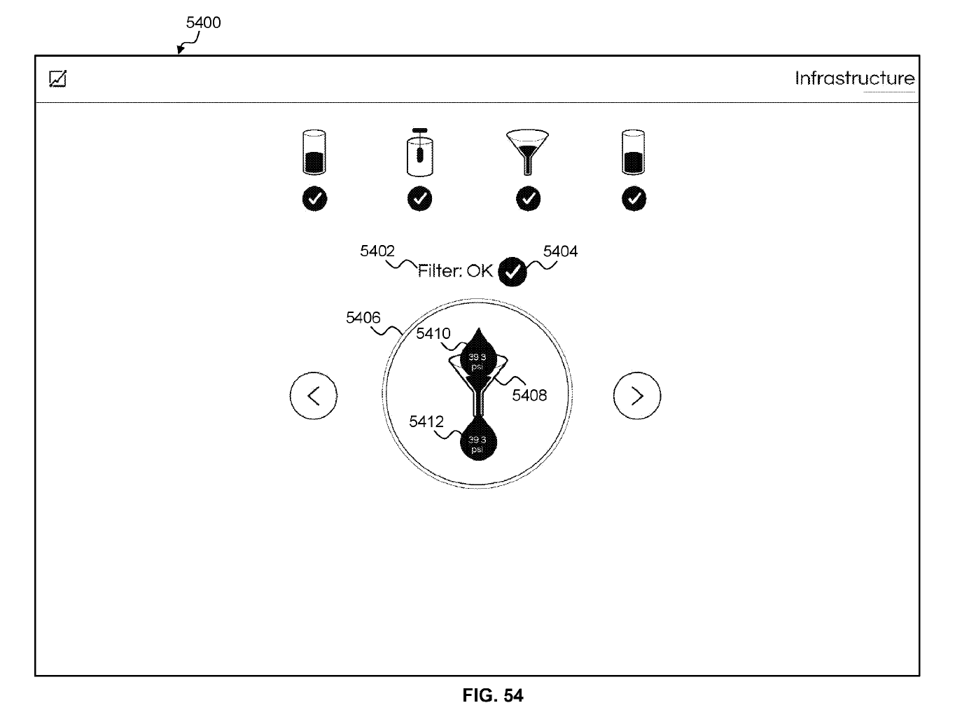

Referring specifically to FIG. 52, a screen 5200 illustrates an example of an infrastructure page and provides a status of a well that may be used to supply water to the vineyard. The screen 5200 includes multiple selectable icons for various infrastructure components, including a well icon 5202 and status indicator 5204, a pump icon 5206 and status indicator 5208, a filter icon 5210 and status indicator 5212, and a chemical (chem) tank icon 5214 and status indicator 5216. The status indicators 5204, 5208, 5212, and 5216 may change in real time or near real time as status information is received via the NIO platforms 402a and/or 402b.

In some embodiments, the status indicators may indicate current status information using colors and/or symbols. For example, the background color and/or symbol color may be green, yellow, or red to indicate normal operation, a warning state, or an error/failure state, respectively. In the present example, the background color (e.g., the color of the circle) of each status indicator 5204, 5208, 5212, and 5216 is green and the checkmark indicates normal operation.

As the screen 5200 is directed to the well, this is identified with text 5218 and a status indicator 5220. An area 5222 provides more detailed well information, including a visual indicator 5224 of the well's water level, a textual indicator 5226 of the well's current water level (e.g., “350.8 ft”), and an indicator 5228 of the pump's location (e.g., “440 ft”). Other information, such as annual water usage, may displayed as text 5230. A selectable button 5232 may be used to move to the next page in the infrastructure category or one of the icons 5202, 5206, 5210, or 5214 may be selected to move to a particular infrastructure component. A home button 5234 enables a user to return to the screen 5100.

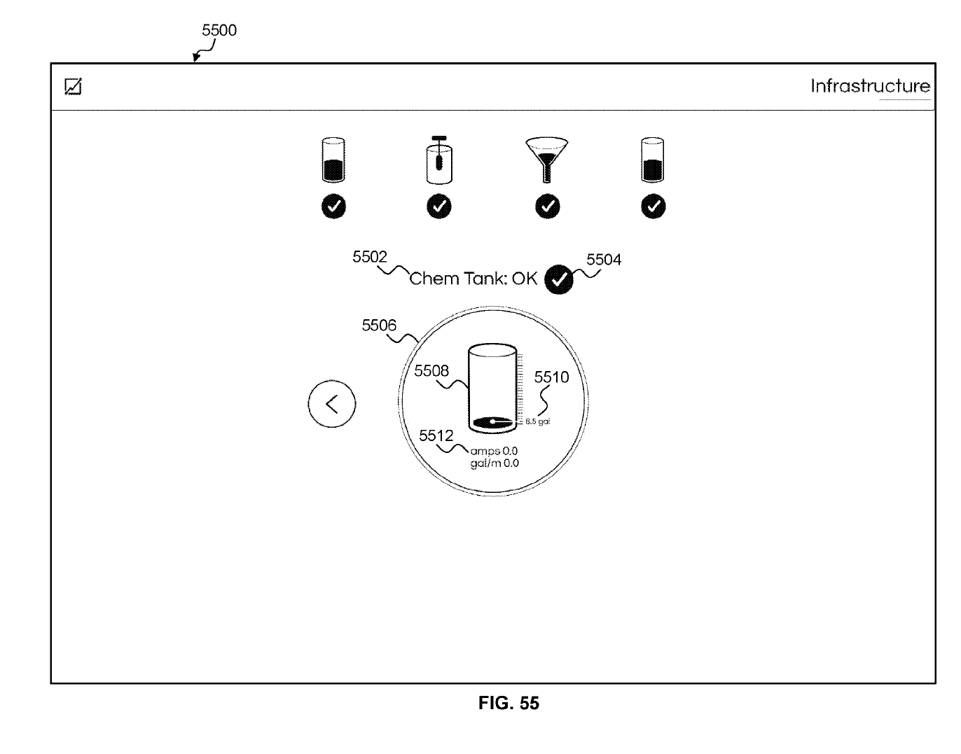

Referring specifically to FIG. 53, a screen 5300 illustrates a status of a pump that may be used to move water from the well of screen 5200 to the vineyard. For this and later examples, some reference numbers may not be repeated in each figure. The screen 5300 includes the previously described selectable icons for the various infrastructure components, the next page button, and the home button. As the screen 5300 is directed to the pump, this is identified with text 5302 and a status indicator 5304. An area 5306 provides more detailed pump information, including a visual indicator 5308 of the pump's status and other information, such as amperage and flow rate in gallons/minute, that may displayed as text 5310. A selectable button 5312 may be used to move to the previous page in the infrastructure category.

For purposes of illustration, the status indicators 5212 and 5216 are no longer the checkmark on a green field indicating a status of normal. Instead, the status indicator 5212 has changed to an exclamation point in a triangle on a red field to indicate an error or failure status, and the status indicator 5216 has changed to an exclamation point on a yellow field to indicate a warning status. It is understood that the design of the status indicators may vary and the illustrated status indicators are only examples. It is further understood that the screens 5200-5500 of FIGS. 52-55 will generally show the same status for each component, and the different statuses shown in FIG. 53 are simply to illustrate that the status indicators may change to visually indicate the status of their corresponding components.

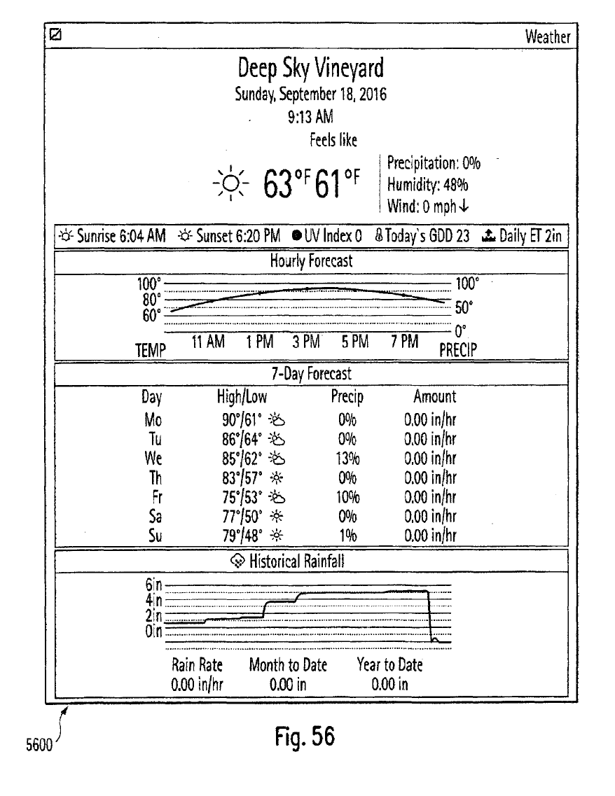

Referring specifically to FIG. 54, a screen 5400 illustrates a status of a filter that may be associated with the pump of screen 5300. The screen 5400 includes the previously described selectable icons for the various infrastructure components, the next page and previous page buttons, and the home button. As the screen 5400 is directed to the filter, this is identified with text 5402 and a status indicator 5404. An area 5406 provides more detailed filter information, including a visual indicator 5408 of the filter with the pre-filter pressure 5410 and the post-filter pressure 5412.

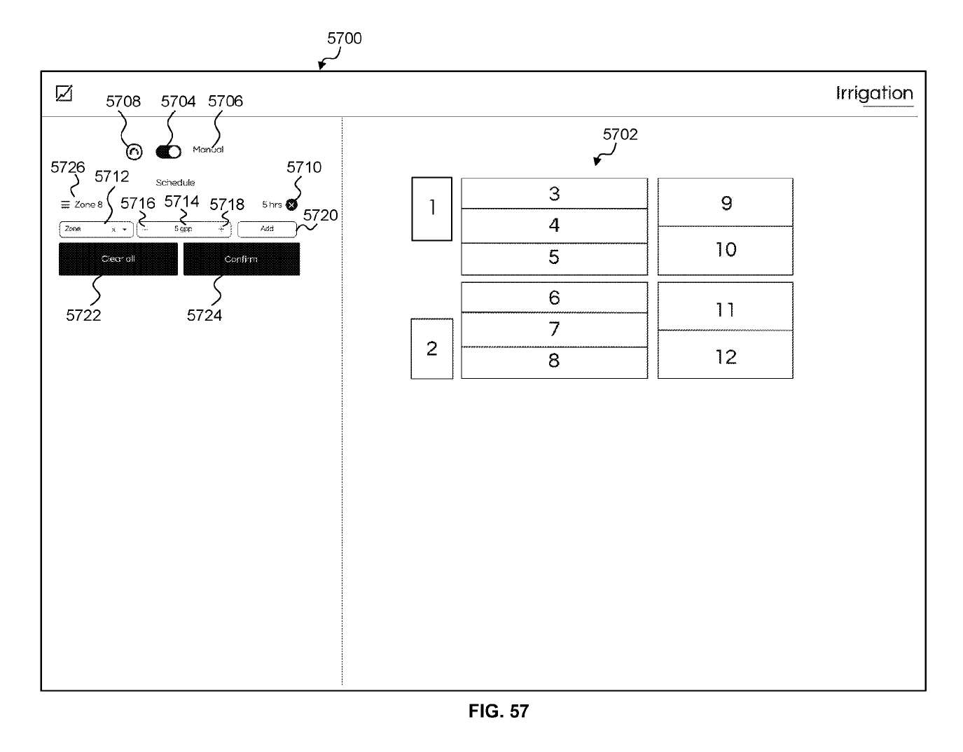

Referring specifically to FIG. 55, a screen 5500 illustrates a status of a chemical tank that may be used to provide various chemicals to the vineyard. The screen 5500 includes the previously described selectable icons for the various infrastructure components, the next page and previous page buttons, and the home button. As the screen 5500 is directed to the chemical tank, this is identified with text 5502 and a status indicator 5504. An area 5506 provides more detailed chemical tank information, including a visual indicator 5508 and a text indicator 5510 of the tank's current fluid level. Other information, such as amperage of a chemical tank pump and flow rate in gallons/minute, may displayed as text 5512.

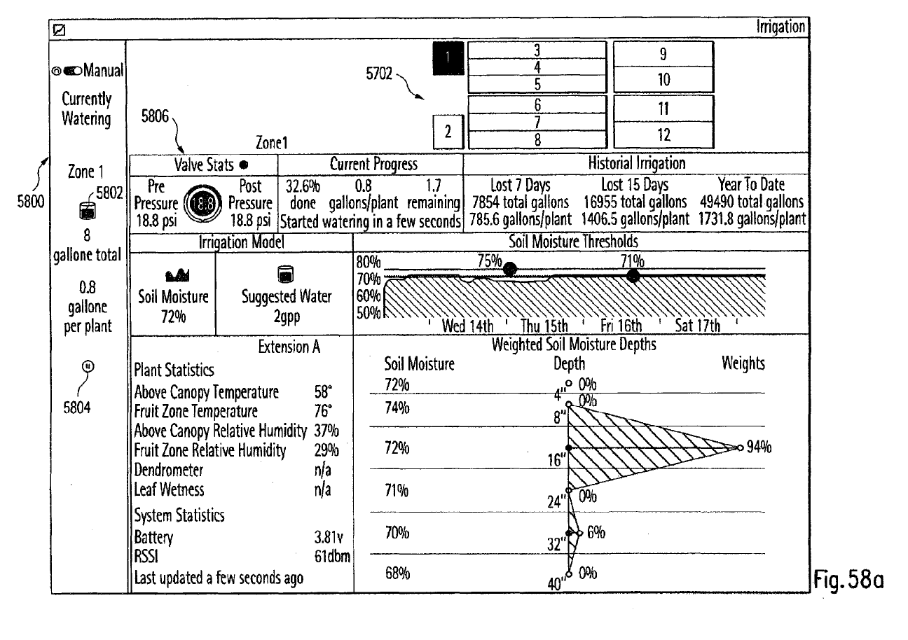

Referring specifically to FIG. 56, a screen 5600 illustrates information about various weather conditions, both current, historical, and forecasted. Such information may be useful in planning watering schedules and for calculating volume suggestions as described with respect to FIG. 50.

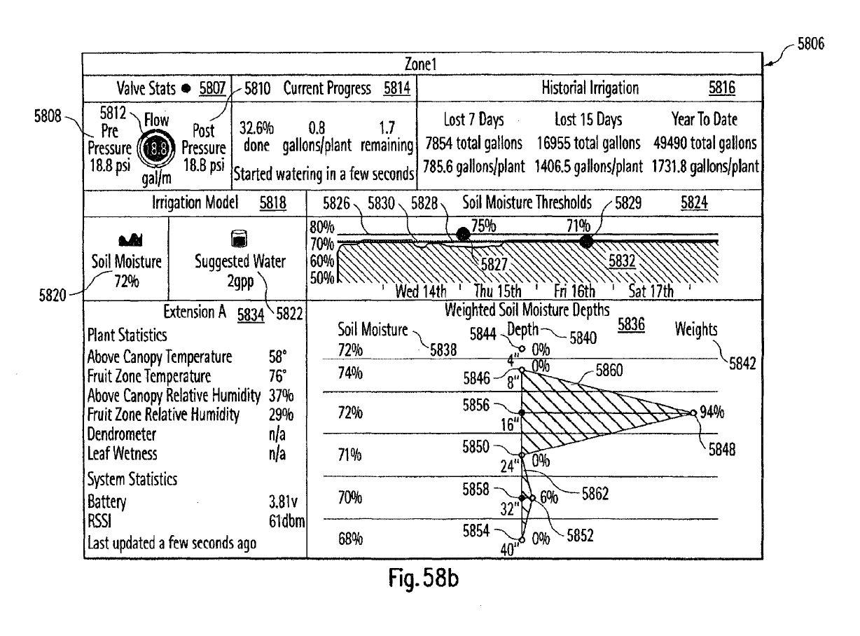

Referring specifically to FIG. 57, a screen 5700 illustrates a home page for the irrigation category 5106 of FIG. 51. In the present example, the screen 5700 provides a view 5702 of the vineyard with multiple zones identified as zone 1-zone 12. The view 5702 may be made using global positioning satellite (GPS) coordinates, with selectable zones overlaid on the view 5702 according to the particular layout of the vineyard. Although not shown, the vineyard may include various valves, irrigation lines, and other components as shown in FIG. 35 and described herein.

The screen 5700 includes a selectable toggle 5704 that enables a user to choose a manual watering schedule 5706 or a watering schedule 5708 managed by NIO platforms (e.g., as described with respect to FIG. 45). In manual mode, which is currently selected in screen 5700, zone 8 is scheduled to be watered. Watering can be assigned by duration (e.g., a defined period of time) or by volume (e.g., a defined number of gallons per zone or per plant). In the present example, the watering is assigned by volume and zone 8 is set to water at five gallons per plant (5 gpp). The current zone may be removed from the schedule by selecting a remove icon 5710 or by selecting a “Clear All” button 5722 that removes all scheduled zones and clears the schedule.

A zone selection box 5712 is provided to enable a user to select additional zones for the currently selected manual watering schedule. Added zones will appear under Zone 8 in the order that they are added (e.g., with the last added appearing at the bottom of the list). Once added, zones may be manually moved up or down in rank to adjust the order in which the selected zones are to be watered. For example, a selector 5726 enables a zone to be moved relative to other zones.

For each zone, a schedule type selector 5714 enables a user to select either a volume of water (e.g., gallons per plant) or a duration to be used for the zone identified in the zone selection box 5712. The schedule type selector 5714 may be provided as different selectors, or may be a single selector (as shown) that can be toggled between duration and volume by clicking on the selector itself. A decrement selector 5716 and an increment selector 5718 enable the schedule type (either duration or volume) to be incremented or decremented as desired. Once the appropriate zone, schedule type, and duration/volume have been selected, an “Add” button 5720 enables the zone to be added to the list.

The “Clear All” button 5722 removes all scheduled zones from the list, as opposed to the remove icon 5710 that removes only the currently displayed zone. A “Confirm” button 5724 confirms the schedule and instructs the system to begin watering.

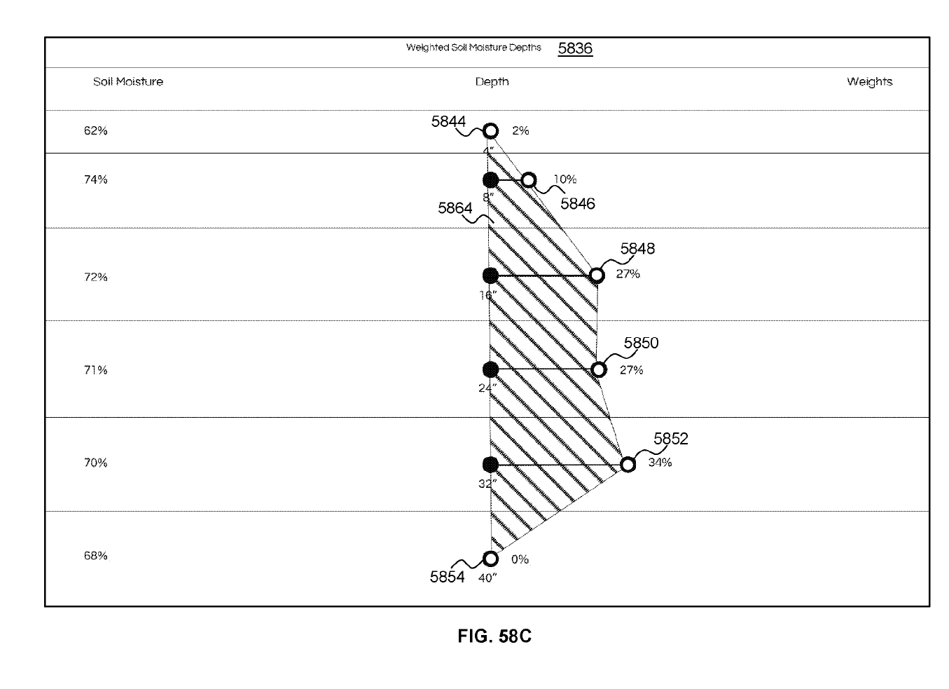

Referring specifically to FIG. 58A, a screen 5800 illustrates the irrigation view for a zone that has been selected from the view 5702. In the present example, zone 1 has been selected and is highlighted in the view 5702. Zone 1 is currently being watered based on a manual setting, with the current watering status 5802 showing that eight gallons have been distributed for 0.8 gallons per plant. A button or other selector 5804 enables a user to pause the current watering of zone 1. An information window 5806 provides additional information and allows a user to configure the watering schedule for zone 1 on the fly if desired.

With additional reference to FIG. 58B, an enlarged view of the information window 5806 is illustrated with various panes. A “Valve Stats” pane 5807 illustrates the pre-valve pressure 5808, post-valve pressure 5810, and flow rate 5812. The flow rate 5812 may visually change to indicate that there is currently water flowing through the valve. A “Current Progress” pane 5814 illustrates a percentage of completion (e.g., how much of the schedule has been completed), a current number of gallons per plant, and a remaining amount of gallons per plant. If the current schedule was based on duration rather than volume, the elapsed and remaining times would be shown instead of gallons per plant.

A “Historical Information” pane 5816 shows historical information for the zone. For example, a top row provides total gallons for the zone for the last seven days, last fifteen days, and year to date. The bottom row provides total gallons per plant for the same periods of time.

An “Irrigation Model” pane 5818 provides current soil moisture information 5820, which may be an average and/or weighted, and a suggested amount of water volume per plant 5822.

A “Soil Moisture Thresholds” pane 5824 includes a visual representation 5832 of the weighted soil moisture level plotted against an x-axis representing time and a y-axis representing percentage. A high threshold 5826 and a high threshold indicator 5827 and a low threshold 5828 and a low threshold indicator 5829 may be selected and moved by a user to adjust the desired high and low thresholds. These thresholds are used, for example, for the threshold_commands published by the HandleMoistureCommands service 230f of FIG. 45. A current weighted soil moisture level is indicated by dotted line 5830 and may vary based on the depth weights previously described with respect to FIG. 48B.

Data from one or more sensor extensions 3902 (FIG. 39) and/or the weather station may be viewed in “Extension” pane 5834. For example, “Above Canopy Temperature,” “Fruit Zone Temperature,” “Above Canopy Relative Humidity,” “Fruit Zone Relative Humidity,” “Dendrometer” data, and “Leaf Wetness” data may be provided. System statistics, such as current battery level and signal strength of the sensor extension may also be viewed.

A “Weighted Soil Moisture Depths” pane 5836 enables a user to view current depth weights and to adjust the weightings if desired. For example, this is one way in which a user may select the weights previously described with respect to FIG. 48C. In the present example, soil moisture 5838, depth 5840, and weights 5842 are shown. As described previously, soil moisture sensors may be distributed vertically to obtain soil moisture data from different depths, such as the four inches, eight inches, sixteen inches, twenty-four inches, thirty-two inches, and forty inches shown in pane 5836. The soil moisture 5838 is shown for a range around each of these depths. For example, the soil moisture at four inches is seventy-two percent and is visualized as ground level (e.g., zero depth) to six inches (e.g., halfway between four inches and the next depth of eight inches). The soil moisture at eight inches is seventy-four percent, and so on for each depth.

Each depth is associated with a corresponding selectable weight indicator that may be moved to adjust the weighting for that particular depth. Weight indicator 5844 corresponds to the four inch depth, weight indicator 5846 corresponds to the eight inch depth, weight indicator 5848 corresponds to the sixteen inch depth, weight indicator 5850 corresponds to the twenty-four inch depth, weight indicator 5852 corresponds to the thirty-two inch depth, and weight indicator 5854 corresponds to the forty inch depth. As one indicator is moved left or right to reduce or increase its weighting, respectively, the percentages of the other indicators are altered accordingly. In some embodiments, specific weights may be entered, rather than adjusted using the illustrated weight indicators. These weights are used, for example, for the weight commands published by the HandleMoistureCommands service 230f of FIG. 45.

For visualization purposes, one or more areas (shown by areas 5860 and 5862 in FIG. 58B) may graphically indicate the weighting of the selected depths. As can be seen by the size of the area 5860 relative to the size of the area 5862, most of the weighting is around the sixteen inch depth. The weight indicator 5848 may be moved to point 5856 and the weight indicator 5852 may be moved left to the point 5858 to reduce those weightings to zero, which will affect the size of the areas 5860 and 5862.

By adjusting the weight of a particular depth, the soil moisture at that depth can be made more or less important. For example, as the plant's roots grow downward throughout the season, the depths can be weighted to ensure that the proper amount of water is getting to the roots. In the present embodiment, the sixteen-inch depth is weighted at ninety-four percent and the thirty-two inch depth is weighted at six percent. The other depths are weighted at zero percent. This means that the soil moisture at sixteen inches is the most important, and the soil moisture at thirty-two inches is the next most important. The remaining depths are relatively insignificant in watering calculations.

With additional reference to FIG. 58C, the “Weighted Soil Moisture Depths” pane 5836 of FIG. 58B is illustrated after some of the weight indicators have been adjusted. More specifically, the weight indicator 5844 has been moved to two percent, the weight indicator 5846 has been moved to ten percent, the weight indicator 5848 has been moved to twenty-seven percent, the weight indicator 5850 has been moved to twenty-seven percent, the weight indicator 5852 has been moved to thirty-four percent, and the weight indicator 5854 remains at zero percent. This results in a single area 5864. This weight profile provides a more evenly distributed watering profile than the weight profile of FIG. 58B, as the soil moisture at every depth except forty inches receives some weight.

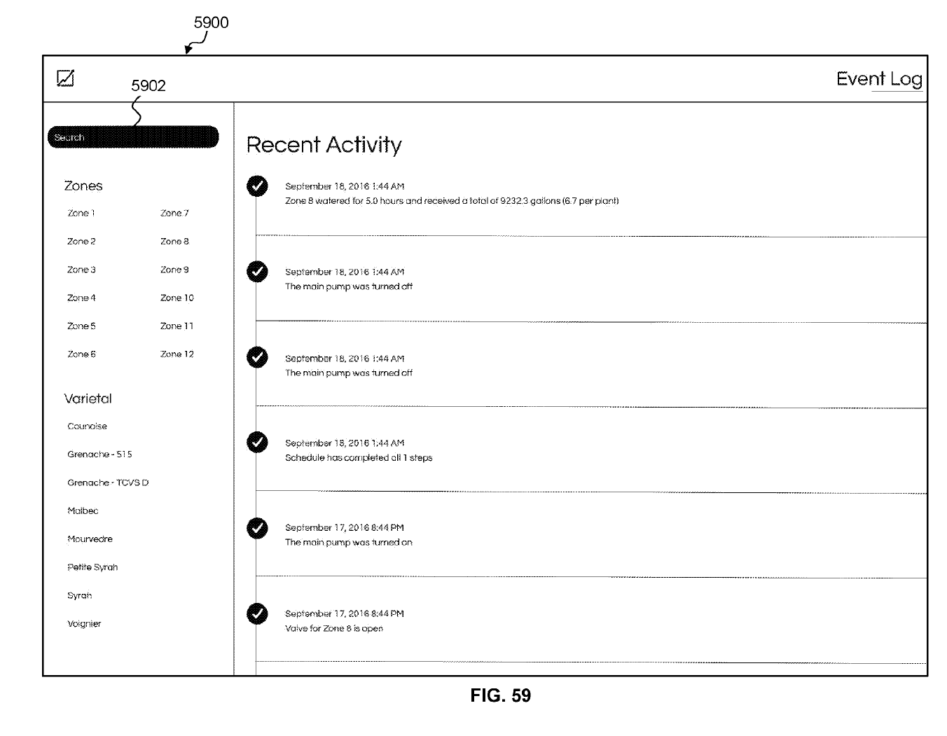

Referring specifically to FIG. 59, a screen 5900 illustrates the event log 5108 after selection. Recent activity is shown. The event log may be sorted by zone or using other criteria. In the present example of a vineyard, the event log may be sorted by varietal. A search box 5902 may also be used to locate particular information. The event log may be based on the output from the event log publisher 4308 of FIG. 43 and/or the event log publisher 4410 of FIG. 44D. It is noted that a status indicator may be associated with some or all of the events for a quick visual representation of whether the corresponding event was successful or is associated with a warning or error/failure.

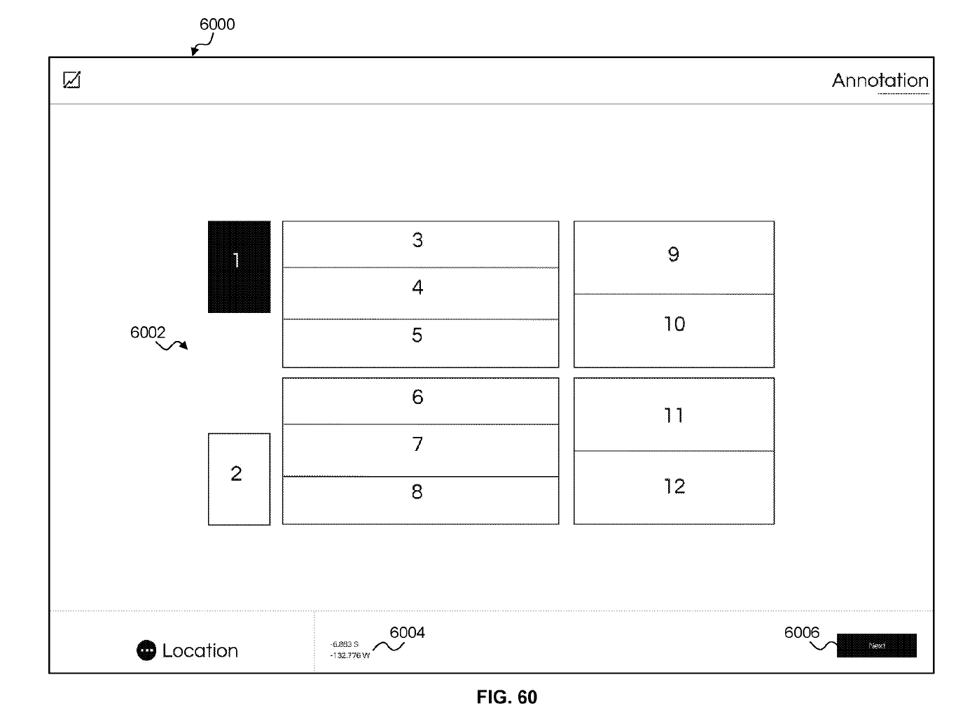

Referring specifically to FIG. 60, a screen 6000 illustrates a home page for annotation 5110. Annotation enables a user's experience, personal observations, and other “soft” inputs to be integrated with the hard data obtained via instrumentation and thereby affect the operation of the system 3900 in real time or near real time. The NIO platforms 402a and/or 402b may be configured to treat these soft inputs as specialized data and/or as any other data, which allows the system 3900 to be reconfigured in real time or near real time to account for factors that may be outside the scope of the data collected only by instrumentation.

The screen 6000 provides a view 6002 of the vineyard, which may be based on GPS coordinates. If a user is viewing the screen 6000 from a mobile device (e.g., a cell phone, a tablet, or a laptop) within the vineyard, the user's location may be displayed directly on the view 6002 and may be reflected in coordinates 6004. This may be used to automatically identify the user's location by zone, varietal, row number, and/or using other criteria. In the present example, no location is shown. A “Next” button 6006 is available for selection.

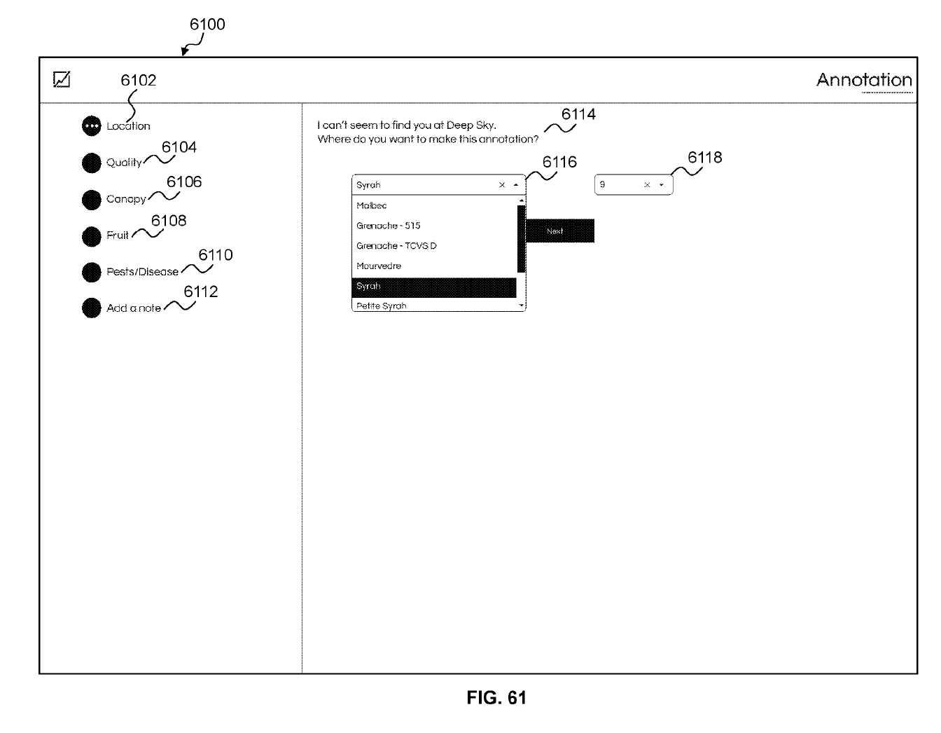

Referring specifically to FIG. 61, selection of the Next button 6006 on screen 6000 results in screen 6100. The screen 6100 provides a selectable menu identifying the current page as “Location” and other pages to which a user may navigate by making a desired selection. For purposes of illustration, the options include “Location” 6102, “Quality” 6104, “Canopy” 6106, “Fruit” 6108, “Pests/Disease” 6110, and “Add a note” 6112. In the present example, the screen 6100 indicates that the user's location in the vineyard was not found (“I can't seem to find you at Deep Sky” (e.g., the name of the vineyard) and asks the user to select a location for the current annotation using text 114. For purposes of example, the user selects the available varietal “Syrah” using menu 6116 and selects row 9 using menu 6118.

Menu items 6104-6112 indicate various annotation types and may visually indicate whether that annotation type has been completed using a checkmark or another indicator. In the present embodiment, three green dots inside the corresponding circle indicate the currently selected page, a solid circle with no symbol indicates a page that has not yet been completed, and a circle with a checkmark indicates a page that has been completed. It is understood that the menu items 6104-6112 may be selected in any order, and that menu items may be skipped entirely if desired.

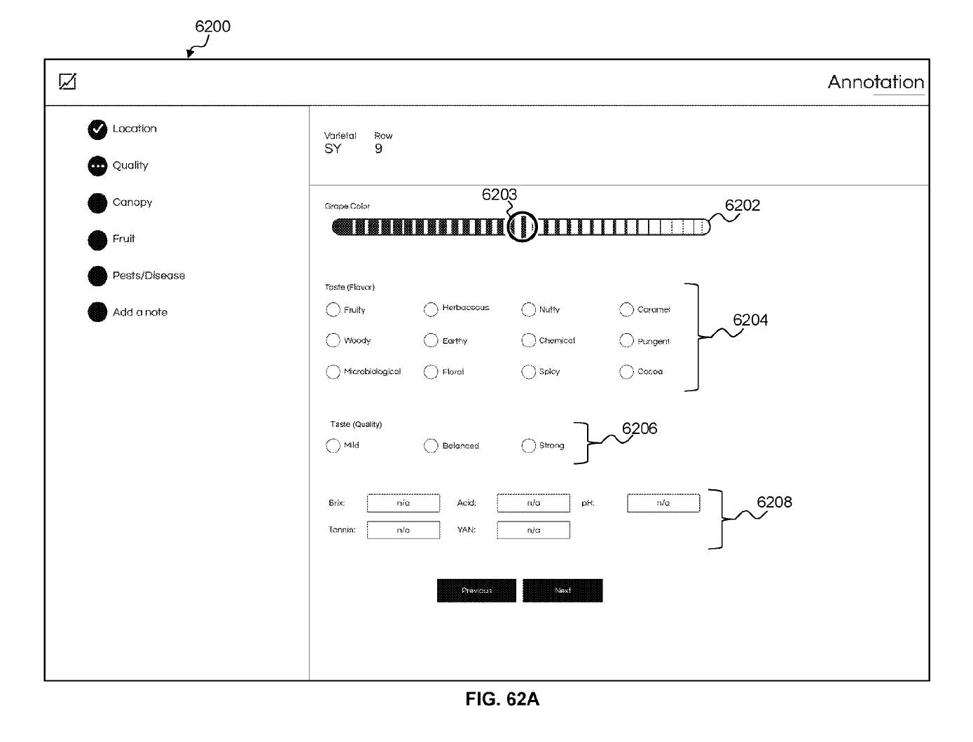

Referring specifically to FIG. 62A, selection of the Next button 6006 on screen 6100 results in screen 6200, which may also be selected using the “Quality” menu selection 6104. As selected on screen 6100, the indicated varietal type is “Sy” (Syrah) in row 9. A “Grape Color” selector 6202 is provided to enable a user to indicate a current color of the fruit. The selector 6202 may be provided as a slider as shown that enables a user to move along the slider with a button 6203. The colors and/or shades provided by the selector 6202 may match the particular varietal in its different stages of maturity, or may provide a wider range of colors/shades from which the user may select. “Taste (Flavor)” selections 6204 and “Taste (Quality)” selections 6206 may be used to indicate user taste results. Such selections may vary based on particular varietals, crops, or as otherwise needed. Additional selections 6208 may also be provided.

With additional reference to FIG. 62B, the screen 6200 of FIG. 62A is illustrated with the “Grape Color” selector 6202 having been selected. By maintaining actuation of the button 6203, the button may enlarge to more clearly show the color/shade currently being viewed. On mobile devices, some or all of the screen may be changed to the viewed color/shade. This enables a user to place a grape on or near the screen to better compare the color/shade being viewed with the color/shade of the grape itself. In other embodiments, a picture may be taken of the grape and manually or automatically compared to the available colors/shades.

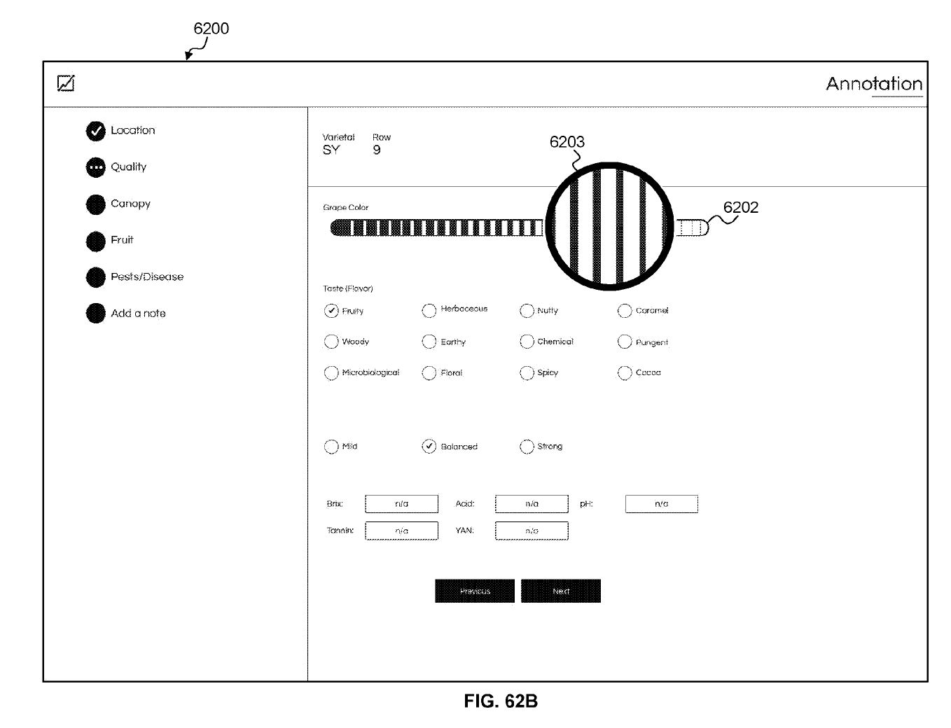

Referring specifically to FIG. 63, selection of the Next button 6006 on screen 6200 results in screen 6300, which may also be selected using the “Canopy” menu selection 6106. The screen 6300 enables a variety of selections to be made regarding the canopy. For example, selections may be made for “Leaf and in-canopy temperature,” “Evaluation of new shoot growth including internode lengths observed,” “Extent of wilting or dead leaves observed,” “Evaluation of the canopy's size to sufficiently finish the fruit,” and “Extent of lignification within the canopy.”

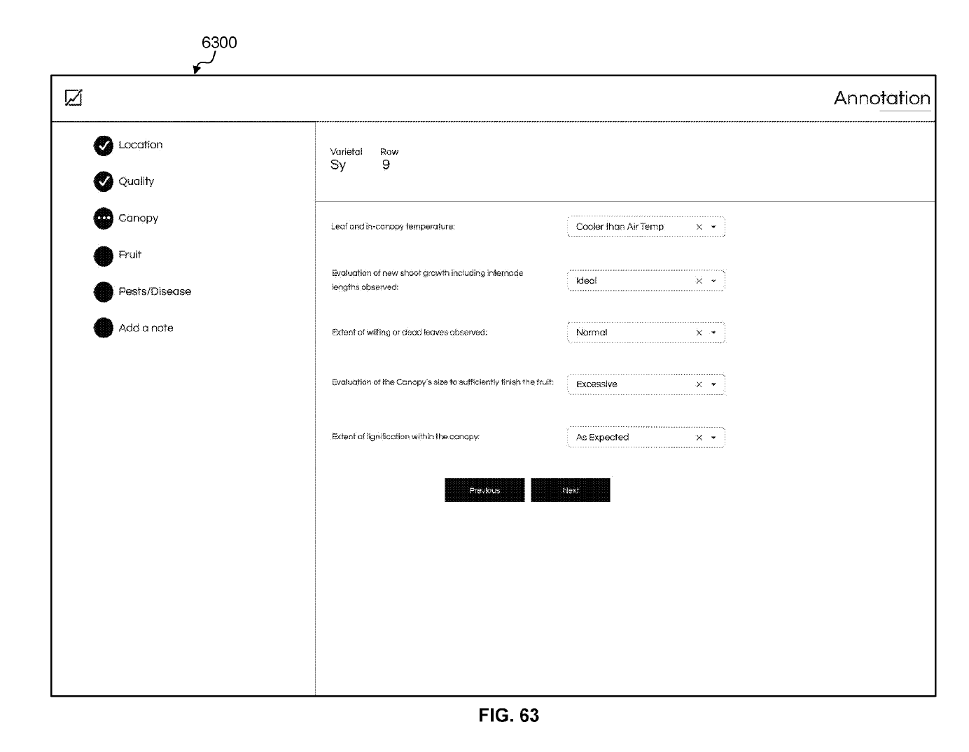

Referring specifically to FIG. 64, selection of the Next button 6006 on screen 6300 results in screen 6400, which may also be selected using the “Fruit” menu selection 6108. The screen 6400 enables a variety of selections to be made regarding the fruit.

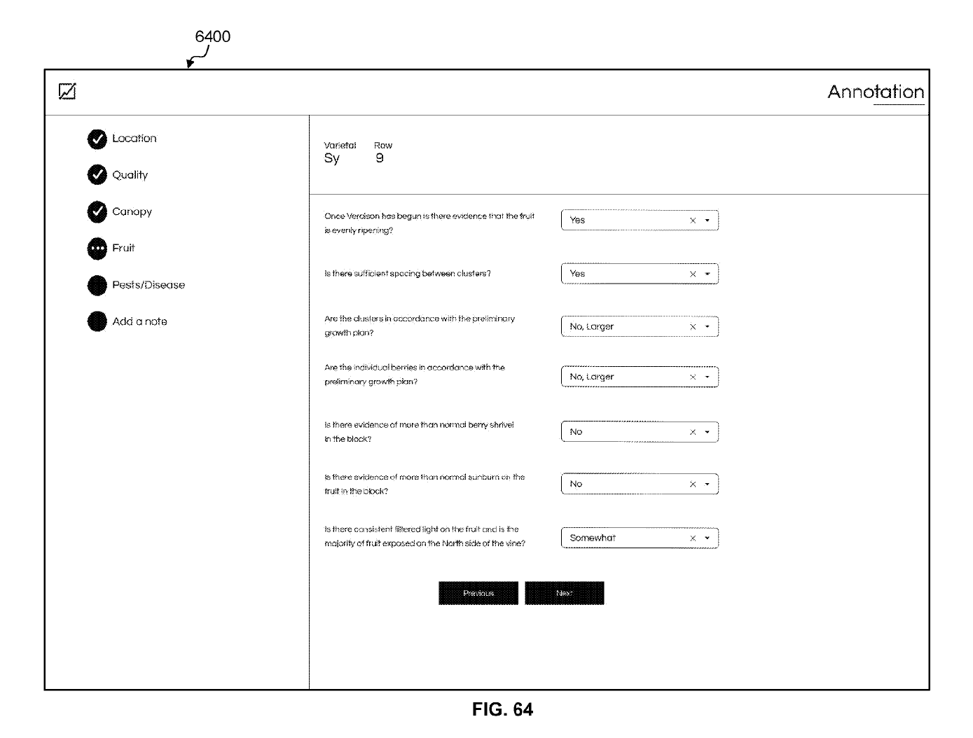

Referring specifically to FIG. 65, selection of the Next button 6006 on screen 6400 results in screen 6500, which may also be selected using the “Pests/Disease” menu selection 6110. The screen 6500 enables a variety of selections to be made regarding pests and/or disease.

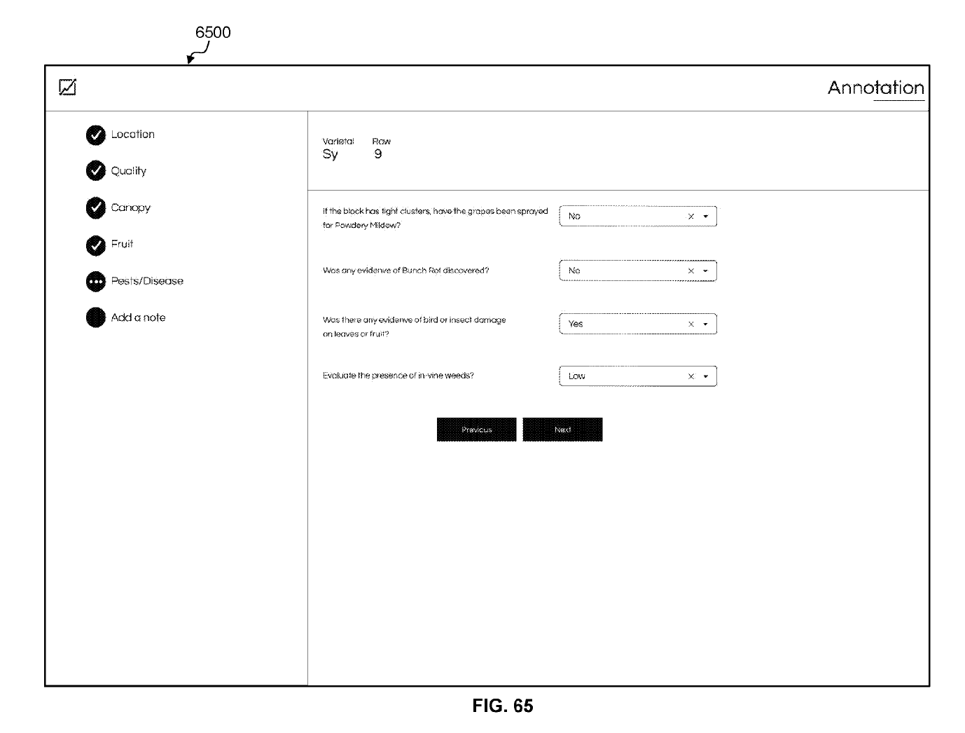

Referring specifically to FIG. 66, selection of the Next button 6006 on screen 6500 results in screen 6600, which may also be selected using the “Add a note” menu selection 6112. The screen 6600 enables a user to enter notes as desired. The notes may include text 6602 entered into a recording area 6604, video and/or still images 6606 (e.g., taken with the device being used to enter the annotations, such as a smart phone or tablet), attachments 6608 (e.g., videos, still images, audio files (including voice recordings), documents and/or other files), and/or drawings 6610 (e.g., entered via a touchscreen). These notes may be examined by the system 3900 (e.g., using artificial intelligence) to determine if they impact the configuration of the system 3900 and/or may be logged for later review. A “post” button 6612 may be used to enter the annotations into the system 3900. Although not shown, the post button may be included on each page if desired. In addition to being integrated with hard sensor data, the annotation information may also be posted to the event log for historical reference.

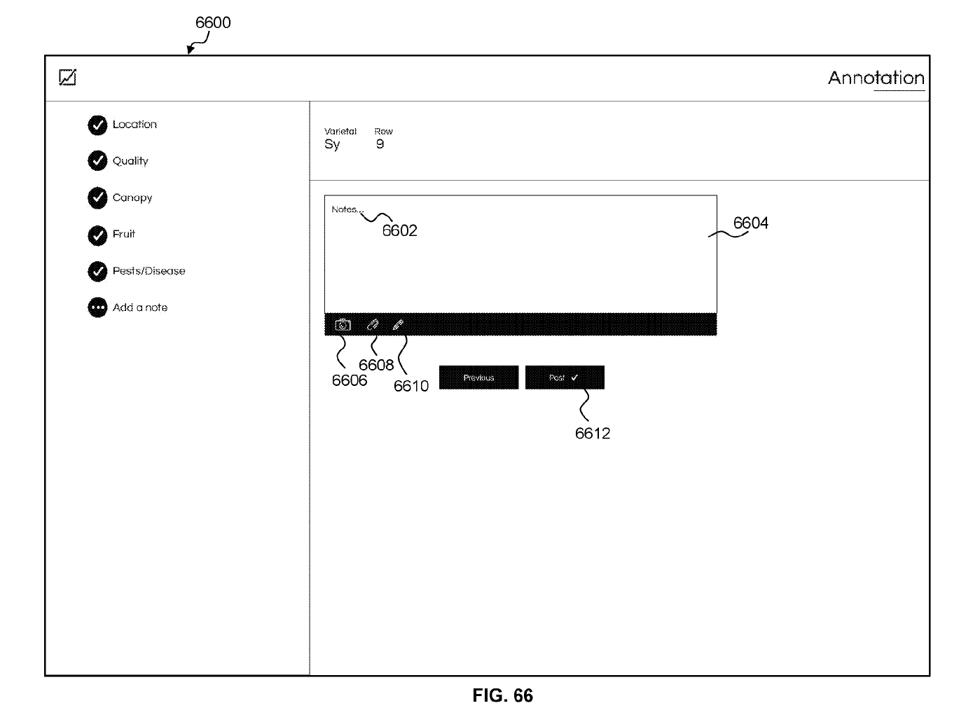

Referring to FIG. 67, a diagram 67 illustrates the use of “soft” inputs that may be integrated in real time or near real time with other inputs in a system such as the system of FIG. 39 or the system of FIG. 40. More specifically, the NIO platform architecture enables a single NIO platform or a system of NIO platforms to asynchronously combine human inputs 6704 with instrumentation inputs 6702 and process (6706) the inputs in order to affect machine decisions, actuations, and/or reconfigurations (6708) in real time or near real time.

This ability to asynchronously take in “soft” inputs (e.g., human observations, impressions, opinions, decisions, etc.) and “tune” (e.g., reconfigure) the behavior of NIO platform services and blocks on the fly either automatically (based on defined specifications) or through user configurable variables provides a level of user input that is otherwise missing in such systems. For example, without this soft input, the knowledge and “art” of a particular farmer may have no way of being incorporated into a management system responsible for the complex environment of a vineyard or farm. The issue with complex systems (such as those involved in raising crops) is that they are complex and therefore are very difficult to accurately reduce to a static set of rules that does not respond in real time or near real time to changing conditions. The ability to asynchronously accept user input alongside instrumentation input and dynamically tune a system in real time or near real time enables the system to deal with more complex situations than might otherwise be feasible.

In outdoor agricultural systems, temperature, rainfall, humidity, light intensity, crop type, soil type, water table level, and many other factors make it virtually impossible to accurately predict when a particular crop should be harvested. While harvest estimates are typically made and may even turn out to be accurate, such estimates may also vary drastically. For example, an October harvest may be planned for a particular type of grape in the vineyard. However, an unexpectedly heavy rainfall in a single day may move the harvest forward into mid-September. Such unexpected events generally require human intervention in the decision making process because humans are capable of providing “soft” inputs that are not currently possible for automated systems.

In another example, the root depth of interest for a particular crop may vary throughout the growing season. This means that the optimal irrigation depth at a given time in the growth cycle is dependent on many factors and generally cannot be accurately known in advance. Estimates may be used with some success, but only account for expected conditions and not actual conditions. The ability to tune the system based on “soft” observations about the growing season and current plant conditions is invaluable in optimizing the crop.

In yet another example, the health of a crop may be impossible for an automated system to determine. The presence of insects, mildew or other diseases that are often readily discernible to the human eye is still generally difficult or impossible for an automated system to detect in a large outdoor environment. The ability to tune the system to account for such human observations (e.g., by automating the delivery of pesticide or modifying a watering schedule based on the presence of mildew) is invaluable. Health may also be determined by viewing fruit and leaf conditions and colors, with soft inputs providing the ability to tune the delivery of water and fertilizer to address current health issues.

In yet another example, the best time to harvest a crop may be impossible for an automated system to determine. Continuing the use of the vineyard as an example, a farmer can use many different criteria to determine the ripeness and quality of a grape, including grape color and taste to determine when the crop is ready to harvest. By providing a platform that enables the farmer's soft inputs to impact the operation of the system, the quality of the harvest can be manage far better than can be accomplished by an automated system that does not provide for such soft inputs.

As illustrated with respect to the annotation screens of FIGS. 60-66, soft input may be prompted by user configurable questions. By answering such questions, a user can initiate notifications for possible user action or automated changes to processes. For example, assume that the question on the screen 6300 directed to “Evaluation of the canopy's size to sufficiently finish the fruit” is answered as “Excessive.” This may result in a notification suggesting that the canopy be trimmed at that location to reduce the canopy's size to normal. In another example, if there are too many weeds, a notification may suggest either weeding or changing the watering threshold since the weeds are taking up a certain percentage of the water being distributed. Other questions, such as whether there is mildew present, may result in automated changes to the watering schedule.

The questions presented and how those questions are answered may be fully configured by a user. Possible answers, as well as how those answers are addressed, enable a user to configure the system based on how much automation is available and the user's preferences for balancing automation and manual control. For example, if a zone cannot be automatically watered for some reason, the user can ensure that an automated response is not a solution for an irrigation issue in that zone. This flexibility not only enables soft inputs, but provides the tools for a user to adapt the application of those soft inputs to their particular needs.

Accordingly, the NIO platform architecture enables an automated system to be tuned using soft inputs in order to better respond to current or expected changes in conditions. Outdoor crops are sensitive to changes in temperature, moisture, and other weather conditions. Some manufacturing processes are sensitive to temperature and humidity. Other processes are sensitive to static electricity. Still other processes are sensitive to vibrations. By accepting soft inputs, any system can be tuned in real time or near time to account for virtually any possible variable that may impact that particular system and the tuning can be based on human experience and observations as well as more traditional instrumentation inputs. By enabling this type of “on the fly” tuning, the use of highly complex rule sets can be avoided. Machine learning may also be implemented to take advantage of both soft inputs and instrumentation inputs. This seamless overlaying of soft, non-traditional input on existing machine processes and instrumentation inputs provides an intuitive and highly flexible approach to handling complex systems.

One or more of the NIO platforms of FIG. 39 and/or FIG. 40 may also be configured to provide alerts and/or suggestions to a user, including the previously described notifications. Such alerts may be displayed via the UI 3910 and/or via email, text, and/or any other communication channel. For example, any of the information described herein, including system information, annotation based information, or a combination thereof may be used for alerts and/or suggestions. For example, if the well level drops below a certain threshold, an alert may be sent to notify a user of this. In another example, if grapes are tightly clustered (as indicated by annotation information) and a defined period of time has elapsed since the grapes were last sprayed for mildew and there is a greater than sixty-five percent chance of rain in forecast, then an alert may be sent suggesting that the grapes be sprayed for powdery mildew before the day it is forecast to rain. In another example, a frost warning may cause a NIO platform to turn on a frost fan and notify a user that this has been done. Accordingly, the system can be configured to send various alerts and/or to make suggestions based on single inputs or combinations of inputs.

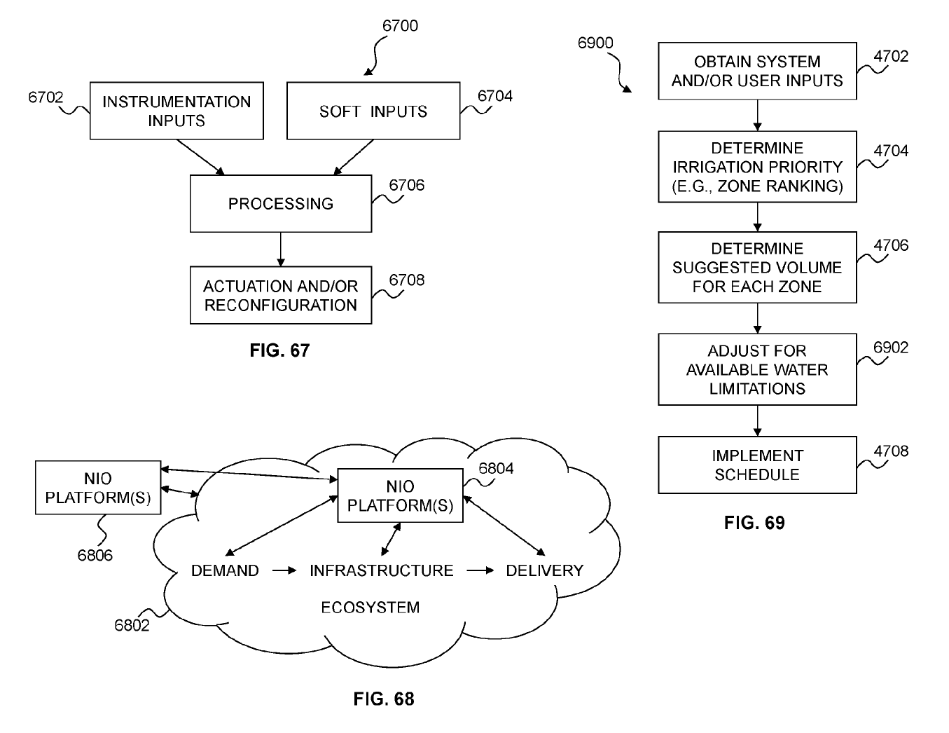

Referring to FIG. 68, one embodiment of an ecosystem 6802 is illustrated with one or more NIO platform(s) 6804 and/or 6806. As shown, one or more NIO platforms may be positioned within (e.g., as part of) the ecosystem 6802 and/or may be positioned outside of the ecosystem. The ecosystem 6802 may encompass some or all of a process by which demand is monitored and a delivery is fulfilled through an infrastructure. It is understood that the ecosystem 6802 may represent many different types of demand and delivery processes and infrastructures.

The use of a system formed by one or more NIO platforms and the configurable interaction of those NIO platforms with an environment enables the monitoring and control of an entire ecosystem 6802, such as the agricultural environment 3400 of FIGS. 34 and 35. By managing both demand and resource distribution within the ecosystem in real time or near real time, the system can ensure that a delivery (e.g., of water) within the ecosystem occurs efficiently and correctly, which in turn ensures that the purpose of the delivery is accomplished. Without such a system-wide view, occurrences in one part of the ecosystem may not be taken into account by other parts of the ecosystem. This may in turn negatively impact the delivery of water and/or other deliverables, which may then negatively impact the output of the ecosystem and/or cause waste that could be avoided.

For example, while traditional irrigation systems may deliver water in the environment 3400 of FIG. 35 using a timed watering schedule, such a system does not account for many possible variables that can impact the delivery of the water. Such variables include leaks in the irrigation system, lower or higher water pressure than expected, low aquifer (e.g., well) levels, relatively high particulate levels in the water that may negatively impact water delivery by clogging filters, and/or other factors that may significantly change the amount of water that is actually being delivered and, in some cases, may result in little or no water being delivered (e.g., if the well level is below the pump level). Accordingly, a purely time-based watering schedule does not generally account for the many variables of a complex ecosystem.

In contrast, the NIO platforms can be configured to monitor and control the ecosystem from end to end, which enables the system to efficiently manage the ecosystem. If an event occurs that is outside of the system's ability to correct (e.g., a water leak is detected due to an unexpected and localized drop in water pressure and the leak needs to be manually fixed), the system can notify a user. In some embodiments, the system can also attempt to remedy the situation if possible, such as by extending the watering period to account for the reduced pressure. Such an extension of the watering period can be accomplished accurately and without underwatering or overwatering because the system is able to calculate and monitor the volume of water needed and delivered, and so can continue watering until that volume has been delivered. To make such determinations, the system needs to be aware of information such as the status of the irrigation system and its components, the current water needs of each zone, the volume of water needed to satisfy the water needs of each zone, and/or similar information.

In another example, the system may determine that the aquifer level (e.g., the well level or the level of another available water supply) is too low to supply enough water for the current watering schedule and may modify the schedule based on one or more priorities. For example, the available water may be used to ensure that all zones receive some water or may be routed to one or more higher priority zones and not delivered at all to lower priority zones. To make such determinations and to calculate how to distribute the available water, the system need to be aware of information such as the well level, the current water needs of each zone, the volume of water needed to satisfy the water needs of each zone, and/or similar information. The system may even take into account the probability of future rainfall. For example, if the weather forecast predicts that one inch of rain will be received in the next twenty-four hours, the system may calculate the effect of such rainfall when determining how to distribute the available water. Different “risk” levels may be provided by a user and/or through machine learning or other automated processes to weight the possibility of rainfall when considered by the system. Anticipated temperatures, humidity, and other factors may also be taken into account.

The system may also proactively calculate when the available water in the well will be depleted based on historical, current, and/or anticipated watering schedules. Anticipated rainfall, temperatures, humidity, and other factors may also be taken into account when calculating future well depletion. For example, if the well typically replenishes at a known rate as long as rainfall satisfies certain criteria (e.g., if rainfall occurs at an expected volume per time period), this anticipated replenishment rate may be integrated into the calculations. Such proactive calculations enable the system to notify a user and/or take early action to regulate water use in anticipation of low well levels.

Other issues may be proactively managed by the system. For example, water quality may be monitored for particulate levels, the presence of chemicals, and/or other issues. For example, as the water level in the well drops, the water quality may decrease due to rising particulate counts. The rising particulate counts may result in clogged filters that reduce flow even after the well level has recovered. Accordingly, a user may be notified to check and/or clean the filters now instead of waiting on a scheduled maintenance date. The system may also monitor flow to determine whether the filters are clogged.

Such active and automated system responses are possible because the system has a system-wide view of the ecosystem, which is due to the level of monitoring and control that the NIO platforms can be configured to provide. By configuring the services run by the NIO platforms to monitor, manage, and/or control many different aspects of the ecosystem as described herein, the system can monitor demand, monitor and manage the infrastructure used to satisfy that demand, and manage the delivery of resources using that infrastructure as needed.

Referring to FIG. 69, a method 6900 illustrates another embodiment of the irrigation process of FIG. 47. Accordingly, like steps are numbered identically to those of FIG. 47. In the present example, in step 6902, the volume determined in step 4706 may be adjusted based on water availability (e.g., an aquifer level) as described with respect to FIG. 68. It is understood that such adjustments may be made as part of step 4706 and need not be a separate step as illustrated in FIG. 69. In some embodiments, such adjustments may be made after the schedule is implemented, with suggested volumes being recalculated as additional information is received and the schedule revised accordingly.

While the preceding description shows and describes one or more embodiments, it will be understood by those skilled in the art that various changes in form and detail may be made therein without departing from the spirit and scope of the present disclosure. For example, various steps illustrated within a particular flow chart may be combined or further divided. In addition, steps described in one diagram or flow chart may be incorporated into another diagram or flow chart. Furthermore, the described functionality may be provided by hardware and/or software, and may be distributed or combined into a single platform. The NIO platform architecture, including services and blocks, and/or any of the methods, sequence diagrams, and/or processes described herein may be embodied as instructions on a computer readable medium and distributed through physical media, by download, and/or provided as software as a service. Additionally, functionality described in a particular example may be achieved in a manner different than that illustrated, but is still encompassed within the present disclosure. Therefore, the claims should be interpreted in a broad manner, consistent with the present disclosure.

For example, in addition to the claimed embodiments in the appended claims, the following is a list of embodiments which may serve as the basis for additional claims in this application or subsequent divisional applications:

### Embodiment 1

A system comprising at least a first configurable platform configured to run on a first device positioned at a geographic location; a plurality of services configured to run on the at least first configurable platform, wherein each service provides a mini runtime environment for a plurality of blocks that provide specific functionality to the service, and wherein the services are configured to obtain a current soil moisture level for a plurality of zones at the geographic location, wherein each of the zones has been assigned a desired minimum soil moisture level; rank the zones in a watering schedule based on a delta between the current soil moisture level and the desired minimum soil moisture level of each zone, wherein water will be delivered to each of the zones in an order based on the zone's ranking in the watering schedule; and for each zone, in the order based on the zone's ranking, open at least one valve to deliver water to the zone, and close the at least one valve after watering of the zone is completed.

### Embodiment 1+1

The system of embodiment 1 wherein the services are further configured to close the at least one valve based on either an expiration of a defined time period or when a defined volume of water has been delivered to the zone.

### Embodiment 1+2

The system of embodiment 1 wherein the services are further configured to monitor the delivery of water to at least one of the zones to determine when a defined volume of water has been delivered to the zone; and close the at least one valve when the volume of water has been delivered to the zone.

### Embodiment 1+3

The system of embodiment 1+2 wherein the services are further configured to, for each of the zones where the current soil moisture level is below the desired minimum soil moisture level, calculate the volume of water needed to raise the current soil moisture level to the desired minimum soil moisture level.

### Embodiment 1+4

The system of embodiment 1+3 wherein the services are configured to calculate the volume of water on a per zone basis.

### Embodiment 1+5

The system of embodiment 1+3 wherein the services are configured to calculate the volume of water on a per plant basis for at least some plants in the zone.

### Embodiment 1+6

The system of embodiment 1+3 wherein the services are further configured to account for rainfall when calculating the volume of water.

### Embodiment 1+7

The system of embodiment 1+3 wherein the services are further configured to account for a water level of a well from which the water is obtained when calculating the volume of water.

### Embodiment 1+8

The system of embodiment 1+7 wherein the services are further configured to reduce the calculated volume of water if the level of water is below a defined threshold.

### Embodiment 1+9

The system of embodiment 1+8 wherein the services are further configured to reduce the calculated volume of water only if the zone for which the volume of water is being calculated is not marked to receive the entire volume of water.

### Embodiment 1+10

The system of any one of embodiments 1+1 through 1+9 wherein the services are configured to calculate the volume of water by: identifying a post-irrigation soil moisture level after at least one irrigation event; calculating a delta between the current soil moisture level and the post-irrigation soil moisture level; calculating an irrigation absorption rate; calculating a water deficit between the post-irrigation soil moisture level and the current soil moisture level; and calculating the volume of water based on the water deficit and the irrigation absorption rate.

### Embodiment 1+11

The system of embodiment 1+10 wherein the services are further configured to recalculate the irrigation absorption rate following each irrigation event, wherein historical irrigation information is combined with information from the most recent irrigation event to increase an accuracy of the irrigation absorption rate.

### Embodiment 1+12

The system of embodiment 1+10 wherein the services are further configured to wait for a defined period of time after the at least one irrigation event before calculating the irrigation absorption rate.

### Embodiment 1+13

The system of any one of embodiments 1 through 1+12 wherein the services are further configured to, for each of the zones, determine if the current soil moisture level is above a desired maximum soil moisture level; and if the current soil moisture level is above the desired maximum soil moisture level, remove the zone from the watering schedule.

### Embodiment 1+14

The system of any one of embodiments 1 through 1+12 wherein the services are configured to, for each of the zones, determine if the current soil moisture level is above a desired maximum soil moisture level; and if the current soil moisture level is above the desired maximum soil moisture level, not calculating the rank for the zone.

### Embodiment 1+15

The system of any one of embodiments 1 through 1+14 wherein the services are further configured to determine if a main well pump is on when one of the zones is to be watered; and turn the main well pump on if the main well pump is off.

### Embodiment 1+16

The system of any one of embodiments 1 through 1+15 wherein the services are configured to obtain the current soil moisture level for each zone by asynchronously receiving sensor data from a plurality of sensors in each of the zones.

### Embodiment 1+17

The system of embodiment 17 wherein the services are further configured to calculate a weighted soil moisture level for each zone based on the sensor data.

### Embodiment 1+18

The system of any one of embodiments 1 through 1+17 wherein the services are further configured to receive user input modifying the desired minimum soil moisture level for a first zone of the zones and to recalculate the ranking for the first zone based on the modified desired minimum soil moisture level.

### Embodiment 1+19

The system of any one of embodiments 1 through 1+18 wherein the services are further configured to monitor a valve in an irrigation system supplying water to the zone being watered.

### Embodiment 1+20

The system of any one of embodiments 1 through 1+19 wherein the services are further configured to monitor a filter in the irrigation system.

### Embodiment 1+21

The system of any one of embodiments 1 through 1+20 further comprising a second configurable platform positioned at the geographic location and coupled to the first configurable platform, wherein the second configurable platform is configured to obtain sensor data for at least a first zone of the plurality of zones and to send the sensor data to the first configurable platform.

### Embodiment 1+22

The system of any one of embodiments 1 through 1+20 further comprising a second configurable platform configured to run on a second device positioned at the geographic location, wherein the services are distributed between the first configurable platform and the second configurable platform.

### Embodiment 1+23

The system of any one of embodiments 1 through 1+22 further comprising a socket.io server coupled to the first configurable platform, wherein the socket.io server is used to provide a user interface that enables a user to interact with at least some of the services.

### Embodiment 1+24

The system of embodiment 24 wherein the user interface enables a user to enter at least one soft input into the system that is used by at least one of the services, wherein the soft input enables the user to enter observational information that is not otherwise available to the system.

### Embodiment 2

A method comprising obtaining a current soil moisture level for a plurality of zones at a geographic location, wherein each of the zones has been assigned a desired minimum soil moisture level; ranking the zones in a watering schedule based on a delta between the current soil moisture level and the desired minimum soil moisture level of each zone, wherein water will be delivered to each of the zones in an order based on the zone's ranking in the watering schedule; and for each zone, in the order based on the zone's ranking, opening at least one valve to deliver water to the zone, and closing the at least one valve after watering of the zone is completed.

### Embodiment 2+1

The method of embodiment 2 further comprising closing the at least one valve based on either an expiration of a defined time period or when a defined volume of water has been delivered to the zone.

### Embodiment 2+2

The method of embodiment 2 further comprising monitoring the delivery of water to at least one of the zones to determine when a defined volume of water has been delivered to the zone; and closing the at least one valve when the volume of water has been delivered to the zone.

### Embodiment 2+3

The method of embodiment 2+2 further comprising, for each of the zones where the current soil moisture level is below the desired minimum soil moisture level, calculating the volume of water needed to raise the current soil moisture level to the desired minimum soil moisture level.

### Embodiment 2+4

The method of embodiment 2+3 wherein the volume of water is calculated on a per zone basis.

### Embodiment 2+5

The method of embodiment 2+3 wherein the volume of water is calculated on a per plant basis for at least some plants in the zone.

### Embodiment 2+6

The method of embodiment 2+3 further comprising accounting for rainfall when calculating the volume of water.

### Embodiment 2+7

The method of embodiment 2+3 further comprising accounting for a water level of a well from which the water is obtained when calculating the volume of water.

### Embodiment 2+8

The method of embodiment 2+7 further comprising reducing the calculated volume of water if the level of water is below a defined threshold.

### Embodiment 2+9

The method of claim 2+8 further comprising reducing the calculated volume of water only if the zone for which the volume of water is being calculated is not marked to receive the entire volume of water.

### Embodiment 2+10

The method of any one of embodiments 2+1 through 2+9 wherein the volume of water is calculated by identifying a post-irrigation soil moisture level after at least one irrigation event; calculating a delta between the current soil moisture level and the post-irrigation soil moisture level; calculating an irrigation absorption rate; calculating a water deficit between the post-irrigation soil moisture level and the current soil moisture level; and calculating the volume of water based on the water deficit and the irrigation absorption rate.

### Embodiment 2+11

The method of embodiment 2+10 further comprising recalculating the irrigation absorption rate following each irrigation event, wherein historical irrigation information is combined with information from the most recent irrigation event to increase an accuracy of the irrigation absorption rate.

### Embodiment 2+12

The method of embodiment 2+10 further comprising waiting for a defined period of time after the at least one irrigation event before calculating the irrigation absorption rate.

### Embodiment 2+13

The method of any one of embodiments 2 through 2+12 further comprising, for each of the zones, determining if the current soil moisture level is above a desired maximum soil moisture level; and if the current soil moisture level is above the desired maximum soil moisture level, removing the zone from the watering schedule.

### Embodiment 2+14

The method of any one of embodiments 2 through 2+12 further comprising, for each of the zones, determining if the current soil moisture level is above a desired maximum soil moisture level; and if the current soil moisture level is above the desired maximum soil moisture level, not calculating the rank for the zone.

### Embodiment 2+15

The method of any one of embodiments 2 through 2+14 further comprising determining if a main well pump is on when one of the zones is to be watered; and turning the main well pump on if the main well pump is off.

### Embodiment 2+16

The method of any one of embodiments 2 through 2+15 wherein the current soil moisture level for each zone is obtained by asynchronously receiving sensor data from a plurality of sensors in each of the zones.

### Embodiment 2+17

The method of embodiment 2+16 further comprising calculating a weighted soil moisture level for each zone based on the sensor data.

### Embodiment 2+18

The method of any one of embodiments 2 through 2+17 further comprising receiving user input modifying the desired minimum soil moisture level for a first zone of the zones and recalculating the ranking for the first zone based on the modified desired minimum soil moisture level.

### Embodiment 2+19

The method of any one of embodiments 2 through 2+18 further comprising monitoring a valve in an irrigation system supplying water to the zone being watered.

### Embodiment 2+20

The method of any one of embodiments 2 through 2+19 further comprising monitoring a filter in the irrigation system.

### Embodiment 2+21

The method of any one of embodiments 2 through 2+20 further comprising receiving, via a user interface, at least one soft input from a user, wherein the soft input enables the user to enter observational information that is not otherwise available.

### Embodiment 3

A system comprising at least a first configurable platform configured to run on a first device positioned at a geographic location; a plurality of services configured to run on the at least first configurable platform, wherein each service provides a mini runtime environment for a plurality of blocks that provide specific functionality to the service, and wherein the services are configured to obtain a current soil moisture level for at least one zone at the geographic location, wherein the zone has been assigned a desired minimum soil moisture level; determine if the current soil moisture level is above a desired maximum soil moisture level, wherein the zone will only be watered if the current soil moisture level is below the desired maximum soil moisture level; and if the zone is to be watered, determine a volume of water needed to raise the current soil moisture level to the desired minimum soil moisture level.

### Embodiment 4

A method comprising obtaining a current soil moisture level for at least one zone at the geographic location, wherein the zone has been assigned a desired minimum soil moisture level; determining if the current soil moisture level is above a desired maximum soil moisture level, wherein the zone will only be watered if the current soil moisture level is below the desired maximum soil moisture level; and if the zone is to be watered, determining a volume of water needed to raise the current soil moisture level to the desired minimum soil moisture level.

### Embodiment 5

A system comprising at least a first configurable platform configured to run on a first device positioned at a geographic location; a plurality of services configured to run on the at least first configurable platform, wherein each service provides a mini runtime environment for a plurality of blocks that provide specific functionality to the service, and wherein the services are configured to obtain a current soil moisture level for at least one zone at the geographic location, wherein the zone has been assigned a desired minimum soil moisture level; determine if the zone needs to be watered based on the current soil moisture level relative to the desired minimum soil moisture level; and if the zone is to be watered, determine a volume of water needed to raise the current soil moisture level to the desired minimum soil moisture level.

### Embodiment 5+1

The system of embodiment 5 wherein the services are configured to determine the volume of water on a per zone basis.

### Embodiment 5+2

The system of embodiment 5 wherein the services are configured to determine the volume of water on a per plant basis for at least some plants in the zone.

### Embodiment 5+3

The system of any of embodiments 5 through 5+2 wherein the services are further configured to account for rainfall when determining the volume of water.

### Embodiment 5+4

The system of any of embodiments 5 through 5+3 wherein the services are further configured to account for a water level of a well from which the water is obtained when determining the volume of water.

### Embodiment 5+5

The system of embodiment 5+4 wherein the services are further configured to reduce the determined volume of water if the level of water is below a defined threshold.

### Embodiment 5+6

The system of embodiment 5+5 wherein the services are further configured to reduce the determined volume of water only if the zone for which the volume of water is being determined is not marked to receive the entire volume of water.

### Embodiment 6

A method comprising obtaining a current soil moisture level for at least one zone at the geographic location, wherein the zone has been assigned a desired minimum soil moisture level; determining if the zone needs to be watered based on the current soil moisture level relative to the desired minimum soil moisture level; and if the zone is to be watered, determining a volume of water needed to raise the current soil moisture level to the desired minimum soil moisture level.

### Embodiment 7

A distributed system of platform instances for use in an agricultural environment, the system comprising a plurality of platform instances based on an identical core, wherein each of the platform instances is located on one of a plurality of devices and is configured to run a plurality of services, wherein each service provides a mini runtime environment for a plurality of blocks that provide specific functionality to the service, and wherein the services are configured to monitor and control a plurality of components within the agricultural environment.

### Embodiment 8

A system for managing an agricultural ecosystem, the system comprising a plurality of platform instances based on an identical core, wherein each of the platform instances is located on one of a plurality of devices and is configured to run a plurality of services, wherein each service provides a mini runtime environment for a plurality of blocks that provide specific functionality to the service, and wherein the services are configured to monitor a demand for a plurality of resources within the ecosystem and deliver the resources to satisfy the demand using an infrastructure provided by the ecosystem.

### Embodiment 9

A system comprising at least one platform instance having a core that is configured to run on a device and launch a plurality of services; and the plurality of services, wherein each service provides a mini runtime environment for a plurality of blocks that provide specific functionality to the service, and wherein the services are configured to asynchronously monitor a system to obtain instrumentation information that includes environmental sensor information and system information, wherein the system includes hardware components that are deployed at a geographic location, and wherein the environmental sensor information represents data about the geographic location that is obtainable by the system without user interaction and the system information includes status information about the hardware components; receive user input that represents observational information based on user observations about dynamically changing elements within the geographic location, wherein the observational information is not obtainable by the system except through the user input and wherein the services are configurable to accept any type of observational information by configuring the specific functionality provided by the blocks; asynchronously integrate the observational information with the instrumentation information; and tune a behavior of a control process used to control the system based on the observational information and the instrumentation information, wherein the use of the observational information enables the control process to be asynchronously and repeatedly adjusted based on the dynamically changing elements.

### Embodiment 9+1

The system of embodiment 9 further comprising a user interface that enables a user to input the observational information.

### Embodiment 9+2

The system of embodiment 9+1 wherein a crop is growing at the geographic location, and wherein the user interface provides a color gradient to aid a user in determining if the crop is ready for harvest.

### Embodiment 10

A method comprising monitoring a system to obtain instrumentation information that includes environmental sensor information and system information, wherein the system includes hardware components that are deployed at a geographic location, and wherein the environmental sensor information represents data about the geographic location that is obtainable by the system without user interaction and the system information includes status information about the hardware components; receiving user input that represents observational information based on user observations about dynamically changing elements within the geographic location, wherein the observational information is not obtainable by the system except through the user input and wherein the services are configurable to accept any type of observational information by configuring the specific functionality provided by the blocks; asynchronously integrating the observational information with the instrumentation information; and tuning a behavior of a control process used to control the system based on the observational information and the instrumentation information, wherein the use of the observational information enables the control process to be asynchronously and repeatedly adjusted based on the dynamically changing elements.

### Embodiment 10+1

The method of embodiment 10 further comprising providing a user interface that enables a user to input the observational information.

### Embodiment 10+2

The method of embodiment 10+1 wherein a crop is growing at the geographic location, and wherein the user interface provides a color gradient to aid a user in determining if the crop is ready for harvest.

### Embodiment 11

A processing system includes a processor; and a memory coupled to the processor and containing instructions for execution by the processor, the instructions for performing any of the methods or implementing the architecture described herein in any embodiment.

### Embodiment 12

A computer program product configured to be operable to perform any of the methods or implementing the architecture described herein in any embodiment.

1. A system comprising:
at least a first configurable platform configured to run on a first device positioned at a geographic location;
a plurality of services configured to run on the at least first configurable platform, wherein each service provides a mini runtime environment for a plurality of blocks that provide specific functionality to the service, and wherein the services are configured to
obtain a current soil moisture level for a plurality of zones at the geographic location, wherein each of the zones has been assigned a desired minimum soil moisture level;
for each of the zones, determine if the current soil moisture level is below the desired minimum soil moisture level;
rank the zones in a watering schedule based on a delta between the current soil moisture level and the desired minimum soil moisture level of each zone, wherein water will be delivered to each of the zones in an order based on the zone's ranking in the watering schedule; and
for each zone, in the order based on the zone's ranking, open at least one valve to deliver water to the zone, and close the at least one valve after watering of the zone is completed.

2. The system of claim 1 wherein the services are further configured to close the at least one valve based on either an expiration of a defined time period or when a defined volume of water has been delivered to the zone.

3. The system of claim 1 wherein the services are further configured to:
monitor the delivery of water to at least one of the zones to determine when a defined volume of water has been delivered to the zone; and
close the at least one valve when the volume of water has been delivered to the zone.

4. The system of claim 3 wherein the services are further configured to, for each of the zones where the current soil moisture level is below the desired minimum soil moisture level, calculate the volume of water needed to raise the current soil moisture level to the desired minimum soil moisture level.

5. The system of claim 4 wherein the services are configured to calculate the volume of water on a per zone basis.

6. The system of claim 4 wherein the services are configured to calculate the volume of water on a per plant basis for at least some plants in the zone.

7. The system of claim 4 wherein the services are further configured to account for rainfall when calculating the volume of water.

8. The system of claim 4 wherein the services are further configured to account for a water level of a well from which the water is obtained when calculating the volume of water.

9. The system of claim 8 wherein the services are further configured to reduce the calculated volume of water if the level of water is below a defined threshold.

10. The system of claim 9 wherein the services are further configured to reduce the calculated volume of water only if the zone for which the volume of water is being calculated is not marked to receive the entire volume of water.

11. The system of claim 2 wherein the services are configured to calculate the volume of water by:
identifying a post-irrigation soil moisture level after at least one irrigation event;
calculating a delta between the current soil moisture level and the post-irrigation soil moisture level;
calculating an irrigation absorption rate;
calculating a water deficit between the post-irrigation soil moisture level and the current soil moisture level; and
calculating the volume of water based on the water deficit and the irrigation absorption rate.

12. The system of claim 11 wherein the services are further configured to recalculate the irrigation absorption rate following each irrigation event, wherein historical irrigation information is combined with information from the most recent irrigation event to increase an accuracy of the irrigation absorption rate.

13. The system of claim 11 wherein the services are further configured to wait for a defined period of time after the at least one irrigation event before calculating the irrigation absorption rate.

14. The system of claim 1 wherein the services are further configured to, for each of the zones, determine if the current soil moisture level is above a desired maximum soil moisture level; and if the current soil moisture level is above the desired maximum soil moisture level, remove the zone from the watering schedule.

15. The system of claim 1 wherein the services are configured to, for each of the zones, determine if the current soil moisture level is above a desired maximum soil moisture level; and if the current soil moisture level is above the desired maximum soil moisture level, not calculating the rank for the zone.
